(19) United States
(12) Patent Application Publication
(10) Pub. No.: US 2026/0022554 A1
(43) Pub. Date: Jan. 22, 2026

(54) Novel Insulation and Weather Resistant Barrier Systems

(71) Applicant: Henry Company, LLC, Kimberton, PA (US)

(72) Inventors: Divya Chopra, West Chester, PA (US); Rajesh Guntupalli, Marietta, GA (US); David Lewis, Bethlehem, CT (US); Thomas Savoy, Prior Lake, MN (US); John Dobson, West Chester, PA (US)

(21) Appl. No.: 19/256,692

(22) Filed: Jul. 1, 2025

Related U.S. Application Data
(60) Provisional application No. 63/666,295, filed on Jul. 1, 2024.
(60) Provisional application No. 63/695,233, filed on Sep. 16, 2024.

(51) Int. Cl. E04B 1/80; B32B 5/18; B32B 7/12

(52) U.S. Cl. CPC E04B 1/806; B32B 5/18; B32B 7/12; B32B 2250/03; B32B 2307/304; B32B 2307/712; B32B 2607/00

(57) ABSTRACT

This invention relates to novel insulation and weather-resistant barrier systems, such as insulated sheathing (IS) panels sheathing panels, and more particularly insulated wall-sheathing (IWS) panels, a panel assembly comprising such panels, and systems for use in construction, such as building construction, designed to provide moisture permeable panels that protect from bulk water, excess air, and thermal transfer. More specifically, this invention relates such panel used for construction purposes, comprising an insulation layer; a structurally-stable panel, an optional fastener-gasketing adhesive layer; and a weather-resistive barrier layer; wherein, in one embodiment, the weather-resistive barrier (WRB) layer exceeds the dimension of the structurally-stable panel from at least one of its edges to create an extension flap; and wherein the extension flap of the WRB layer further comprises a removably attached release-liner on its back.

### CROSS REFERENCE TO RELATED APPLICATIONS

This application claims benefit under 35 U.S.C. § 119(e) of Provisional U.S. Patent Application No. 63/666,295, filed Jul. 1, 2024, and Provisional U.S. Patent Application No. 63/695,233, filed Sep. 16, 2024, the contents of which are hereby incorporated by reference in their entirety.

### FIELD OF INVENTION

This invention relates to novel insulation and weather-resistant barrier systems, such as insulated sheathing (IS) panels sheathing panels, and more particularly insulated wall-sheathing (IWS) panels, a panel assembly comprising such panels, and systems for use in construction, such as building construction, designed to provide moisture permeable panels that protect from bulk water, excess air, and thermal transfer. More specifically, this invention relates such panel used for construction purposes, comprising an insulation layer; a structurally-stable panel, an optional fastener-gasketing adhesive layer; and a weather-resistive barrier layer; wherein, in one embodiment, the weather-resistive barrier (WRB) layer exceeds the dimension of the structurally-stable panel from at least one of its edges to create an extension flap; and wherein the extension flap of the WRB layer further comprises a removably attached release-liner on its back.

### BACKGROUND

Insulation and weather-resistant barrier system construction for example, roof or wall panel construction systems of residential or commercial buildings do not typically provide simple, efficient, and safe means of installation. Most often in these systems, extra steps must typically be added to the installation process to prevent liquid moisture, air, and heat from passing through the wall.

Constructing a wall with a weather barrier requires not only that panels be attached to framing members, but also a house-wrap is unrolled and spread over the walls. The house-wrap is attached to the sheathing panels with staples or button cap nails and fenestration openings for windows or doors must be cut out of the wrap and the flaps from these openings folded back and stapled down. The house-wrap is often difficult to install because it is in typical nine-ft wide rolls, which can be cumbersome to maneuver by workers on scaffolding or in windy conditions. While it is important that the barrier layer shed bulk water, it should allow for the escape of water vapor. Moreover, since house-wraps are only fastened at limited points, pockets or voids form between the sheathing and house wrap. If the barrier were to trap water vapor in a wall panel, the build-up of moisture could lead to rot or mold growth. Further, certain sheathing materials, such as oriented strand board (OSB), are known to irreversibly swell and warp when exposed to moisture.

Furthermore, small gaps along the edges of adjoining panels typically remain after installation assembly. These thermal gaps within the building envelope allow undesirable thermal energy entry and escape through the walls. Although house wrap can provide some protection, breaks or tears in the house wrap often form during installation or construction. Foam insulation sheathing has also been used to improve thermal resistance performance of building structures. However, insulation sheathing also presents certain limitations and challenges. In addition to frequently suffering physical damage during installation and construction, the structural properties of insulation sheathing relegates it to limited building applications. Insulation wall-sheathing panels are typically fastened as exterior cladding to the outermost, exterior facing of the wall with nails, screws, or staples. Once again, this is an extra step that must be added to the installation process. Moreover, as an additional fastened layer, pockets or voids inevitably form between it and the surface it is secured to. Moreover, most insulation sheathing can also limit external finishing options.

It is desirable for wall sheathing panels to shed precipitation, such as rain and snow, during construction so that the interior remains dry. Accordingly, there is a need in the art for wall-sheathing panels, which are resistant to bulk water but permeable to water vapor, provide improved thermal resistance and create a simplified, safe, and time-saving installation process.

Similarly, for installing roof panels, may problems arise in installation including unsafe environment for workers. When large rolls of sheet are installed, it becomes a problem.

Given the foregoing, there is a continuing need to develop improved insulated sheathing (IS) panels for roof and wall construction that prevent or minimize the penetration of bulk water, which come pre-equipped with a water permeable barrier layer applied during manufacture, and which have improved thermal performance.

### SUMMARY OF THE INVENTION

### First Set of Embodiments

In one embodiment, this invention relates to a first insulated sheathing (IS) panel used for construction purposes, comprising three or more layers of material, wherein the three or more layers comprise a first insulation layer; a first structurally-stable panel; and a first weather-resistive barrier (WRB) layer; wherein either the first structurally-stable panel is planarly and contactably attached to the first WRB layer, or the first insulation layer is planarly and contactably attached to the first WRB layer; and wherein the first WRB layer exceeds the dimension of the IS panel from at least one of its edges to create an extension flap along the edges, and wherein the extension flap of the WRB layer further comprises a removably attached release-liner attached to the first WRB layer's inner surface at the back of the extension flap.

In another embodiment, this invention relates to a first IS panel as recited above, comprising the following layers:
a first insulation layer having an outer surface and an inner surface;
a first structurally-stable panel having an outer surface and an inner surface, and at least one edge extending between its outer surface and the inner surface; wherein the inner surface of the first insulation layer is planarly and contactably attached to the outer surface of the first structurally-stable panel; and
a first WRB layer having an outer surface and an inner surface, wherein the inner surface of the WRB layer is secured to the outer surface of the first structurally-stable panel;
wherein the WRB layer exceeds the dimension of the structurally-stable panel from at least one of its edges to create an extension flap; and
wherein the extension flap of the WRB layer further comprises a removably attached release-liner attached to the WRB layer's inner surface at the back of the extension flap.

In yet another embodiment, this invention relates to a first IS panel as recited above, comprising the following layers:
a first insulation layer having an outer surface and an inner surface;
a first structurally-stable panel having an outer surface and an inner surface, and at least one edge extending between its outer surface and the inner surface; wherein the inner surface of the first insulation layer is planarly and contactably attached to the outer surface of the first structurally-stable panel;
a second structurally-stable panel having an outer surface and an inner surface, and at least one edge extending between its outer surface and the inner surface; wherein the inner surface of the first structurally-stable panel is planarly and contactably attached to the outer surface of the second structurally-stable panel; and
a first WRB layer having an outer surface and an inner surface, wherein the inner surface of the WRB layer is secured to the outer surface of the second structurally-stable panel;
wherein the WRB layer exceeds the dimension of the structurally-stable panels from at least one of its edges to create an extension flap; and
wherein the extension flap of the WRB layer further comprises a removably attached release-liner attached to the WRB layer's inner surface at the back of the extension flap.

In one embodiment, this invention relates to a first IS panel as recited above, comprising the following layers:
a first insulation layer having an outer surface and an inner surface;
a first structurally-stable panel having an outer surface and an inner surface, and at least one edge extending between its outer surface and the inner surface; wherein the inner surface of the first insulation layer is planarly and contactably attached to the outer surface of the first structurally-stable panel;
a first heat-sealant layer having an outer surface and an inner surface, and at least one edge extending between its outer surface and the inner surface; wherein the inner surface of the first structurally-stable panel is planarly and contactably attached to the outer surface of the first heat-sealant layer; and
a first WRB layer having an outer surface and an inner surface, wherein the inner surface of the WRB layer is secured to the outer surface of the heat-sealant layer;
wherein the WRB layer exceeds the dimension of the heat-sealant layer from at least one of its edges to create an extension flap; and
wherein the extension flap of the WRB layer further comprises a removably attached release-liner attached to the WRB layer's inner surface at the back of the extension flap.

In another embodiment, this invention relates to a first IS panel as recited above, comprising the following layers:
a first structurally-stable panel having an outer surface and an inner surface, and at least one edge extending between its outer surface and the inner surface;
a first insulation layer having an outer surface and an inner surface; wherein the outer surface of the first insulation layer is planarly and contactably attached to the inner surface of the first structurally-stable panel;
a second structurally-stable panel having an outer surface and an inner surface, and at least one edge extending between its outer surface and the inner surface; wherein the outer surface of the second structurally-stable panel is planarly and contactably attached to the inner surface of the first insulation panel; and
a first WRB layer having an outer surface and an inner surface, wherein the inner surface of the WRB layer is secured to the outer surface of the second structurally-stable panel;
wherein the WRB layer exceeds the dimension of the structurally-stable panels from at least one of its edges to create an extension flap; and
wherein the extension flap of the WRB layer further comprises a removably attached release-liner attached to the WRB layer's inner surface at the back of the extension flap.

In yet another embodiment, this invention relates to a first IS panel as recited above, comprising the following layers:
a first insulation layer having an outer surface and an inner surface;
a first structurally-stable panel having an outer surface and an inner surface, and at least one edge extending between its outer surface and the inner surface; wherein the inner surface of the first insulation layer is planarly adjacent to the outer surface of the first structurally-stable panel;
a set of strips embedded in the first insulation layer, wherein the set of strips contact the first structurally-stable layer at the strips' non-embedded end and wherein said strips create air-pockets in conjunction with said first insulation layer and said structurally-stable panel; or wherein the set of strips is embedded in the first insulation layer such that the strips' non-embedded ends are exposed but are nominally flush with the inner surface of the insulation layer; and
a first WRB layer having an outer surface and an inner surface, wherein the inner surface of the WRB layer is secured to the outer surface of the first structurally-stable panel;
wherein the WRB layer exceeds the dimension of the structurally-stable panel from at least one of its edges to create an extension flap; and
wherein the extension flap of the WRB layer further comprises a removably attached release-liner attached to the WRB layer's inner surface at the back of the extension flap.

In one embodiment, this invention relates to a first IS panel as recited above, wherein the set of strips are organized in a geometric pattern to drain moisture.

In another embodiment, this invention relates to a first IS panel as recited above, comprising the following layers:
a first insulation layer having an outer surface and an inner surface;
a first structurally-stable panel having an outer surface and an inner surface, and at least one edge extending between its outer surface and the inner surface;
a plurality of insulation beads in contact with the first structurally-stable layer;
a first WRB layer having an outer surface and an inner surface, wherein the inner surface of the WRB layer is secured to the plurality of insulation beads, and wherein said insulation beads create air-pockets in conjunction with said first structurally-stable panel and said WRB layer; and
wherein the WRB layer exceeds the dimension of the first structurally-stable panel from at least one of its edges to create an extension flap; and
wherein the extension flap of the WRB layer further comprises a removably attached release-liner attached to the WRB layer's inner surface at the back of the extension flap.

In yet another embodiment, this invention relates to a first IS panel as recited above, comprising the following layers:
a first insulation layer having an outer surface and an inner surface;
a first structurally-stable panel having an outer surface and an inner surface, and at least one edge extending between its outer surface and the inner surface; wherein the inner surface of the first insulation layer is planarly and contactably attached with optionally an adhesive to the outer surface of the first structurally-stable panel;
wherein the insulation layer and the structurally-stable panel is attached to each other through an adhesive tape on at least one edge of the combined insulation layer and the structurally-stable panel; and
a first WRB layer having an outer surface and an inner surface, wherein the inner surface of the WRB layer is secured to the outer surface of the first structurally-stable panel;
wherein the WRB layer exceeds the dimension of the structurally-stable panel from at least one of its edges to create an extension flap; and
wherein the extension flap of the WRB layer further comprises a removably attached release-liner attached to the WRB layer's inner surface at the back of the extension flap.

In one embodiment, this invention relates to a first IS panel as recited above, comprising the following layers:
a first insulation layer having an outer surface and an inner surface;
a first structurally-stable panel having an outer surface and an inner surface, and at least one edge extending between its outer surface and the inner surface; wherein the inner surface of the first insulation layer is planarly and contactably adjacent to the outer surface of the first structurally-stable panel, and the insulation layer is optionally attached with an adhesive, planarly and contactably, to the structurally-stable panel; or
wherein the inner surface of the first insulation layer is planarly and contactably adjacent to the outer surface of the first structurally-stable panel, and the insulation layer is only nominally in contact with structurally-stable panel, creating an air-gap therebetween;
wherein, optionally, the insulation layer and the structurally-stable panel is attached to each other through an adhesive tape on at least one edge of the combined insulation layer and the structurally-stable panel; and
a first WRB layer having an outer surface and an inner surface, wherein the inner surface of the WRB layer is secured to the outer surface of the first structurally-stable panel;
wherein the WRB layer exceeds the dimension of the structurally-stable panel from at least one of its edges to create an extension flap; and
wherein the extension flap of the WRB layer further comprises a removably attached release-liner attached to the WRB layer's inner surface, such that the WRB layer is extended beyond the face of the panel, and over at least one edge of the IS panel to at least partially encase the IS panel.

In another embodiment, this invention relates to a first IS panel as recited above, wherein if the structurally-stable panel is planarly and contactably attached to the WRB layer, a first facer layer is planarly and contactably attached to outer surface of the insulation layer and on the opposite side of the WRB layer, and wherein the insulation panel is planarly and contactably attached to the WRB layer, the facer layer is planarly and contactably attached to the outer surface of the structurally-stable panel and on the opposite side of the WRB layer.

In yet another embodiment, this invention relates to a first IS panel as recited above, further comprising a first fastener-gasketing layer having an outer surface and an inner surface; wherein the outer surface of the fastener-gasketing layer is in contact with the inner surface of said WRB layer.

In one embodiment, this invention relates to a first IS panel as recited above, wherein the one or more structurally-stable panels comprises material selected from MgX, gypsum, wood, cementitious material, composite material, wood composite material, plant-based material, reinforced materials, blends thereof, and mixtures of stated materials.

In another embodiment, this invention relates to a first IS panel as recited above, wherein the SS panel comprises lignocellulosic material, OSB, plywood, waferboard, particleboard, chipboard, medium-density fiberboard, and boards that are a composite of strands and ply veneers.

In yet another embodiment, this invention relates to a first IS panel as recited above, wherein the SS panel comprises magnesium oxide, magnesium oxychloride, magnesium sulfate, magnesium oxysulphate, magnesium oxyphosphate, or combinations thereof.

In one embodiment, this invention relates to a first IS panel as recited above:
wherein the SS panel is an engineered composite building material made from a blend of plastic and cellulose fiber;
wherein the SS panel is an engineered fiberboard laminate which is a composite material formed from multiple layers of paperboard made from wood fibers or other cellulosic materials; or
wherein the SS panel is laminated to a plastic film or foil, wherein the plastic film comprises polyethylene, polypropylene, polyester, or nylon, and wherein the foil is a metallic foil.

In another embodiment, this invention relates to a first IS panel as recited above:
wherein the SS panel comprises a cementitious material with a glass fiber reinforcing material embedded therein;
wherein the SS panel is formed by pouring a slurry of cementitious material with glass fiber reinforcing material into a mold and allowing the cementitious product to cure, or dry;
wherein the SS panel comprises glass fiber reinforcing material in the form of chopped glass fiber;
wherein the glass fiber reinforcing material may be incorporated into the SS panel in the form of one or more glass fiber scrims;
wherein the SS panel comprises a reinforcing material selected from glass, flax, basalt, cellulose, carbon, or aramid fiber; or
wherein the SS panel comprises a reinforcement fiber mat is embedded with polyurethane.

In yet another embodiment, this invention relates to a first IS panel as recited above, wherein the SS panel is wood composite panel comprising a binder material and plant-based material, wherein said panel includes at least 70 percent plant-based material by weight and at least 2.5 percent thermoplastic binder by weight.

In one embodiment, this invention relates to a first IS panel as recited above, wherein the SS panel is a wood composite panel selected from the group consisting of oriented strand wood composite panel, fiber wood composite panel, particle wood composite panel and a layer comprising plant-based material.

In another embodiment, this invention relates to a first IS panel as recited above, wherein the SS panel has a thickness in the range of from about 0.01 to 3 inches.

In yet another embodiment, this invention relates to a first IS panel as recited above, wherein the number of SS panels is from 1 to 20.

In one embodiment, this invention relates to a first IS panel as recited above, wherein the insulation layer comprises a foam.

In another embodiment, this invention relates to a first IS panel as recited above, wherein the insulation layer comprises a foam, or wherein the insulation layer comprises a foam that is open-celled, close-celled, or a mixed-cell structure.

In yet another embodiment, this invention relates to a first IS panel as recited above, wherein the insulation layer comprises at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In one embodiment, this invention relates to a first IS panel as recited above, wherein the insulation layer comprises at least one of an inorganic insulating material selected from the group consisting of mineral wool, glass wool, compressed fumed silica, perlite, calcium silicate, foamed glass, and silica aerogel blanket.

In another embodiment, this invention relates to a first IS panel as recited above, further comprising one or more additional layers that can be any of a fiberglass, polymer, or metal sheet, film, fiber, mat, fabric layer, or combinations thereof, either within or on one or more of the SS panel, or one or more of the insulation layers, that is on the surface of the one or more of the SS panels or the one or more of the insulation layers, and/or between the one or more of the insulation layers and the one or more of the SS panels.

In yet another embodiment, this invention relates to a first IS panel as recited above, wherein the insulation layer has a density in the range of about 1 to about 20 pounds per cubic feet (pcf) according to ASTM D1622.

In another embodiment, this invention relates to a first IS panel as recited above, wherein the insulation layer has a water absorption of less than about 10% according to ASTM C209 or ASTM C2842.

In one embodiment, this invention relates to a first IS panel as recited above, wherein the insulation layer has a water vapor permeance from about 0.1 to about 20 perms as determined according to ASTM E96.

In another embodiment, this invention relates to a first IS panel as recited above, wherein the system exhibits a thermal resistance value (R-value) from about 1 to about 15 according to ASTM C1289-02.

In yet another embodiment, this invention relates to a first IS panel as recited above, wherein the insulation layer further comprises a membrane layer.

In one embodiment, this invention relates to a first IS panel as recited above, wherein the insulation membrane layer comprises radiant barrier material, polymeric film, polymeric fabric, paper, cellulosic material, reinforcing scrim, or a combination thereof.

In another embodiment, this invention relates to a first IS panel as recited above, wherein the insulation layer is secured to the panel using an adhesive selected from a phenol-formaldehyde resin, hot-melt adhesive, polyvinyl acetate (PVA) resin, or a combination thereof.

In yet another embodiment, this invention relates to a first IS panel as recited above, wherein the WRB layer is a house wrap.

In one embodiment, this invention relates to a first IS panel as recited above, wherein the WRB barrier layer is substantially bulk water resistant, and substantially water vapor permeable.

In another embodiment, this invention relates to a first IS panel as recited above, wherein the WRB layer further comprises an intumescent coating for at least one of thermal barrier, fire resistance, and ignition barrier properties.

In yet another embodiment, this invention relates to a first IS panel as recited above, wherein the barrier layer comprises a resin-impregnated paper substantially covering the outward facing surface of the panel, the resin-impregnated paper having a paper basis weight of 21.772 kg (48 lbs.) to about 102.058 kg (225 lbs) per ream and a resin content of less than 80% by dry weight.

In one embodiment, this invention relates to a first IS panel as recited above, wherein each panel and barrier layer has a water vapor transmission rate from about 0.7 to about 7 grams/m²/24 hrs as determined according to ASTM E96 procedure A (at 73° F.-50% RH) and a liquid water transmission rate from about 1 to about 28 grams/100 in²/24 hrs via Cobb ring according to ASTM D5795.

In another embodiment, this invention relates to a first IS panel as recited above, wherein an outer surface of the barrier layer is textured.

In yet another embodiment, this invention relates to a first IS panel as recited above, wherein the textured outer surface provides a wet coefficient of friction in a range of about 0.8 to about 1.1 (English XL Tribometer) and a dry coefficient of friction of at least about 0.8 (English XL Tribometer).

In one embodiment, this invention relates to a first IS panel as recited above, wherein the extension flap is on at least one side of the panel or on all sides of the panel.

In another embodiment, this invention relates to a first IS panel as recited above, wherein the extension flap is 0.5% to about 50% of the length of the maximum dimension of the panel.

In yet another embodiment, this invention relates to a first IS panel as recited above, wherein the adhesive on the inner surface of the WRB layer is the same as or different from the adhesive of the release-liner.

In one embodiment, this invention relates to a first IS panel as recited above, wherein, the extension flap overhangs from about 0.1 inch to 12 inches on at least one edge of the panel.

In another embodiment, this invention relates to a first IS panel as recited above, comprising a fastener-gasketing adhesive between the WRB layer and the layer on the inside of the panel facing the WRB layer.

In yet another embodiment, this invention relates to a first IS panel as recited above, wherein the release-liner or release sheet is a paper sheet having a silicone release surface coating or a treated plastic film.

In one embodiment, this invention relates to a first IS panel as recited above, wherein one or more of the extension flaps are continuous or discontinuous along the length of the edge from which it exceeds beyond the panel.

In another embodiment, this invention relates to a first IS panel as recited above, wherein one or more of the extension flap, in the direction perpendicular to the edge of the panel, is 0.1% to 50% of the shortest and the longest dimension of the panel, respectively.

In yet another embodiment, this invention relates to a first IS panel as recited above, wherein one or more of the extension flaps in their direction parallel to the edge of the panel, are from 5% to 120% the length of the edge of the panel.

In one embodiment, this invention relates to a first IS panel as recited above, wherein the release-liner covers the surface area of the extension flap of the barrier layer from about 10% to 100%.

In another embodiment, this invention relates to a first IS panel assembly comprising at least two panels juxtaposed and/or adhered to each other, wherein at least one panel is according to a panel as recited above.

In yet another embodiment, this invention relates to a first IS panel assembly comprising at least two panels juxtaposed and/or adhered to each other, wherein all panels are structurally the same, and wherein all panels are according to a panel as recited above.

In one embodiment, this invention relates to a first IS panel assembly wherein the extension flap of a first panel forms a tongue and groove assembly with the extension flap of the adjacent panel.

In another embodiment, this invention relates to a first IS panel or panel assembly wherein the IS panel is an insulated wall sheathing panel.

### Second Set of Embodiments

In yet another embodiment, this invention relates to a first IS panel used for construction purposes, comprising the following layers:
a first insulation layer having an outer surface and an inner surface;
a first structurally-stable panel having an outer surface and an inner surface, and at least one edge extending between its outer surface and the inner surface; wherein the inner surface of the first insulation layer is planarly and contactably attached to the outer surface of the first structurally-stable panel;
a first heat-sealant layer having an outer surface and an inner surface, and at least one edge extending between its outer surface and the inner surface; wherein the inner surface of the first structurally-stable panel is planarly and contactably attached to the outer surface of the first heat-sealant layer; and
a first WRB layer having an outer surface and an inner surface, wherein the inner surface of the WRB layer is secured to the outer surface of the heat-sealant layer.

In one embodiment, this invention relates to a first IS panel used for construction purposes, comprising the following layers:
a first structurally-stable panel having an outer surface and an inner surface, and at least one edge extending between its outer surface and the inner surface;
a first insulation layer having an outer surface and an inner surface; wherein the outer surface of the first insulation layer is planarly and contactably attached to the inner surface of the first structurally-stable panel;
a second structurally-stable panel having an outer surface and an inner surface, and at least one edge extending between its outer surface and the inner surface; wherein the outer surface of the second structurally-stable panel is planarly and contactably attached to the inner surface of the first insulation panel; and
a first WRB layer having an outer surface and an inner surface, wherein the inner surface of the WRB layer is secured to the outer surface of the second structurally-stable panel.

In another embodiment, this invention relates to a first IS panel used for construction purposes, comprising the following layers:
a first insulation layer having an outer surface and an inner surface;
a first structurally-stable panel having an outer surface and an inner surface, and at least one edge extending between its outer surface and the inner surface;
a set of strips embedded in the first insulation layer, wherein the set of strips contact the first structurally-stable layer at their non-embedded end; wherein said strips create air-pockets in conjunction with said first insulation layer and said structurally-stable panel; and
a first WRB layer having an outer surface and an inner surface, wherein the inner surface of the WRB layer is secured to the outer surface of the first structurally-stable panel.

In yet another embodiment, this invention relates to a first IS panel used for construction purposes, comprising the following layers:
a first insulation layer having an outer surface and an inner surface;
a set of strips embedded in the first insulation layer with their non-embedded ends exposed but nominally flush with the inner surface of the insulation layer;
a first structurally-stable panel having an outer surface and an inner surface, and at least one edge extending between its outer surface and the inner surface; wherein the inner surface of the first insulation layer is planarly and contactably attached to the outer surface of the first structurally-stable panel, and wherein the non-embedded ends of the strips are in contact with the outer surface of the first structurally-stable panel; and
a first WRB layer having an outer surface and an inner surface, wherein the inner surface of the WRB layer is secured to the outer surface of the first structurally-stable panel.

In one embodiment, this invention relates to a first IS panel used for construction purposes as recited above, wherein the set of strips are organized in a geometric pattern to drain moisture.

In another embodiment, this invention relates to a first IS panel used for construction purposes, comprising the following layers:
a first insulation layer having an outer surface and an inner surface;
a first structurally-stable panel having an outer surface and an inner surface, and at least one edge extending between its outer surface and the inner surface;
a plurality of insulation beads in contact with the first structurally-stable layer;
a first WRB layer having an outer surface and an inner surface, wherein the inner surface of the WRB layer is secured to the plurality of insulation beads; wherein said insulation beads create air-pockets in conjunction with said first structurally-stable panel and said WRB layer.

In yet another embodiment, this invention relates to a first IS panel used for construction purposes, comprising the following layers:
a first insulation layer having an outer surface and an inner surface;
a first structurally-stable panel having an outer surface and an inner surface, and at least one edge extending between its outer surface and the inner surface; wherein the inner surface of the first insulation layer is planarly and contactably adjacent to the outer surface of the first structurally-stable panel, and the insulation layer is optionally attached with an adhesive, planarly and contactably, to the structurally-stable panel;
wherein the insulation layer and the structurally-stable panel is attached to each other through an adhesive tape on at least one edge of the combined insulation layer and the structurally-stable panel; and
a first WRB layer having an outer surface and an inner surface, wherein the inner surface of the WRB layer is secured to the outer surface of the first structurally-stable panel.

In one embodiment, this invention relates to a first IS panel used for construction purposes, comprising the following layers:
a first structurally-stable panel having an outer surface and an inner surface, and at least one edge extending between its outer surface and the inner surface;
a first insulation layer having an outer surface and an inner surface; wherein the outer surface of the first insulation layer is planarly and contactably attached to the inner surface of the first structurally-stable panel;
wherein the first structurally-stable panel is made from a composite board such as EcoStorm®.

In another embodiment, this invention relates to a method for preparing a first IS panel, the method comprising the following steps:
providing a first insulation layer having an outer surface and an inner surface;
providing a first structurally-stable panel having an outer surface and an inner surface, and at least one edge extending between its outer surface and the inner surface;
planarly and contactably attaching the inner surface of the first insulation layer to the outer surface of the first structurally-stable panel; an providing a first WRB layer having an outer surface and an inner surface, wherein the WRB layer exceeds the dimension of the structurally-stable panel from at least one of its edges to create an extension flap, and wherein the extension flap of the WRB layer further comprises a removably attached release-liner attached to the WRB layer's inner surface at the back of the extension flap; and
planarly and contactably securing or attaching the inner surface of the WRB layer to the outer surface of the first structurally-stable panel.

In yet another embodiment, this invention relates to a method for preparing a panel assembly, the method comprising:
a. providing a plurality of IS panels, wherein at least one of the panels is as recited above;
b. securing each of the plurality of the IS panels to a structural element of the wall;
c. removing the release-liner from the back of the extension flap from the panels with having such extension flap, and sealing the seams between the individual IS panels of the plurality of panels; and/or
d. sealing the IS panels using other sealing means.

In another embodiment, this invention relates to a first IS panel or panel assembly as recited above, without extension flaps and the release-liner, wherein in place of a WRB, a water proof intumescent coating fluid is applied that provides additional protection, and wherein said panel comprises a split liner tape at least on one side, wherein said split liner tape wherein, optionally, the split liner tape exceeds the dimension of the structurally-stable panel from at least one of its edges to create an extension flap; and
wherein the extension flap of the split liner tape further comprises a removably attached release-liner attached to the layer immediately below it in a planarly and contactably attached construction.

In one embodiment, this invention relates to the methods as recited above:
wherein the structurally-stable panel is made from materials comprising MgX, gypsum, wood, cementitious material, composite material, wood composite material, plant-based material, and reinforced materials, blends thereof, or mixtures of stated materials;
wherein the SS panel is made from materials comprising magnesium oxide, magnesium oxychloride, magnesium sulfate, magnesium oxysulphate, magnesium oxyphosphate, or combinations thereof;
wherein the structurally-stable panel is made from grass or rice hulls;
wherein the SS panel is made from materials comprising lignocellulosic material, OSB, plywood, waferboard, particleboard, chipboard, medium-density fiberboard, and boards that are a composite of strands and ply veneer;
wherein the SS panel is made from engineered fiberboard laminate, materials known as EcoStorm®, material known as CompoLite®, or materials with glass-fiber reinforcement; OR
wherein the insulation layer of the above embodiment comprises foams made from at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

### BRIEF DESCRIPTION OF THE DRAWINGS

FIGS. 1A, 1B and 1C show a perspective view of the continuous insulated panel on a wall.

FIG. 2 shows a schematic of a concept for the insulation sheathing (IS) panel in an insulated wall sheathing (IWS) configuration with the release-liner on the back of the WRB layer.

FIG. 3 shows a schematic of a concept for the insulation sheathing (IS) panel in an insulated wall sheathing (IWS) configuration comprising a structurally-stable panel in contact the insulation layer with an adhesive but not a fastener-gasketing adhesive.

FIG. 4 depicts a schematic of a concept for the insulation sheathing (IS) panel in an insulated wall sheathing (IWS) configuration comprising a fastener-gasketing adhesive.

FIG. 5 depicts a schematic of a concept for the insulation sheathing (IS) panel in an insulated wall sheathing (IWS) configuration comprising an adhesive and a fastener-gasketing adhesive.

FIG. 6 depicts a schematic of a concept for the insulation sheathing (IS) panel in an insulated wall sheathing (IWS) configuration in its front view comprising extension flaps with a release-liner on the back with various shapes and contours of the extension flaps.

FIG. 7 shows a schematic of the concept shown in FIG. 5, in which an insulation facer is placed on the insulation layer.

FIG. 8 shows a schematic of the concept for placing multiple insulation sheathing (IS) panels (panel assembly) in an insulated wall sheathing (IWS) configuration with extension flaps juxtaposed with each other where the extension flaps perform the sealing function of the gaps between the panels.

FIG. 9 shows a schematic of a concept for the insulation sheathing (IS) panel in an insulated wall sheathing (IWS) configuration comprising two structurally-stable panels in place of one.

FIG. 10 shows a schematic of a concept for the insulation sheathing (IS) panel in an insulated wall sheathing (IWS) configuration comprising a heat-sealant layer attached to the structurally-stable panel and the fastener-gasketing adhesive or the WRB layer.

FIG. 11 shows a schematic of another concept for the insulation sheathing (IS) panel in an insulated wall sheathing (IWS) configuration in which the insulation layer or foam is positioned between two structurally-stable panels, for example, of wood.

FIG. 12 shows a schematic of another concept for the insulation sheathing (IS) panel in an insulated wall sheathing (IWS) configuration in which the insulation layer or foam is positioned inside and a structurally-stable panel, for example, of wood, on the outside, and set of strips for drainage.

FIG. 13 depicts a schematic of a concept for the insulation sheathing (IS) panel in an insulated wall sheathing (IWS) configuration that includes strips lodged in between the insulation layer and the structurally stable panel that create air-pockets.

FIG. 14 depicts a schematic of a concept for the insulation sheathing (IS) panel in an insulated wall sheathing (IWS) configuration comprising embedded insulation foam beads in between the structurally stable layer or the wood-composite layer and the fastener gasketing layer or WRB layer to create air-pockets.

FIG. 15 depicts a schematic of a concept for the insulation sheathing (IS) panel in an insulated wall sheathing (IWS) configuration with the structurally-stable panel made from a non-OSB panel such as MgX or composite such as EcoStorm®.

FIG. 16 shows a schematic of a concept in cross-section for the insulation sheathing (IS) panel in an insulated wall sheathing (IWS) configuration with patterned strips between the insulation layer and the structurally-stable layer, with the strips creating moisture drainage channels.

FIG. 17 shows a schematic of a concept in sectional view for the insulation sheathing (IS) panel in an insulated wall sheathing (IWS) configuration of FIG. 16 with geometrically patterned strips embedded into the insulation layer, with the strips creating moisture drainage channels when packed in between the insulation layer and the structurally-stable layer.

FIGS. 18 and 19 show a schematic of the insulation sheathing (IS) panel in an insulated wall sheathing (IWS) configuration in which the insulation layer and the structurally-stable panel are attached to each other by an adhesive tape covering along one or more edges of the two components.

FIG. 20 shows a schematic of a concept for the insulation sheathing (IS) panel in an insulated wall sheathing (IWS) configuration comprising two structurally-stable panels in place of one, but without extension flaps.

FIG. 21 shows a schematic of a concept for the insulation sheathing (IS) panel in an insulated wall sheathing (IWS) configuration comprising a heat-sealant layer in contact with the structurally-stable panel and the fastener-gasketing adhesive or the WRB layer, but without extension flaps.

FIG. 22 shows a schematic of another concept for the insulation sheathing (IS) panel in an insulated wall sheathing (IWS) configuration in which the insulation layer or foam is positioned between two structurally-stable panels, for example, of wood, but without extension flaps.

FIG. 23 shows a schematic of another concept for the insulation sheathing (IS) panel in an insulated wall sheathing (IWS) configuration in which the insulation layer or foam is positioned inside and a structurally-stable panel, for example, of wood, on the outside, but without extension flaps.

FIG. 24 depicts a schematic of a concept for the insulation sheathing (IS) panel in an insulated wall sheathing (IWS) configuration that includes strips lodged in between the insulation layer and the structurally stable panel that create air-pockets, but without extension flaps.

FIG. 25 depicts a schematic of a concept for the insulation sheathing (IS) panel in an insulated wall sheathing (IWS) configuration embedded oriented strand board strips in between the insulation layer and the structurally stable layer or the wood-composite layer but without any air-gap in between the two layers, but without extension flaps.

FIG. 26 depicts a schematic of a concept for the insulation sheathing (IS) panel in an insulated wall sheathing (IWS) configuration in which foam beads are placed between the structurally-stable panel and the fastener-gasketing adhesive or the WRB layer to create air-pockets, but without extension flaps.

FIG. 27 shows a schematic of a concept for the insulation sheathing (IS) panel in an insulated wall sheathing (IWS) configuration with patterned strips between the insulation layer and the structurally-stable layer, with the strips creating moisture drainage channels, but without extension flaps.

FIG. 28 shows a schematic of the insulation sheathing (IS) panel in an insulated wall sheathing (IWS) configuration in which the insulation layer and the structurally-stable panel are attached to each other by a tape covering along one or more edges of the two components, but without extension flaps.

FIG. 29 depicts a schematic of the insulation sheathing (IS) panel in an insulated wall sheathing (IWS) configuration wherein the wood panel is on the inside and the insulation layer is attached to the WRP wrap through a fastener-gasketing layer, with the extension flaps on the WRB wrap.

FIG. 30 depicts a schematic of the insulation sheathing (IS) panel in an insulated wall sheathing (IWS) configuration with the structurally-stable panel made from a non-OSB panel such as MgX or composite such as EcoStorm®, but without extension flaps.

FIGS. 30 and 31 depict a schematic of the insulation sheathing (IS) panel in an insulated wall sheathing (IWS) configuration in which the insulation panel and the structurally-stable panel are covered by the WRB layer on one or more of its edges, and optionally also partially covering the insulation layer.

FIG. 33 depicts a schematic of the insulation sheathing (IS) panel in an insulated wall sheathing (IWS) configuration wherein the structurally-stable panel is made from a non-OSB board such as MgX, rice hulls, grass.

FIG. 34 depicts a schematic of the insulation sheathing (IS) panel in an insulated wall sheathing (IWS) configuration wherein the two structurally-stable panels are made from wood and MgX, respectively.

FIG. 35 depicts a schematic of the insulation sheathing (IS) panel in an insulated wall sheathing (IWS) configuration wherein the two structurally-stable panels are made from MgX and wood, respectively.

FIG. 36 depicts a schematic of the insulation sheathing (IS) panel in an insulated wall sheathing (IWS) configuration wherein the structurally-stable panel is made from MgX with the insulation layer attached to the WRB layer.

FIG. 37 depicts a schematic of the insulation sheathing (IS) panel in an insulated wall sheathing (IWS) configuration wherein the insulation layer is sandwiched between two structurally-stable panels both made from wood or MgX with the second wood or MgX panel attached to the WRB layer.

FIG. 38 depicts a schematic of the insulation sheathing (IS) panel in an insulated wall sheathing (IWS) configuration in which an intumescent coating is applied to a WRB layer but without any extension flaps.

FIG. 39 depicts the insulation sheathing (IS) panel in an insulated wall sheathing (IWS) configuration in which no WRB is included and instead an intumescent coating is applied along with a split liner tape for adhesion of said panel with other panels to form a panel assembly.

### DETAILED DESCRIPTION OF THE INVENTION

Before the present compositions, articles, devices, and/or methods are disclosed and described, it is to be understood that the aspects described below are not limited to specific methods as such, may, of course, vary. It is also to be understood that the terminology used herein is for the purpose of describing particular aspects only and is not intended to be limiting. As used in the specification and in the claims, the term “comprising” may include the embodiments “consisting of” and “consisting essentially of.”

Disclosed are materials, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. Thus, if a class of adhesives A, B, and C are disclosed as well as a class of additives D, E, and F and an example of a combination A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, compositions, and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

Unless expressly stated otherwise, it is not intended that any method outlined herein be construed as requiring that its steps be performed in a particular order. Accordingly, where a method claim does not expressly recite an order to be followed by its steps, or where neither the claims nor the descriptions specifically state that the steps are to be limited to a precise sequence, it should not be inferred that a specific order is intended or required. This holds for any possible non-express basis for interpretation, including, but not limited to: logical flow or arrangement of steps; interpretations derived from the grammatical organization, syntax, or punctuation; and the quantity or variety of embodiments detailed in the specification. The description of the invention should not be read as mandating a fixed sequence of steps, unless such a requirement is articulated explicitly.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight. Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Unless stated otherwise, pressures expressed in psi units would be gauge, and pressures expressed in kPa units would be absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an endpoint of a range, the disclosure should be understood to include the specific value or endpoint referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause;
other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of.”

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise. As used in the specification and the appended claims, the singular forms “a,” “an,” and “the” include plural referents unless the context clearly dictates otherwise.

The term “predominant portion” or “predominantly,” as used herein, unless otherwise defined herein, means greater than 50% of the referenced material. If not specified, the percent is on a molar basis when reference is made to a molecule (such as hydrogen and ethylene), and otherwise is on a weight basis (such as for additive content).

The term “substantial portion” or “substantially,” as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

All parts, percentages and ratios used herein are expressed by weight unless otherwise specified.

In this specification and in the claims which follow, reference will be made to a number of terms which shall be defined herein.

“Optional” or “optionally” means that the subsequently described event or circumstance can or cannot occur, and that the description includes instances where the event or circumstance occurs and instances where it does not.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification. Throughout this application, various publications are referenced. The disclosures of these publications in their entirety are hereby incorporated by reference into this application in order to more fully describe the state of the art to which they pertain. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation. In the context of the present description, all publications, patent applications, patents and other references mentioned herein, if not otherwise indicated, are explicitly incorporated by reference herein in their entirety for all purposes as if fully set forth.

### Definitions

By “planarly and contactably” is meant that two layers of an IS panel are in the planar and are in contact with each other in a planar manner, that is, not at the edge but a substantial planar area of the two layers are in contact or are capable of contact.

By “attached” is meant, for example in “planarly and contactably attached,” that two layers are securely tied to each other, even with an adhesive in some cases or as the case maybe with fasteners. But in general, “attached” conveys the meaning that between the two planar layers there is a substantial connection and if there is non-connection, it is only nominal. Attachment could be strong or weak attachment.

By “secured” is meant that two layers are in contact with each other and are substantially connected, similar to the meaning of the term “attached.”

By “adjacent” is meant that two layers are planarly in contact, but their attachment may or may not be as secure when the term “attached” or “secured or “adhered” is used. For example, two layers could be simply place on top of each other, as adjacent to each other.

To be clear, if two IS panels or IWS panels are placed adjacent each other, it is to convey the meaning that they are place—side-by-side, as in a panel assembly.

By “IS panel” is meant that such panel serves the purpose at a minimum of insulation and mechanical strength and is used for construction purposes, such as building construction.

Similarly, an “IWS panel” is meant that such panel serves the purpose at a minimum of insulation and mechanical strength for construction purposes, such as building construction, but for use in wall configuration.

The following describes exemplary embodiments of the present invention in the building construction context, which pertains to insulated sheathing (IS) panel, for example insulated wall-sheathing (IWS) panels for a panelized sheathing assembly and system attached to a frame structure of the building, and that are suitable for use in the construction of residential and commercial buildings.

Generally, this invention relates to a first insulated sheathing (IS) panel used for construction purposes, comprising three or more layers of material, wherein the three or more layers comprise a first insulation layer; a first structurally-stable panel; and a first weather-resistive barrier (WRB) layer;
wherein either the first structurally-stable panel is planarly and contactably attached to the first WRB layer, or the first insulation layer is planarly and contactably attached to the first WRB layer; and
wherein the first WRB layer exceeds the dimension of the IS panel from at least one of its edges to create an extension flap along the edges, and wherein the extension flap of the WRB layer further comprises a removably attached release-liner attached to the first WRB layer's inner surface at the back of the extension flap.

At the outset we describe the method of preparing the IS panels such as IWS panels. As described in one example below, the layers or panels that need to be organized together is first provided. Then, appropriately, such layer is secured, planarly and contactably attached, adhered, or placed adjacently to another layer or a panel to form the IS panel such as an IWS panel.

### Example of Method of Making an IS Panel

This invention relates to a method for preparing a first IS panel as recited below in the exemplary embodiments, where the method comprises the following steps:
providing a first insulation layer having an outer surface and an inner surface;
providing a first structurally-stable panel having an outer surface and an inner surface, and at least one edge extending between its outer surface and the inner surface;
planarly and contactably attaching the inner surface of the first insulation layer to the outer surface of the first structurally-stable panel; an
providing a first WRB layer having an outer surface and an inner surface,
   wherein the WRB layer exceeds the dimension of the structurally-stable panel from at least one of its edges to create an extension flap, and
   wherein the extension flap of the WRB layer further comprises a removably attached release-liner attached to the WRB layer's inner surface at the back of the extension flap;
planarly and contactably securing or attaching the inner surface of the WRB layer to the outer surface of the first structurally-stable panel.

In one embodiment, the fastener-gasketing layer can also be planarly and contactably attached to the SS layer, and the facer layer can be planarly and contactably attached to the insulation layer. In a similar manner, various other layers are applied in the exemplary embodiments given below.

### Exemplary Embodiments

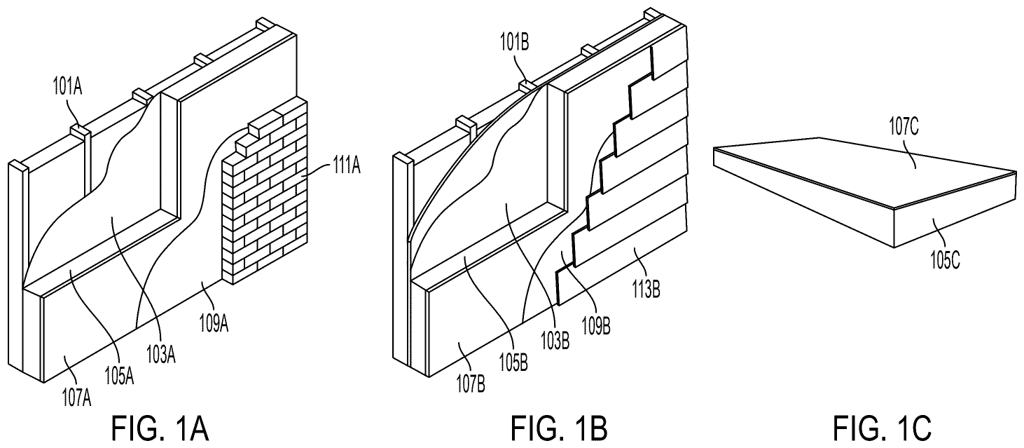

### FIG. 1

FIG. 1A shows a perspective view of the continuous insulated sheathing panel for example, to be installed on a wall. On the existing wall 101A of a building the insulated wall sheathing panel or the IWS panel 100A is applied. The IWS panel 100A comprises a facer 103A, an insulation layer 105A and an oriented strand board (OSB) layer 107A. On the OSB layer 107A is applied the weather-resistive barrier (WRB) layer, or the house-wrap 109A. On the house-wrap 109A is applied, for example, a brick layer 111A. FIG. 1B shows a similar perspective of the continuous IWS panel on a wall 101B, with an IWS panel 100B, that comprises a facer 103B, an insulation layer 105B, an SS panel such as an oriented strand board layer 107B, and a WRB layer 109B, with a vinyl siding 111B on top of the house-wrap 109B.

Similarly, 1C shows an existing continuous panel 100C, comprising an insulation layer 105C, an OSB layer 107C, and a facer layer 103C. The house-wrap layer is not shown in this figure.

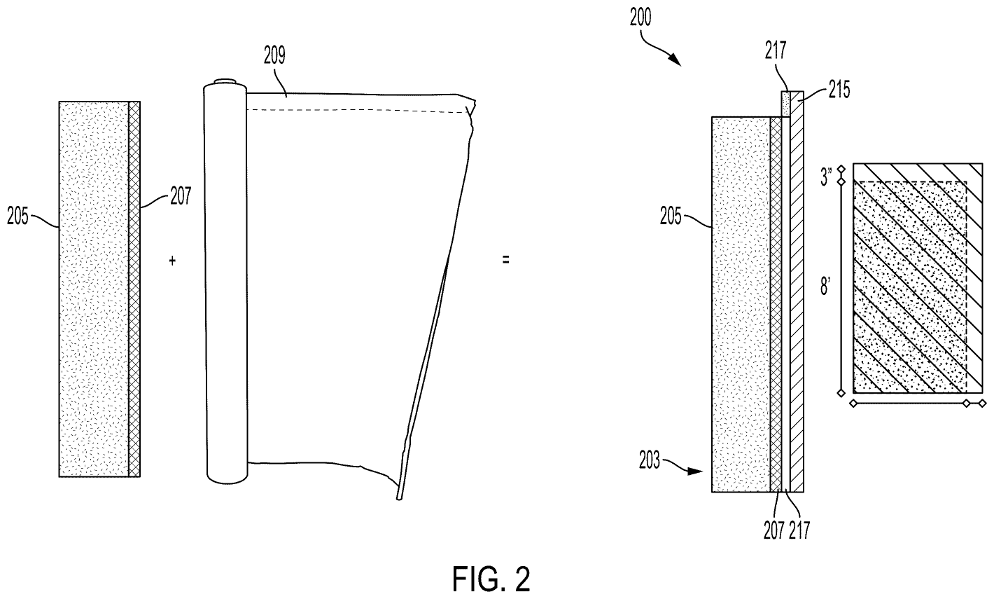

### FIG. 2

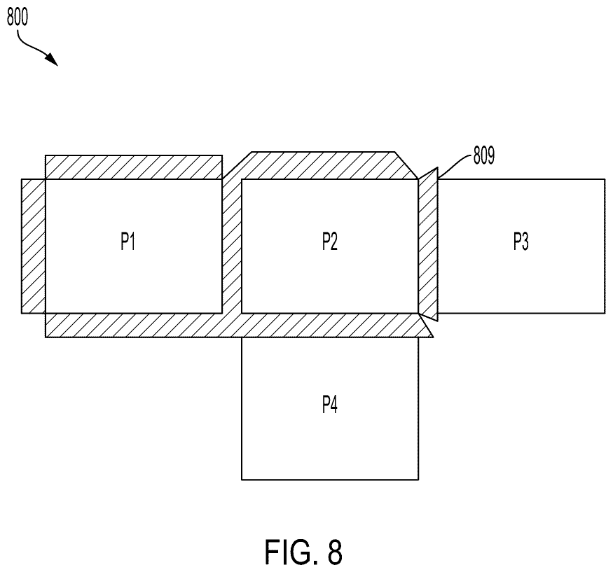

FIG. 2 describes the three-layered IS panel in the wall configuration, for example, the IWS panel 200, as one embodiment of the present invention in general terms. The panel 200 comprises an optional facer layer 203, for example, a metallized polypropylene (PP) layer, an insulation layer 205, a structurally-stable layer such as an OSB board 207, an optional fastener-gasketing adhesive layer 213, a WRB layer 209 with an extension flap 215 extending over at least one side of the IWS panel 200 with or without an adhesive layer. On the back side of the extension flap 215 is removably attached a release-liner layer 217, such that once the panel is put in place on the existing wall with other panels to form a panel assembly (see for example, FIG. 8), the release-liner 217 can be removed to provide adhesion of the WRB layer 209, which would overlap with the WRB layer of an adjacent IWS panel, creating a seal between the two panels. This reduces the effort on part of the installer to apply the WRB layer, cutting it to proper size, and provides a much more efficient sealing with only nominal air-pockets, if any, between the WRB layer and the structurally-stable layer 207.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising:
providing a plurality of IS panels, wherein at least one panel is as recited in the above embodiments;
securing each of the plurality of the IS panels to a structural element of the wall; removing the release-liner from the back of the extension flap; and sealing the seams between the individual IS panels of the plurality of panels.

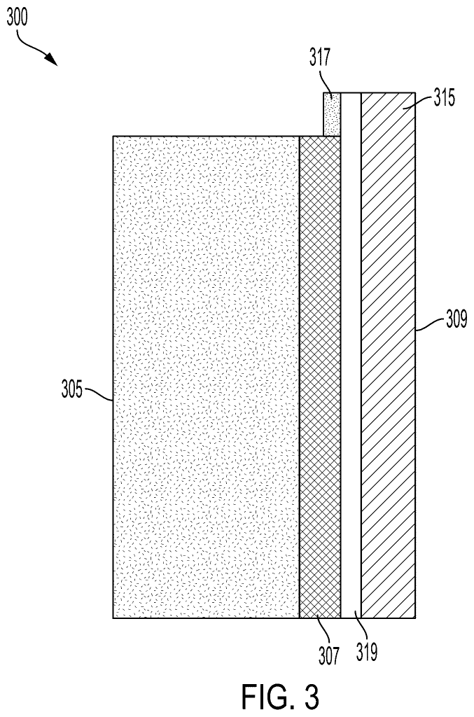

### FIG. 3

In one embodiment, this invention relates to a first IS panel such as an IWS panel 300, as shown in FIG. 3, used for construction purposes, comprising the following layers:
a. an insulation layer 305, for example, foam;
b. a structurally-stable (SS) panel or layer 307 such as a first wood-composite panel; and
c. a weather-resistive barrier (WRB) layer 309;
wherein the first weather-resistive barrier 309 layer exceeds the dimension of the structurally stable panel such as a wood-composite panel 307 from at least one of its edges to create an extension flap 315 along the edges. In one embodiment, the WRB layer 309 is adhered to the SS panel 307, wherein the adhesion is through the adhesive 319 on the back of the WRB layer 309. In other words, this adhesive layer is different from an optional fastener-gasketing adhesive layer (not shown). Stated differently, the first adhesive layer, or the second adhesive layer, or both adhesive layers may be present in the embodiments of the invention. The first one is the adhesive layer 319 of the WRB layer 309, and the second one is the fastener-gasketing adhesive layer not shown here. FIG. 3 shows the first adhesive layer 319. On the back side of the extension flap 315 is removably attached a release-liner layer 317, such that once the panel is installed on the existing wall with other panels to form a panel assembly, the release-liner 317 can be removed to provide adhesion of the WRB layer 309, which would overlap with the WRB layer of an adjacent IWS panel, creating a seal between the two panels.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising: providing a plurality of IS panels, wherein at least one panel is as recited in the above embodiments; securing each of the plurality of the IS panels to a structural element of the wall; removing the release-liner from the back of the extension flap; and sealing the seams between the individual IS panels of the plurality of panels.

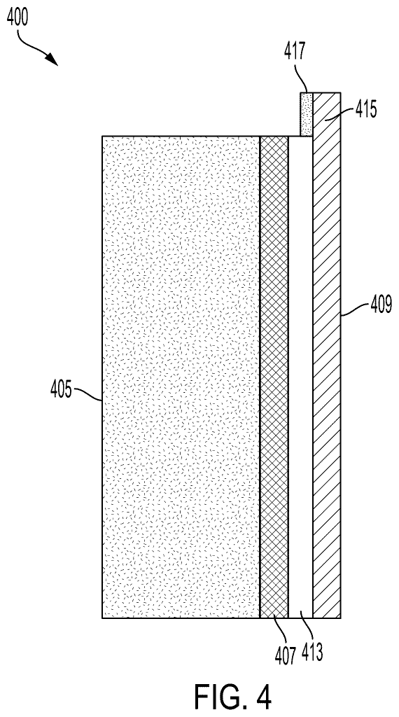

### FIG. 4

FIG. 4 shows a nail-gasketing adhesive 413, along with other layers of the IS panel such as an IWS panel 400, namely insulation layer 405 such as foam, a structurally-stable layer 407 such as an OSB board, a fastener-gasketing adhesive layer 413, and a WRB layer 409 with or without an adhesive on its back. The weather-resistive barrier layer 409 layer exceeds the dimension of the SS panel 407 from at least one of its edges to create an extension flap 415 along the edges. On the back side of the extension flap 415 is removably attached a release-liner layer 417, such that once the panel is put in place on the existing wall with other panels to form a panel assembly, the release-liner 417 can be removed to provide adhesion of the WRB layer 409, which would overlap with the WRB layer of an adjacent IWS panel, creating a seal between the two panels.

In another embodiment, this invention relates to a first IWS panel used for construction purposes, comprising the following layers:
a. a first insulation layer having an outer surface and an inner surface;
b. a first structurally-stable panel such as a wood-composite panel having an outer surface and an inner surface, and at least one edge extending between its outer surface and the inner surface; wherein the inner surface of the first insulation layer is planarly and contactably attached to the outer surface of the first structurally-stable panel such as a wood-composite panel; and
c. a first WRB layer having an outer surface and an inner surface, wherein the inner surface of the WRB layer is secured to the outer surface of the first structurally-stable panel such as a wood-composite panel;
wherein the WRB layer exceeds the dimension of the wood-composite panel from at least one of its edges to create an extension flap; and
wherein the extension flap of the WRB layer further comprises a removably attached release-liner attached to the WRB layer's inner surface.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls. In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising:
providing a plurality of IS panels, wherein at least one panel is as recited in the above embodiments;
securing each of the plurality of the IS panels to a structural element of the wall; removing the release-liner from the back of the extension flap; and sealing the seams between the individual IS panels of the plurality of panels.

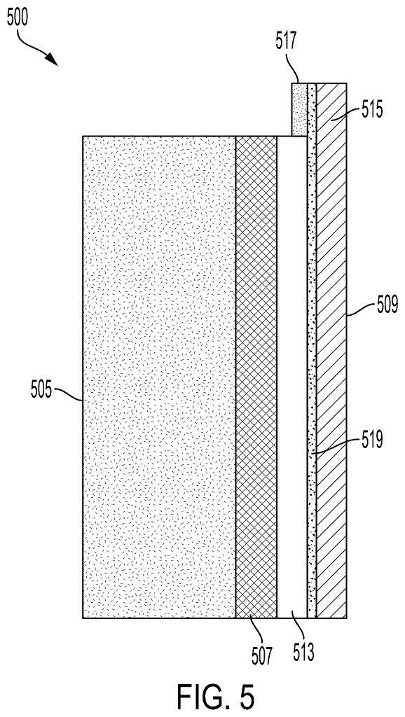

### FIG. 5

As shown in FIG. 5, in one embodiment, this invention relates to a first IS panel such as a first IWS panel 500 used for construction purposes, comprising the following layers:
a1. an optional first insulation facer layer (not shown);
a. a first insulation layer 505;
b. a first structurally-stable layer 507 such as a wood-composite panel; and
c. a first weather-resistive barrier (WRB) layer 509;
wherein the first WRB layer 509 exceeds the dimension of the first structurally-stable layer 507 such as a wood-composite panel from at least one of its edges to create an extension flap 515 along the edges, wherein an optional adhesive 519 on the back of the WRB layer and a fastener-gasketing layer 513 is provided. On the back side of the extension flap 515 is removably attached a release-liner layer 517, such that once the panel is put in place on the existing wall with other panels to form a panel assembly, the release-liner 517 can be removed to provide adhesion of the WRB layer 509, which would overlap with the WRB layer of an adjacent IWS panel, creating a seal between the two panels. See FIG. 5, for example.

More specifically, in one embodiment, this invention relates a first insulation wall-sheathing (IWS) panel used for construction purposes, for example, to externally envelope a building having a structural frame, the IWS panel comprising:
a1. an optional first insulation facer layer having an outer surface and an inner surface;
a. a first insulation layer having an outer surface and an inner surface; wherein the inner surface of the first insulation facer layer is planarly and contactably attached to the outer surface of the first insulation layer;
b. a first structurally-stable (SS) layer such as a wood-composite panel having an outer surface and an inner surface, and at least one edge extending between its outer surface and the inner surface; wherein the inner surface of the first insulation layer is planarly and contactably attached to the outer surface of the first structurally-stable (SS) layer such as a wood-composite panel; and
c. a first WRB layer having an outer surface and an inner surface, wherein the inner surface of the WRB layer is secured to the outer surface of the first structurally-stable (SS) layer such as a wood-composite panel;
wherein the WRB layer exceeds the dimension of the first structurally-stable (SS) layer from at least one of its edges to create an extension flap; and
wherein the extension flap of the WRB layer further comprises a removably attached release-liner attached to the WRB layer's inner surface.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising:
providing a plurality of IS panels, wherein at least one panel is as recited in the above embodiments;
securing each of the plurality of the IS panels to a structural element of the wall; removing the release-liner from the back of the extension flap; and sealing the seams between the individual IS panels of the plurality of panels.

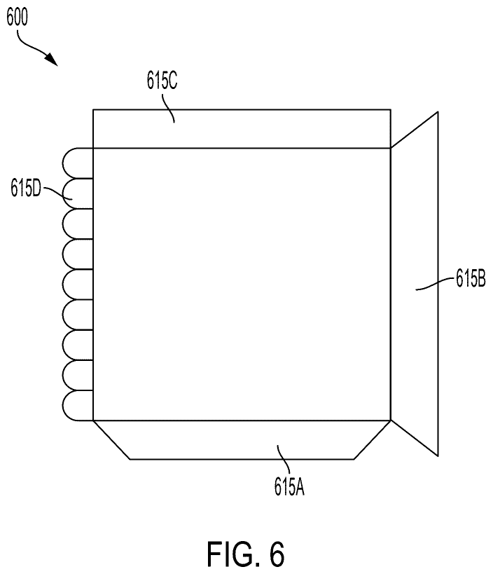

### FIG. 6

FIG. 6 describes a first IS panel such as a first IWS panel 600 with the various exemplary shapes (615A, 615B, 615C, 615D) of the extension flap that can be used with a removably attached release-liner on its back. An IWS panel of this invention may have one flap or more than one flap, wherein each flap is the same shape and/or size, or at least one flap is of different shape or different size.

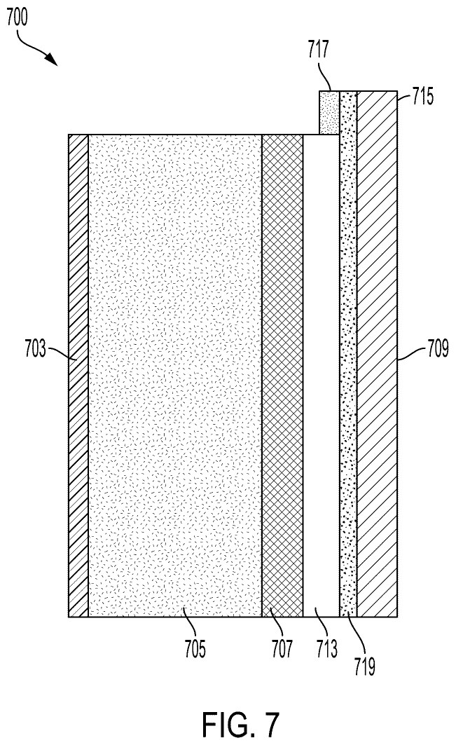

### FIG. 7

In one embodiment, as shown in FIG. 7, this invention relates to a first IS panel such as a first IWS panel 700 used for construction purposes, comprising the following layers:
a1. a first insulation facer layer 703;
a. a first insulation layer 705;
b. a first structurally-stable panel 707, such as a wood-composite panel;
cl. a first fastener-gasketing layer 713; and
c. a first weather-resistive barrier (WRB) layer 709, the first WRB layer 709 having an outer surface and an inner surface, wherein the inner surface of the WRB layer is secured to the outer surface of the first wood-composite panel 707 through an optional adhesive layer 719; wherein the extension flap 715 of the WRB layer 709 further comprises a removably attached release-liner 717 attached to the barrier layer 709's inner surface.

More specifically, in one embodiment, this invention relates to a first IWS panel used for construction purposes, for example, to externally envelope a building having a structural frame, the IWS panel comprising:
a1. a first insulation facer layer having an outer surface and an inner surface;
a. a first insulation layer having an outer surface and an inner surface; wherein the inner surface of the first insulation facer layer is planarly and contactably attached to the outer surface of the first insulation layer;
b. a first wood-composite panel having an outer surface and an inner surface, and at least one edge extending between its outer surface and the inner surface; wherein the inner surface of the first insulation layer is planarly and contactably attached to the outer surface of the first wood-composite panel; and
cl. a first fastener-gasketing layer having an outer surface and an inner surface; wherein the inner surface of the OSB panel is planarly and contactably attached to the outer surface of the first fastener-gasketing layer; and
c. a first weather-resistive barrier (WRB) layer, the first WRB layer having an outer surface and an inner surface, wherein the inner surface of the WRB layer is secured to the outer surface of the first wood-composite panel through an optional adhesive layer; and wherein the extension flap of the WRB layer further comprises a removably attached release-liner attached to the barrier layer's inner surface;
wherein the WRB layer exceeds the dimension of the wood-composite panel from at least one of its edges to create an extension flap; and
wherein the extension flap of the WRB layer further comprises a removably attached release-liner attached to the barrier layer's inner surface.

In one embodiment, this invention relates to a panel assembly comprising at least two panels juxtaposed and/or adhered to each other, wherein at least one panel is according to the embodiments described above. Stated differently, all panels of the panel assembly can comprise of any one embodiment described above, more than one embodiments described above, or can include other types of IWS panels that may not be described above, as long as at least one such panel of the panel assembly is from an embodiment described above.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM). In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising:
providing a plurality of IS panels, wherein at least one panel is as recited in the above embodiments;
securing each of the plurality of the IS panels to a structural element of the wall; removing the release-liner from the back of the extension flap; and sealing the seams between the individual IS panels of the plurality of panels.

### FIG. 8

As shown in FIG. 8, panel assembly P1-P4 are IS panels such as IWS panels, with the sealing done by the release-liner removal from the back of the WRB layer 809, at its one or more edges. Various exemplary shapes of the extension flap are shown in the panel assembly. The following examples further exemplify additional embodiments of the invention.

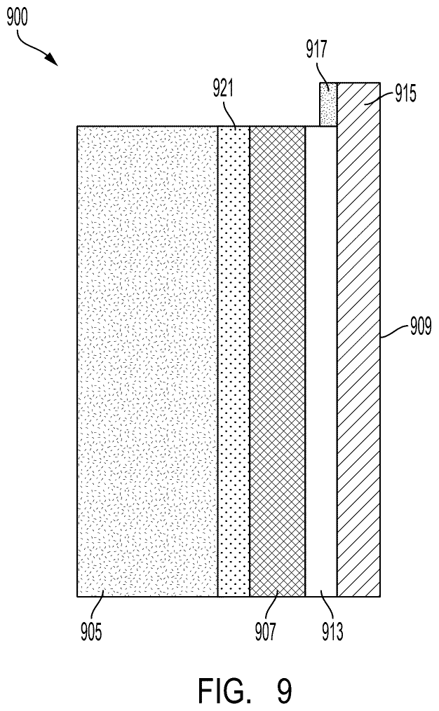

### FIG. 9

As shown in FIG. 9, in one embodiment, the present invention relates to a first IS panel such as a first IWS panel 900 used for construction purposes, comprising the following layers:
a first insulation layer 905 having an outer surface and an inner surface;
a first structurally-stable panel 907 having an outer surface and an inner surface, and at least one edge extending between its outer surface and the inner surface; wherein the inner surface of the first insulation layer 905 is planarly and contactably attached to the outer surface of the first structurally-stable panel 907;
a second structurally-stable panel 921 having an outer surface and an inner surface, and at least one edge extending between its outer surface and the inner surface; wherein the inner surface of the first structurally-stable panel 907 is planarly and contactably attached to the outer surface of the second structurally-stable panel 921; and
a first WRB layer 909 having an outer surface and an inner surface, wherein the inner surface of the WRB layer 909 is secured to the outer surface of the second structurally-stable panel 921;
wherein the WRB layer 909 exceeds the dimensions of at least one of the structurally-stable panels 907 and 921 from at least one of its edges to create an extension flap 915; and
wherein the extension flap 915 of the WRB layer 909 further comprises a removably attached release-liner 917 attached to the WRB layer 909's inner surface.

In a variation to the above embodiment, the insulation layer can be adhered or secured to first structurally-stable panel using an adhesive, as described later in this disclosure. In a further variation to the above two embodiments, the first structurally-stable panel and the second structurally-stable panel are planarly and contactably attached to each other by an adhesive. In a further variation to the above embodiments, the second structurally-stable panel is planarly and contactably attached to a fastener-gasketing adhesive layer 913, and the fastener-gasketing adhesive layer 913 is planarly and contactably attached to the WRB layer 909 through the second adhesive that is included on the inside of the WRB layer (not shown). In one embodiment, the fastener-gasketing adhesive is an optional component of the above-recited embodiment.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising:
providing a plurality of IS panels, wherein at least one panel is as recited in the above embodiments;
securing each of the plurality of the IS panels to a structural element of the wall; removing the release-liner from the back of the extension flap; and sealing the seams between the individual IS panels of the plurality of panels.

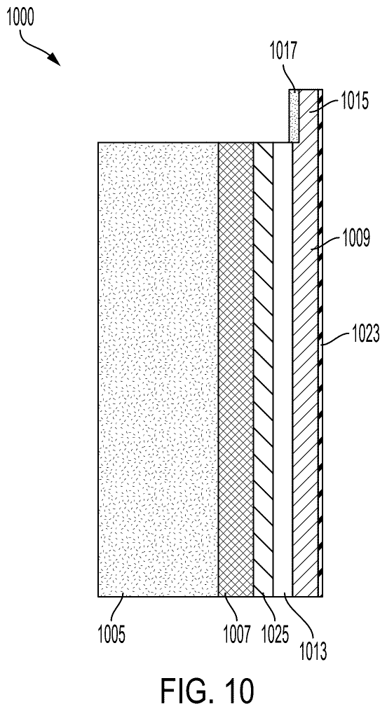

### FIG. 10

As shown in FIG. 10, in one embodiment, the present invention relates to a first IS panel such as a first IWS panel 1000 used for construction purposes, comprising the following layers:
a first insulation layer 1005 having an outer surface and an inner surface;
a first structurally-stable panel 1007 having an outer surface and an inner surface, and at least one edge extending between its outer surface and the inner surface; wherein the inner surface of the first insulation layer 1005 is planarly and contactably attached to the outer surface of the first structurally-stable panel 1007;
a first heat-sealant layer 1025 having an outer surface and an inner surface, and at least one edge extending between its outer surface and the inner surface; wherein the inner surface of the first structurally-stable panel 1007 is planarly and contactably attached to the outer surface of the first heat-sealant layer 1025; and
a first WRB layer 1009 having an outer surface and an inner surface, wherein the inner surface of the WRB layer 1009 is secured to the outer surface of the heat-sealant layer 1025;
wherein the WRB layer 1009 exceeds the dimension of the heat-sealant layer from at least one of its edges to create an extension flap 1015; and
wherein the extension flap 1015 of the WRB layer 1009 further comprises a removably attached release-liner 1017 attached to the WRB layer 1009's inner surface.

In a variation to the above embodiment, the insulation layer can be adhered or secured to first structurally-stable panel 1007 using an adhesive, as described later in this disclosure. In a further variation to the above two embodiments, the first structurally-stable panel 1007 and the heat-sealant layer 1025 are planarly and contactably attached to each other by the use of an adhesive or other fastening means. In a further variation to the above embodiments, the heat-sealant layer 1025 planarly and contactably attached to a fastener-gasketing adhesive 1013, and the fastener-gasketing adhesive 1013 is planarly and contactably attached to the WRB layer through a second adhesive that is included on the WRB layer 1009. In one embodiment, the fastener-gasketing adhesive 1013 is an optional component of the above-recited embodiment. In other words, the heat-sealant layer 1025 is directly attached, planarly and contactably, to the WRB layer 1009 through the adhesive (not shown) on the WRB layer 1009.

In another embodiment, and as shown in FIG. 10, an optional print layer 1023 is also attached or deposited on the WRB layer 1009. The print layer can be an intumescent coating layer as described later in this disclosure.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising:
providing a plurality of IS panels, wherein at least one panel is as recited in the above embodiments;
securing each of the plurality of the IS panels to a structural element of the wall; removing the release-liner from the back of the extension flap; and sealing the seams between the individual IS panels of the plurality of panels.

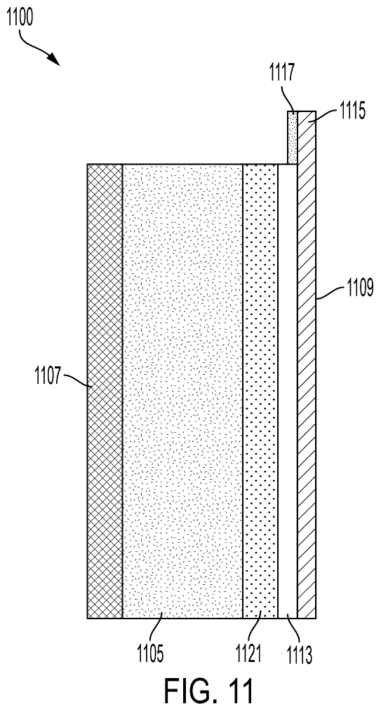

### FIG. 11

As shown in FIG. 11, in one embodiment, the present invention relates to a first IS panel such as a first IWS panel 1100 used for construction purposes, comprising the following layers:
a first structurally-stable panel 1107 having an outer surface and an inner surface, and at least one edge extending between its outer surface and the inner surface;
a first insulation layer 1105 having an outer surface and an inner surface; wherein the outer surface of the first insulation layer 1105 is planarly and contactably attached to the inner surface of the first structurally-stable panel 1107;
a second structurally-stable panel 1121 having an outer surface and an inner surface, and at least one edge extending between its outer surface and the inner surface; wherein the outer surface of the second structurally-stable panel 1121 is planarly and contactably attached to the inner surface of the first insulation panel 1105; and
a first WRB layer 1109 having an outer surface and an inner surface, wherein the inner surface of the WRB layer 1109 is secured to the outer surface of the second structurally-stable panel 1121;
wherein the WRB layer 1109 exceeds the dimensions of at least one of the two structurally-stable panels 1107 and 1121 from at least one of its edges to create an extension flap 1115; and
wherein the extension flap 1115 of the WRB layer 1109 further comprises a removably attached release-liner 117 attached to the WRB layer 1109's inner surface.

In a variation to the above embodiment, the insulation layer 1105 can be adhered or secured to first structurally-stable panel 1107 using an adhesive, as described later in this disclosure. In a further variation to the above two embodiments, the insulation layer 1105 and the first structurally-stable panel 1107, and the insulation layer 1105 and the second structurally-stable panel 1107 are planarly and contactably attached to each other by use of an adhesive or other fastening means.

In a further variation to the above embodiments, the second-structurally stable panel 1121 is planarly and contactably attached to a fastener-gasketing adhesive layer 1113, and the fastener-gasketing adhesive layer 1121 is planarly and contactably attached to the WRB layer 1109 through a second adhesive that is included on the WRB layer 1109. In one embodiment, the fastener-gasketing adhesive layer 1113 is an optional component of the above-recited embodiment. In other words, the second structurally-stable panel 1121 is directly attached, planarly and contactably, to the WRB layer 1109 through the adhesive (not shown) on the WRB layer 1109.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising:
providing a plurality of IS panels, wherein at least one panel is as recited in the above embodiments;
securing each of the plurality of the IS panels to a structural element of the wall; removing the release-liner from the back of the extension flap; and sealing the seams between the individual IS panels of the plurality of panels.

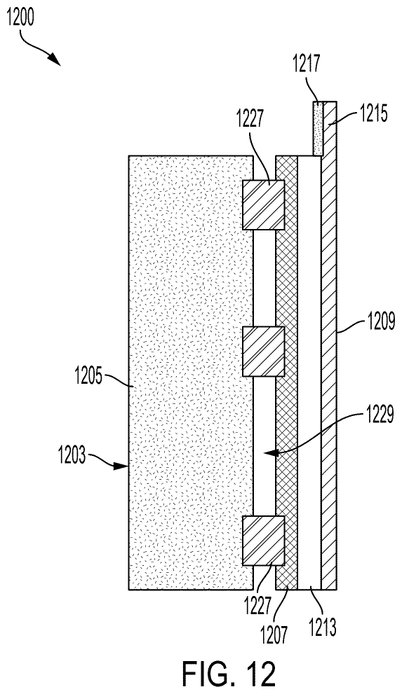

### FIG. 12

As shown in FIG. 12, in one embodiment, the present invention relates to a first IS panel such as a first IWS panel 1200 used for construction purposes, comprising the following layers:
a first insulation layer 1205 having an outer surface and an inner surface;
a first structurally-stable panel 1207 having an outer surface and an inner surface, and at least one edge extending between its outer surface and the inner surface;
a set of strips 1227 partially embedded in the first insulation layer 1205, wherein the set of strips 1227 contact the first structurally-stable layer 1207 at their non-embedded end; wherein said strips 1227 create air-pockets 1229 in conjunction with said first insulation layer 1205 and said structurally-stable panel 1207; and
a first WRB layer 1209 having an outer surface and an inner surface, wherein the inner surface of the WRB layer 1209 is secured to the outer surface of the first structurally-stable panel 1207;
wherein the WRB layer 1209 exceeds the dimension of the structurally-stable panel 1207 from at least one of its edges to create an extension flap 1215; and
wherein the extension flap 1215 of the WRB layer 1209 further comprises a removably attached release-liner attached to the WRB layer 1209's inner surface.

In a variation to the above embodiment, contact strips 1227 are variably embedded, depthwise, in the insulation layer 1205 to create either an even air-gap or an uneven air-gap 1229 between the insulation layer and the first-structurally stable panel 1207. In one embodiment, the strips 1227 are almost fully or partially embedded in the insulation layer and are planarly and contactably attached on their other end to the first-structurally stable panel 1207 by use of an adhesive or other fastening means. In another variation of the embodiments herein, the air-pocket strips form a geometric pattern or an irregular pattern. In another variation to this embodiment, the pattern, geometric or otherwise, is prepared such that it facilitates removal of water or moisture through drainage.

In a further variation to the above embodiments, the first structurally-stable panel 1207 is planarly and contactably attached to a fastener-gasketing adhesive layer 1213, and the fastener-gasketing adhesive layer 1213 is planarly and contactably attached to the WRB layer 1209 through a second adhesive that is included on the WRB layer 1209. In one embodiment, the fastener-gasketing adhesive layer 1209 is an optional component of the above-recited embodiment. In other words, the first structurally-stable panel 1207 is directly attached, planarly and contactably, to the WRB layer 1209 through the adhesive (not shown in FIG. 12) on the WRB layer 1209.

In a further variation to the above embodiments, a second structurally-stable panel is planarly and contactably attached to the other side on the insulation layer.

In an additional variation the above embodiments, the IWS panel 1200 comprises an insulation facer 1203 planarly and contactably attached to the outside surface of the insulation layer 1205 through an adhesive, as described infra.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising: providing a plurality of IS panels, wherein at least one panel is as recited in the above embodiments; securing each of the plurality of the IS panels to a structural element of the wall; removing the release-liner from the back of the extension flap; and sealing the seams between the individual IS panels of the plurality of panels.

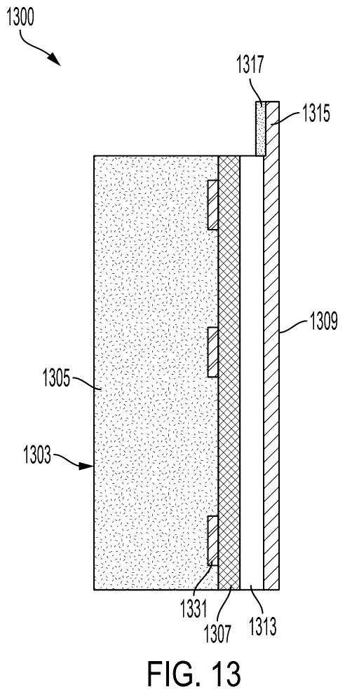

### FIGS. 13, 16, and 17

As shown in FIGS. 13, 16, and 17, in one embodiment, the present invention relates to a first insulation sheathing (IS) panel such as a first IWS panel 1300 used for construction purposes, comprising the following layers:
a first insulation layer 1305 having an outer surface and an inner surface;
a set of strips 1327 embedded in the first insulation layer 1305 with their non-embedded ends exposed but nominally flush with the inner surface of the insulation layer 1305;
a first structurally-stable panel 1307 having an outer surface and an inner surface, and at least one edge extending between its outer surface and the inner surface; wherein the inner surface of the first insulation layer 1305 is planarly and contactably adjacent to the outer surface of the first structurally-stable panel 1307, and wherein the non-embedded or exposed ends of the strips 1327 are in contact with the outer surface of the first structurally-stable panel 1307; and
a first WRB layer 1309 having an outer surface and an inner surface, wherein the inner surface of the WRB layer 1309 is secured to the outer surface of the first structurally-stable panel 1307;
wherein the WRB layer 1309 exceeds the dimension of the structurally-stable panel 1307 from at least one of its edges to create an extension flap 1315; and
wherein the extension flap 1315 of the WRB layer 1309 further comprises a removably attached release-liner 1317 attached to the WRB layer 1309's inner surface.

In a variation to the above embodiment, contact strips 1327 are uniformly embedded or variably embedded, depthwise, in the insulation layer 1305 to create an even air-gap, or an uneven air-gap 1329, or virtually no air-gap between the insulation layer 1305 and the first-structurally stable panel 1307.

In one embodiment, the strips 1327 are almost fully or partially embedded in the insulation layer 1305 and are planarly and contactably attached on their other end to the first-structurally stable panel 1307 by use of an adhesive or other fastening means. In another variation of the embodiments herein, the strips form a geometric pattern or an irregular pattern. In another variation to this embodiment, the pattern, geometric or otherwise, is prepared such that it facilitates removal of water or moisture through drainage.

In a further variation to the above embodiments, the first structurally-stable panel 1307 is planarly and contactably attached to a fastener-gasketing adhesive layer 1313, and the fastener-gasketing adhesive layer 1313 is planarly and contactably attached to the WRB layer 1309 through a second adhesive (not shown in FIG. 13, 16, or 17) that is included on the WRB layer 1309. In one embodiment, the fastener-gasketing adhesive layer 1313 is an optional component of the above-recited embodiment. In other words, the first structurally-stable panel is directly attached, planarly and contactably, to the WRB layer 1309 through the adhesive on the WRB layer.

In a further variation to the above embodiments, a second structurally-stable panel is planarly and contactably attached to the other side on the insulation layer.

In an additional variation the above embodiments, the IWS panel 1300 comprises an insulation facer 1303 planarly and contactably attached to the outside surface of the insulation layer 1305 through an adhesive, as described infra.

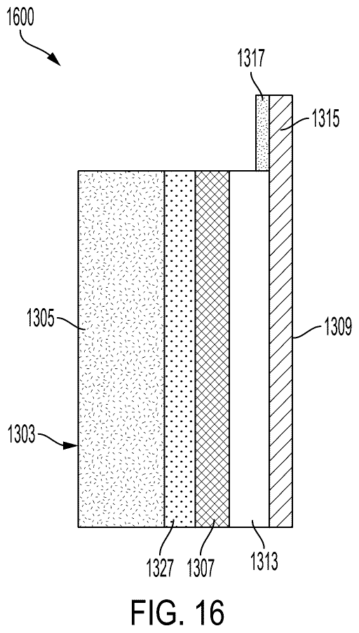

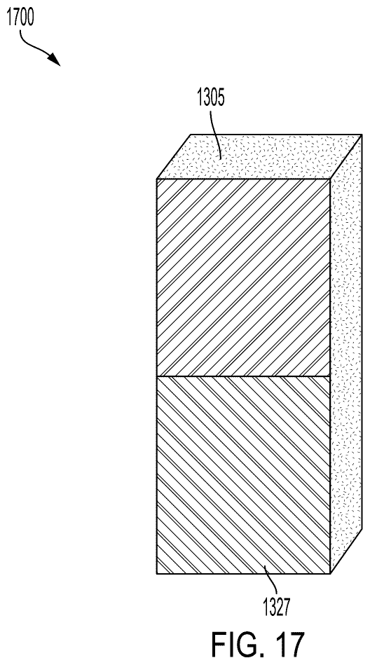

To be clear, FIGS. 16 and 17 further elaborate FIG. 13 from a different perspective.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising: providing a plurality of IS panels, wherein at least one panel is as recited in the above embodiments; securing each of the plurality of the IS panels to a structural element of the wall; removing the release-liner from the back of the extension flap; and sealing the seams between the individual IS panels of the plurality of panels.

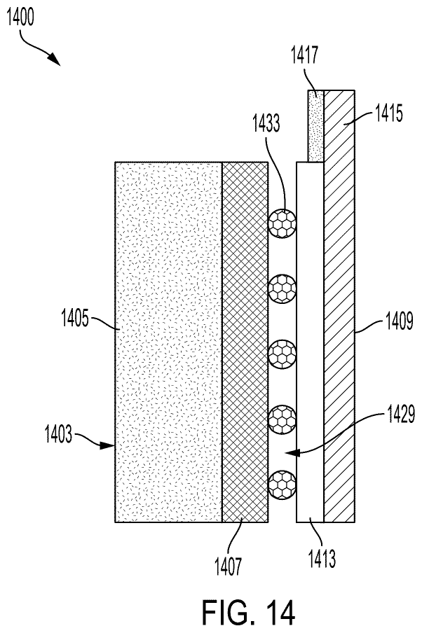

### FIG. 14

As shown in FIG. 14, in one embodiment, the present invention relates to a first insulation sheathing (IS) panel such as a first insulation wall sheathing (IWS) panel 1400 used for construction purposes, comprising the following layers:
a first insulation layer 1405 having an outer surface and an inner surface;
a first structurally-stable panel 1407 having an outer surface and an inner surface, and at least one edge extending between its outer surface and the inner surface;
a plurality of insulation beads 1433 in contact with the first structurally-stable layer 1407;
a first WRB layer 1409 having an outer surface and an inner surface, wherein the inner surface of the WRB layer 1409 is secured to the plurality of insulation beads 1433; wherein said insulation beads 1433 create air-pockets 1429 in conjunction with said first structurally-stable panel 1407 and said WRB layer 1409; and
wherein the WRB layer 1409 exceeds the dimension of the first structurally-stable panel 1407 from at least one of its edges to create an extension flap 1415; and
wherein the extension flap 1415 of the WRB layer 1409 further comprises a removably-attached release-liner 1417 attached to the WRB layer 1409's inner surface.

In a variation to the above embodiment, insulation beads 1433 are of unform or variable size in their planar or perpendicular dimensions to the first structurally-stable panel 1407 to create either an even air-gap or an uneven air-gap (1429) between the WRB layer 1409 and the first-structurally stable panel 1407. In another variation of the embodiments herein, the beads 1433 form a geometric pattern or an irregular pattern in the plane in which they are located. In another variation to this embodiment, the pattern, geometric or otherwise, is prepared such that it facilitates removal of water or moisture through drainage.

In a further variation to the above embodiments, the first structurally-stable panel 1407 is planarly and contactably attached to a fastener-gasketing adhesive layer 1413, and the fastener-gasketing adhesive layer 1413 is planarly and contactably attached to the WRB layer 1409 through a second adhesive (not shown in FIG. 14) that is included on the WRB layer 1409. In one embodiment, the fastener-gasketing adhesive layer 1413 is an optional component of the above-recited embodiment. In other words, the first structurally-stable panel is directly attached, planarly and contactably, to the WRB layer 1409 through the adhesive on the WRB layer 1409.

In a further variation to the above embodiments, a second structurally-stable panel is planarly and contactably attached to the other side on the insulation layer.

In an additional variation the above embodiments, the IWS panel 1400 comprises an insulation facer 1403 planarly and contactably attached to the outside surface of the insulation layer 1405 through an adhesive, as described infra.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising: providing a plurality of IS panels, wherein at least one panel is as recited in the above embodiments; securing each of the plurality of the IS panels to a structural element of the wall; removing the release-liner from the back of the extension flap; and sealing the seams between the individual IS panels of the plurality of panels.

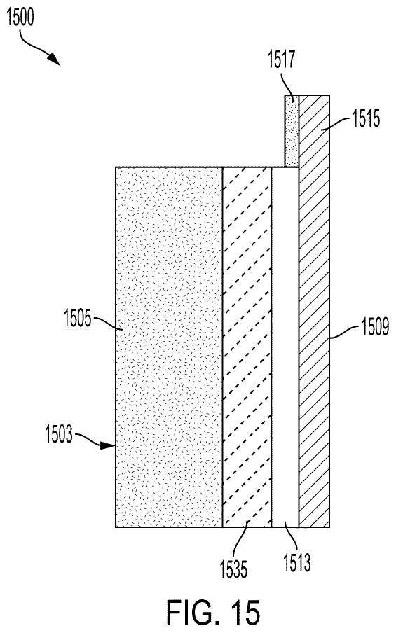

### FIG. 15

As shown in FIG. 15, in one embodiment, the present invention relates to a first insulation sheathing (IS) panel such as a first insulation wall sheathing (IWS) panel 1500 used for construction purposes, comprising the following layers:
a first insulation layer 1505 having an outer surface and an inner surface;
a first structurally-stable panel 1535 having an outer surface and an inner surface, and at least one edge extending between its outer surface and the inner surface;
a first WRB layer 1509 having an outer surface and an inner surface; and
wherein the WRB layer 1509 exceeds the dimension of the first structurally-stable panel 1507 from at least one of its edges to create an extension flap 1515; and
wherein the extension flap 1515 of the WRB layer 1509 further comprises a removably-attached release-liner 1517 attached to the WRB layer 1509's inner surface; and wherein the structurally-stable panel 1535 is a non-OSB board, comprising, for example, wood-composite, grass, rice hulls, MgO, compalite, and other plant-based materials. For example, in one embodiment, the structurally-stable panel is a composite board such as the EcoStorm® coverboard obtained from Carlisle Corporation of Mechanicsburg, Pennsylvania. The EcoStorm® coverboard is an engineered composite building material made from a blend of plastic and cellulose fiber. In one embodiment of the invention, the composite board is sourced from post-industrial and post-consumer waste streams. In another embodiment, such composite board is a durable, moisture and mold resistant building material.

In a further variation to the above embodiments, the first structurally-stable panel is planarly and contactably attached to a fastener-gasketing adhesive layer 1513, and the fastener-gasketing adhesive layer 1513 is planarly and contactably attached to the WRB layer 1509 through a second adhesive (not shown in FIG. 15) that is included on the WRB layer 1509. In one embodiment, the fastener-gasketing adhesive is an optional component of the above-recited embodiment. In other words, the first structurally-stable panel is directly attached, planarly and contactably, to the WRB layer through the adhesive on the WRB layer.

In a further variation to the above embodiments, a second structurally-stable panel is planarly and contactably attached to the other side on the insulation layer, wherein the second structurally-stable panel is the same as the first structurally-stable panel as described above, or as described infra.

In an additional variation the above embodiments, the IWS panel comprises an insulation facer 1503 planarly and contactably attached to the outside surface of the insulation layer 1505 through an adhesive, as described infra.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising: providing a plurality of IS panels, wherein at least one panel is as recited in the above embodiments; securing each of the plurality of the IS panels to a structural element of the wall; removing the release-liner from the back of the extension flap; and sealing the seams between the individual IS panels of the plurality of panels.

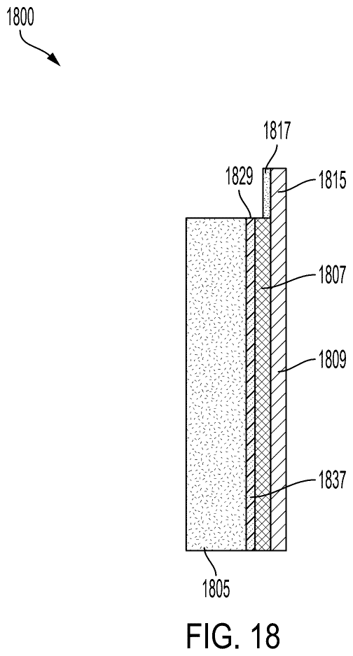

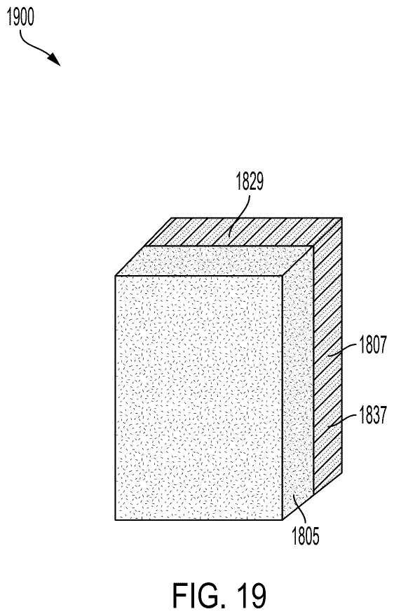

### FIGS. 18 and 19

As shown in FIGS. 18 and 19, in one embodiment, the present invention relates to a first insulation sheathing (IS) panel such as a first insulation wall sheathing (IWS) panel 1800 and its partial perspective view in 1900, used for construction purposes, comprising the following layers:
a first insulation layer 1805 having an outer surface and an inner surface;
a first structurally-stable panel 1807 having an outer surface and an inner surface, and at least one edge extending between its outer surface and the inner surface; wherein the inner surface of the first insulation layer 1805 is planarly and contactably adjacent to the outer surface of the first structurally-stable panel 1807, and the insulation layer 1805 is optionally attached with an adhesive tape 1837, planarly and contactably, to the structurally-stable panel 1807;
wherein the insulation layer 1805 and the structurally-stable panel 1807 are attached to each other through an adhesive tape 1837 on at least one edge, and preferably on all four edges, wherein the tape 1837 covers of the combined insulation layer 1805 and the structurally-stable panel 1807 fully or partially; and
a first WRB layer 1809 having an outer surface and an inner surface, wherein the inner surface of the WRB layer 1809 is secured to the outer surface of the first structurally-stable panel 1807;
wherein the WRB layer exceeds the dimension of the structurally-stable panel from at least one of its edges to create an extension flap 1815; and
wherein the extension flap 1815 of the WRB layer 1809 further comprises a removably-attached release-liner 1817 attached to the WRB layer 1809's inner surface.

In one embodiment, the insulation layer has no adhesive that planarly and contactably assists in adhesion to the structurally-stable panel, but instead, the insulation layer, such as a foam, and the structurally-stable panel such as an OSB board, are attached at their edges by a tape means, or other means such that there is a nominal or more than nominal airgap (1829) in between the insulation layer 1805 and the structurally stable panel 1807. Stated differently, the absence of an adhesive that assists in planarly and contactably attaching the insulation layer 1805 and the structurally-stable panel 1807 can create air gaps 1829 by virtue of the roughness of the two surfaces or the width of the air-gap can be specifically engineered, as desired. The tape or edge-attachment means allow for existence of such air-gap 1829, which can provide additional insulation. In another variation of the embodiment, the edge-attachment means such as a tape is used at one edge, two edges, three edges, or four edges (and multiple edges depending on the shape of the IWS panel). In another variation of the embodiment, the taping of the edges is performed in conjunction with a planarly and contactably attached adhesive between the SS panel and the insulation layer. In a further variation to the above embodiments, the structurally-stable panel is planarly and contactably attached to a fastener-gasketing adhesive layer, and the fastener-gasketing adhesive layer is planarly and contactably attached to the WRB layer through the second adhesive that is included on the inside of the WRB layer. In one embodiment, the fastener-gasketing adhesive layer is an optional component of the above-recited embodiment.

In an additional variation the above embodiments, the IWS panel described above comprises an insulation facer planarly and contactably attached to the outside surface of the insulation layer, as described infra.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising: providing a plurality of IS panels, wherein at least one panel is as recited in the above embodiments; securing each of the plurality of the IS panels to a structural element of the wall; removing the release-liner from the back of the extension flap; and sealing the seams between the individual IS panels of the plurality of panels.

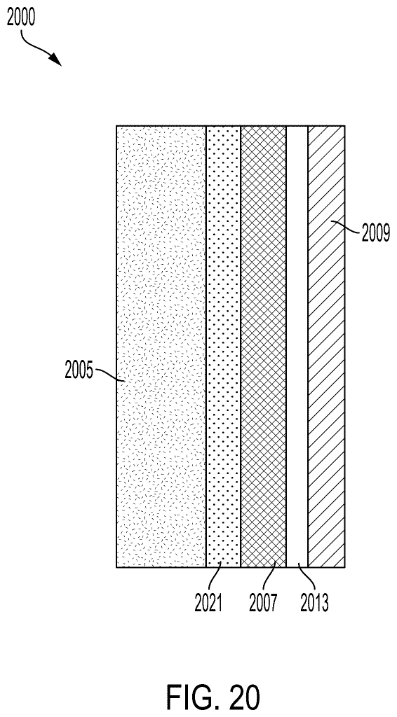

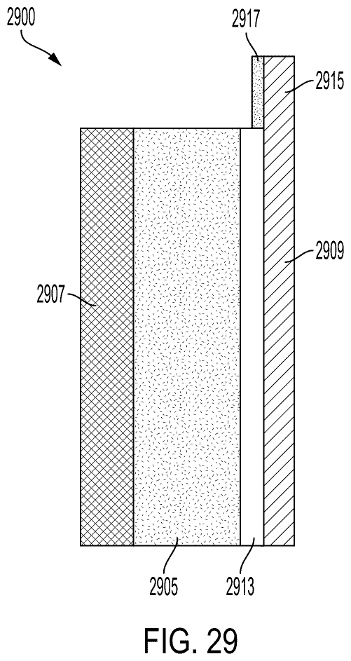

FIGS. 20-30 embodiments are described infra under a different section.

### FIG. 31

As shown in FIG. 31, in one embodiment, the present invention relates to a first insulation sheathing (IS) panel such as a first insulation wall sheathing (IWS) panel 3100 used for construction purposes, comprising the following layers:
a first insulation layer 3105 having an outer surface and an inner surface;
a first structurally-stable panel 3107 having an outer surface and an inner surface, and at least one edge extending between its outer surface and the inner surface; wherein the inner surface of the first insulation layer 3105 is planarly and contactably adjacent to the outer surface of the first structurally-stable panel 3107, and the insulation layer 3105 is optionally attached with an adhesive, planarly and contactably, to the structurally-stable panel 3107;
wherein the insulation layer 3105 and the structurally-stable panel are optionally attached to each other through an adhesive tape (not shown) on at least one edge, and preferably on all four edges, wherein the tape covers of the combined insulation layer and the structurally-stable panel fully or partially; and
a first WRB layer 3109 having an outer surface and an inner surface, wherein the inner surface of the WRB layer 3109 is secured to the outer surface of the first structurally-stable panel 3107;
wherein the WRB layer 3109 is further wrapped around to cover the insulation layer 3105, at least partially, from at least one of its edges to create an extension flap 3141; and
wherein the extension flap of the WRB layer 3109 further comprises a removably attached release-liner 3115 attached to the WRB layer 3109's inner surface.

In one embodiment, the insulation layer has no adhesive that planarly and contactably assists in adhesion to the structurally-stable panel, but instead, the insulation layer such as a foam and the structurally-stable panel such as an OSB board are attached at their edges by a tape means, or other means such that there is a nominal or more than nominal air-gap (3129 in FIG. 31) in between the insulation layer and the structurally stable panel. Stated differently, the absence of an adhesive that assists in planarly and contactably attaching the insulation layer and the structurally-stable panel can create air gaps by virtue of the roughness of the two surfaces or the width of the air-gap can be specifically engineered, as desired. The tape or edge-attachment means allow for existence of such air-gap, which can provide additional insulation. In another variation of the embodiment, the edge-attachment means such as a tape is used at one edge, two edges, three edges, or four edges (and multiple edges depending on the shape of the IWS panel). In another variation of the embodiment, the taping of the edges is performed in conjunction with a planarly and contactably attaching an adhesive between the SS panel and the insulation layer. In a further variation to the above embodiments, the structurally-stable panel is planarly and contactably attached to a fastener-gasketing adhesive layer (see FIG. 31, 3113), and the fastener-gasketing adhesive layer is planarly and contactably attached to the WRB layer through the second adhesive that is included on the inside of the WRB layer. In one embodiment, the fastener-gasketing adhesive is an optional component of the above-recited embodiment.

In an additional variation the above embodiments, the IWS panel described above comprises an insulation facer planarly and contactably attached to the outside surface of the insulation layer, as described infra.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising: providing a plurality of IS panels, wherein at least one panel is as recited in the above embodiments; securing each of the plurality of the IS panels to a structural element of the wall; removing the release-liner from the back of the extension flap; and sealing the seams between the individual IS panels of the plurality of panels.

FIG. 32

As shown in FIG. 32, in one embodiment, the present invention relates to a first insulation sheathing (IS) panel such as a first insulation wall sheathing (IWS) panel 3100 used for construction purposes, similar to FIG. 31, but with the flaps sealed, comprising the following layers:
a first insulation layer 3205 having an outer surface and an inner surface;
a first structurally-stable panel 3207 having an outer surface and an inner surface, and at least one edge extending between its outer surface and the inner surface; wherein the inner surface of the first insulation layer 3205 is planarly and contactably adjacent to the outer surface of the first structurally-stable panel 3207, and the insulation layer 3205 is optionally attached with an adhesive, planarly and contactably, to the structurally-stable panel 3207;
wherein the insulation layer 3205 and the structurally-stable panel are optionally attached to each other through an adhesive tape (not shown) on at least one edge, and preferably on all four edges, wherein the tape covers of the combined insulation layer and the structurally-stable panel fully or partially; and
a first WRB layer 3209 having an outer surface and an inner surface, wherein the inner surface of the WRB layer 3209 is secured to the outer surface of the first structurally-stable panel 3207;
wherein the WRB layer 3209 is further wrapped around to cover the insulation layer 3205, at least partially, from at least one of its edges to create an extension flap 3243, which is sealed onto the insulation layer 3205; and
wherein the extension flap of the WRB layer 3109 is sealed onto the insulation layer as its removably-attached release-liner has been removed, which then exposes and seals with the adhesive that allows for sealing of the flaps 3243.

In one embodiment, the insulation layer has no adhesive that planarly and contactably assists in adhesion to the structurally-stable panel, but instead, the insulation layer such as a foam and the structurally-stable panel such as an OSB board are attached at their edges by a tape means, or other means such that there is a nominal or more than nominal air-gap (3229 in FIG. 32) in between the insulation layer and the structurally stable panel. Stated differently, the absence of an adhesive that assists in planarly and contactably attaching the insulation layer and the structurally-stable panel can create air gaps by virtue of the roughness of the two surfaces, or the width of the air-gap can be specifically engineered, as desired. The tape or edge-attachment means allow for existence of such air-gap, which can provide additional insulation. In another variation of the embodiment, the edge-attachment means such as a tape is used at one edge, two edges, three edges, or four edges (and multiple edges depending on the shape of the IWS panel). In another variation of the embodiment, the taping of the edges is performed in conjunction with a planarly and contactably attaching an adhesive between the SS panel and the insulation layer. In a further variation to the above embodiments, the structurally-stable panel is planarly and contactably attached to a fastener-gasketing adhesive layer (see FIG. 32, 3213), and the fastener-gasketing adhesive layer is planarly and contactably attached to the WRB layer through the second adhesive that is included on the inside of the WRB layer. In one embodiment, the fastener-gasketing adhesive is an optional component of the above-recited embodiment.

In an additional variation the above embodiments, the IWS panel described above comprises an insulation facer planarly and contactably attached to the outside surface of the insulation layer, as described infra.

This invention also relates to all those embodiments described above, wherein the release-liner has been removed, and the WRB layer extension flap is attached to the desired surface to seal the panels.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising: providing a plurality of IS panels, wherein at least one panel is as recited in the above embodiments; securing each of the plurality of the IS panels to a structural element of the wall; removing the release-liner from the back of the extension flap; and sealing the seams between the individual IS panels of the plurality of panels.

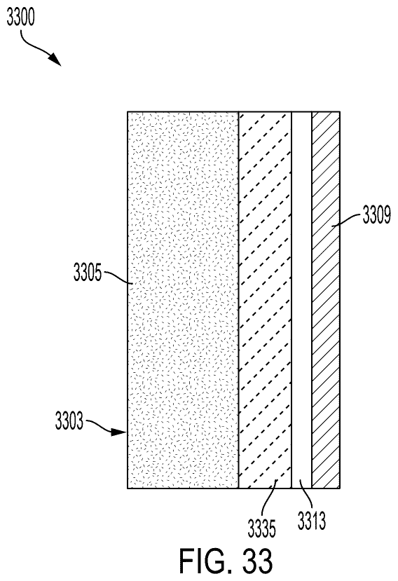

Embodiments of FIG. 33 are described infra in a different section.

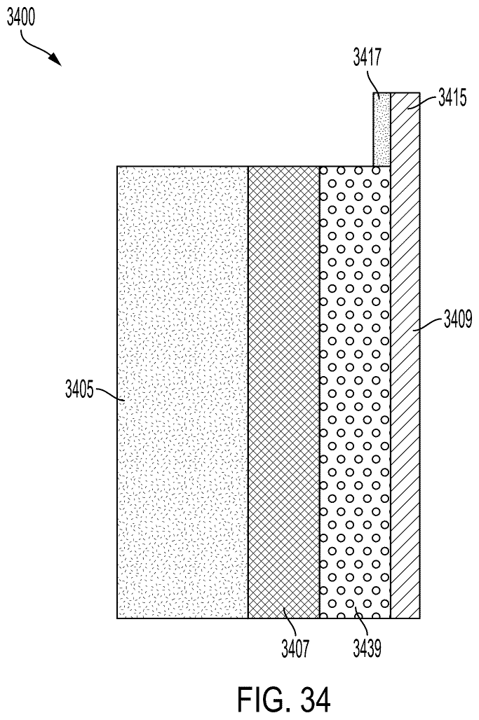

### FIG. 34

In another embodiment, as shown in FIG. 34, this invention relates to the first insulation sheathing (IS) panel such as a first insulation wall sheathing (IWS) panel or a panel assembly as recited above comprising more than one said panel, wherein at least one panel, is a first IWS panel 3400 used for construction purposes, comprising the following layers:
a first insulation layer 3405 having an outer surface and an inner surface;
a first structurally-stable panel 3407 having an outer surface and an inner surface, and at least one edge extending between its outer surface and the inner surface; wherein the inner surface of the first insulation layer 3405 is planarly and contactably attached to the outer surface of the first structurally-stable panel 3407; and
a second structurally-stable panel 3439 having an outer surface and an inner surface, and at least one edge extending between its outer surface and the inner surface; wherein the inner surface of the first structurally-stable panel 3407 is at least partly or fully planarly and contactably attached to the outer surface of the second structurally-stable panel 3439; and
wherein said first structurally-stable panel 3407 is preferably made from wood, and the second structurally stable panel 3439 is made from MgX;
a first WRB layer 3409 having an outer surface and an inner surface, wherein the inner surface of the WRB layer 3409 is secured to the outer surface of the second structurally-stable panel 3439;
wherein, optionally, the WRB layer exceeds the dimension of the structurally-stable panel 3439 from at least one of its edges to create an extension flap 3415; and
wherein the extension flap 3415 of the WRB layer 3409 further comprises a removably attached release-liner 3417 attached to the WRB layer 3409's inner surface.

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising: providing a plurality of IS panels, wherein at least one panel is as recited in the above embodiments; securing each of the plurality of the IS panels to a structural element of the wall; removing the release-liner from the back of the extension flap; and sealing the seams between the individual IS panels of the plurality of panels.

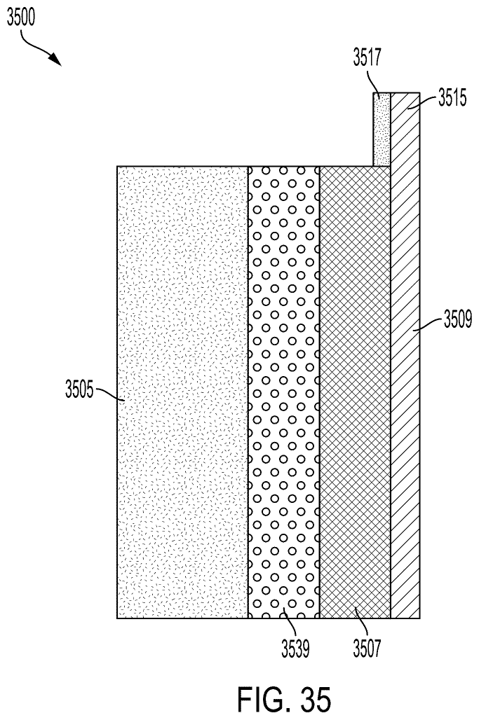

### FIG. 35

In yet another embodiment, as shown in FIG. 35, this invention relates to a panel, or a panel assembly comprising more than one said panel, wherein at least one panel, is a first IWS panel 3500 used for construction purposes, comprising the following layers:
a first insulation layer 3505 having an outer surface and an inner surface;
a first structurally-stable panel 3539 having an outer surface and an inner surface, and at least one edge extending between its outer surface and the inner surface; wherein the inner surface of the first insulation layer 3505 is planarly and contactably attached to the outer surface of the first structurally-stable panel 3539; and
a second structurally-stable panel 3507 having an outer surface and an inner surface, and at least one edge extending between its outer surface and the inner surface; wherein the inner surface of the first structurally-stable panel 3539 is at least partly planarly and contactably attached to the outer surface of the second structurally-stable panel 3507; and
wherein said second structurally-stable panel 3507 is preferably made from wood, and the first structurally-stable panel 3539 is made from MgX;
a first WRB layer 3509 having an outer surface and an inner surface, wherein the inner surface of the WRB layer 3509 is secured to the outer surface of the second structurally-stable panel 3507;
wherein, optionally, the WRB layer 3509 exceeds the dimension of the structurally-stable panel from at least one of its edges to create an extension flap 3515; and
wherein the extension flap 3515 of the WRB layer further comprises a removably-attached release-liner 3517 attached to the WRB layer's inner surface.

In another variation of the above embodiment, the first SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising: providing a plurality of IS panels, wherein at least one panel is as recited in the above embodiments; securing each of the plurality of the IS panels to a structural element of the wall; removing the release-liner from the back of the extension flap; and sealing the seams between the individual IS panels of the plurality of panels.

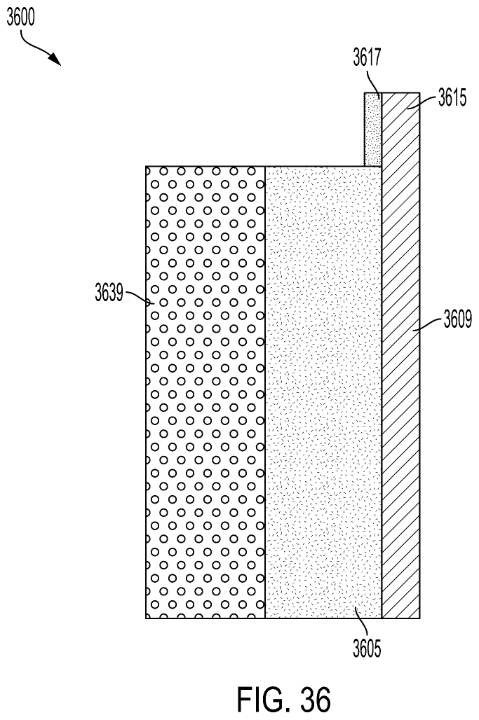

### FIG. 36

In yet another embodiment, as shown in FIG. 36, this invention relates to a first insulation sheathing (IS) panel such as a first insulation wall sheathing (IWS) panel, or a panel assembly comprising more than one said panel, wherein at least one panel, is a first IWS panel 3600 used for construction purposes, comprising the following layers:
a first structurally-stable panel 3639 having an outer surface and an inner surface, and at least one edge extending between its outer surface and the inner surface;
a first insulation layer 3605 having an outer surface and an inner surface;
wherein the inner surface of the first structurally-stable 3639 is planarly and contactably attached to the outer surface of the first insulation layer panel 3605;
wherein said first structurally-stable panel 3639 is made from wood or MgX;
a first WRB layer 3609 having an outer surface and an inner surface, wherein the inner surface of the WRB layer is secured to the outer surface of the first insulation layer panel 3605;
wherein, optionally, the WRB layer 3609 exceeds the dimension of the structurally-stable panel or the insulation layer from at least one of its edges to create an extension flap 3615; and
wherein the extension flap 3615 of the WRB layer 3609 further comprises a removably attached release-liner 3617 attached to the WRB layer 3609's inner surface.

In one embodiment, the structurally-stable panel of the above embodiment is made from structural materials as defined herein. Specifically, the structurally-stable panel comprises material selected from material comprising magnesium oxide, magnesium oxychloride, magnesium sulfate, magnesium oxysulphate, magnesium oxyphosphate, or combinations thereof. In another variation of this embodiment, the structurally-stable panel is made from wood, lignocellulosic material, OSB, plywood, waferboard, particleboard, chipboard, medium-density fiberboard, and boards that are a composite of strands and ply veneers.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising: providing a plurality of IS panels, wherein at least one panel is as recited in the above embodiments; securing each of the plurality of the IS panels to a structural element of the wall; removing the release-liner from the back of the extension flap; and sealing the seams between the individual IS panels of the plurality of panels.

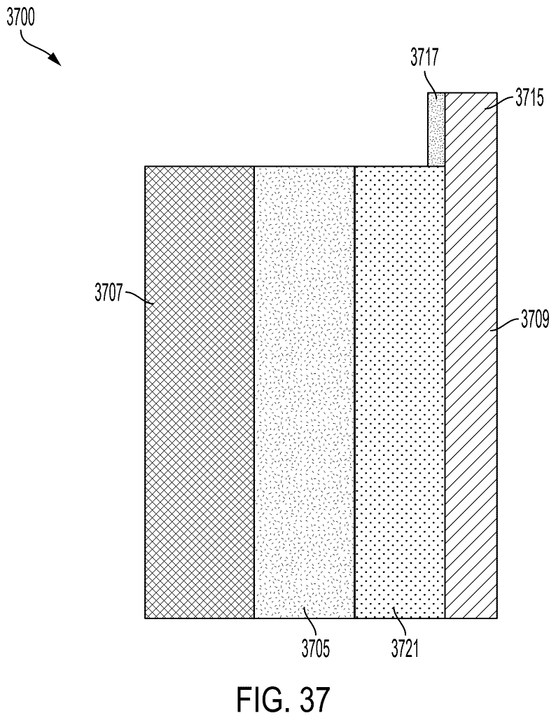

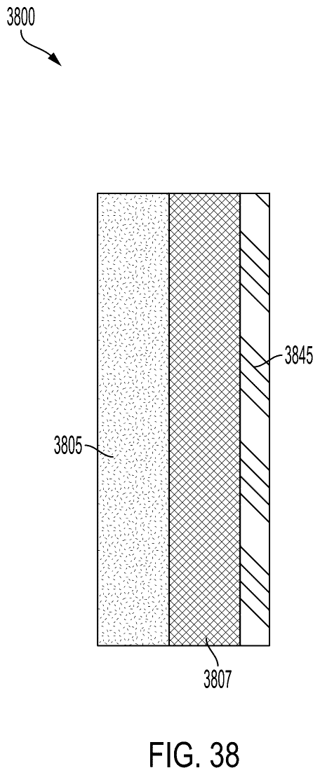

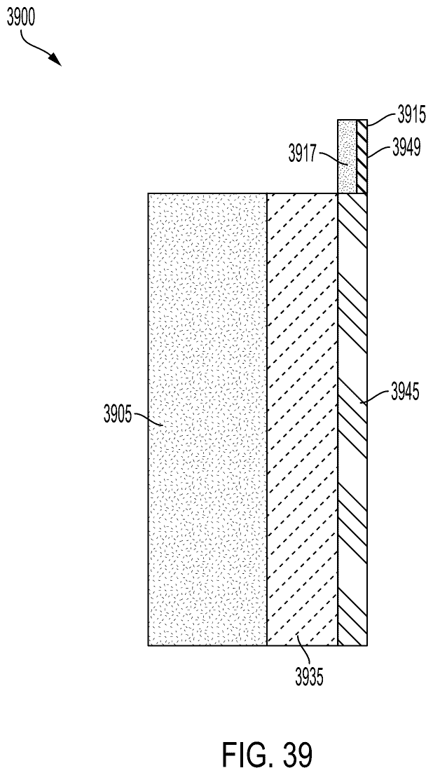

### FIG. 37

In yet another embodiment, this invention relates to a first insulation sheathing (IS) panel such as a first insulation wall sheathing (IWS) panel, or a panel assembly comprising more than one said panel, wherein at least one panel, is a first IWS panel 3700 used for construction purposes, comprising the following layers:
a first structurally-stable panel 3707 having an outer surface and an inner surface, and at least one edge extending between its outer surface and the inner surface;
a first insulation layer 3705 having an outer surface and an inner surface; wherein the inner surface of the first structurally-stable 3707 panel is planarly and contactably attached to the outer surface of the first insulation layer; and
a second structurally-stable panel 3721 having an outer surface and an inner surface, and at least one edge extending between its outer surface and the inner surface; wherein the inner surface of the first insulation layer 3705 is at least partly planarly and contactably attached to the outer surface of the second structurally-stable panel 3721; and
wherein said first structurally-stable panel 3707 is made from wood or MgX, and the second structurally stable panel 3721 is made from wood or MgX;
a first WRB layer 3709 having an outer surface and an inner surface, wherein the inner surface of the WRB layer 3709 is secured to the outer surface of the second structurally-stable panel 3721;
wherein, optionally, the WRB layer 3709 exceeds the dimension of at least one of the structurally-stable panels from at least one of its edges to create an extension flap 3715; and
wherein the extension flap 3715 of the WRB layer further comprises a removably attached release-liner 3717 attached to the WRB layer 3709's inner surface.

In yet another embodiment, this invention relates to a panel or panel assembly as recited above, without extension flaps and the release-liner, wherein a water-proof intumescent coating fluid is applied that provides additional protection on the WRB. More specifically, the IWS panel 3800 comprises an insulation layer 3805, a structurally-stable panel 3807, a WRB layer 3809, and an intumescent coating layer 3845 on top of the WRB layer 3809.

In one embodiment, the structurally-stable panel of the above embodiment is made from structural materials as defined herein. Specifically, the structurally-stable panel comprises material selected from material comprising magnesium oxide, magnesium oxychloride, magnesium sulfate, magnesium oxysulphate, magnesium oxyphosphate, or combinations thereof. In another variation of this embodiment, the structurally-stable panel is made from wood, lignocellulosic material, OSB, plywood, waferboard, particleboard, chipboard, medium-density fiberboard, and boards that are a composite of strands and ply veneers.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In yet another embodiment, this invention relates to a panel or panel assembly as recited above, wherein the intumescent coating gives at least one of thermal barrier, fire resistance, and ignition barrier properties.

In one embodiment, this invention relates to a panel, or a panel assembly comprises a GPS insulation layer, an MgO (chlorine) structurally stable panel, and a WRB layer with extension flaps and a release-liner. Optionally, the FPS layer is adhered to the MgO layer with an adhesive. Optionally, the MgO layer is adhered to the WRB layer using a regular adhesive and/or a nail gasketing adhesive. Optionally, the WRB layer has at least one extension flap with a release-liner in the back, as described elsewhere. In one embodiment of this invention, the panel or a panel assembly comprises a GPS insulation layer, an MgO (chlorine) structurally stable panel, and a WRB layer with extension flaps and a release-liner. Optionally, the GPS layer is adhered to the MgO layer with an adhesive. Optionally, the MgO layer is adhered to the WRB layer using a regular adhesive and/or a nail gasketing adhesive. Optionally, the WRB layer has at least one extension flap with a release-liner in the back, as described elsewhere.

In one embodiment, this invention relates to a method for preparing a panel assembly, the method comprising: providing a plurality of IS panels, wherein at least one panel is as recited in the above embodiments; securing each of the plurality of the IS panels to a structural element of the wall; removing the release-liner from the back of the extension flap; and sealing the seams between the individual IS panels of the plurality of panels.

In one embodiment, this invention relates to a method for preparing a panel assembly, the method comprising: providing a plurality of IS panels, wherein all panels are as recited in the above embodiments; securing each of the plurality of the IS panels to a structural element of the wall; removing the release-liner from the back of the extension flap; and sealing the seams between the individual IS panels of the plurality of panels.

IWS Panels without Extension Flaps

The following embodiments of the invention do not have any extension flaps in their insulation sheathing (IS) panel such as an fist insulation wall sheathing (IWS) panel.

As shown in FIG. 20, in one embodiment, the present invention relates to a first insulation sheathing (IS) panel such as a first insulation wall sheathing (IWS) panel 2000 used for construction purposes, comprising the following layers:
a first insulation layer 2005 having an outer surface and an inner surface;
a first structurally-stable panel 2007 having an outer surface and an inner surface, and at least one edge extending between its outer surface and the inner surface; wherein the inner surface of the first insulation layer 2005 is planarly and contactably attached to the outer surface of the first structurally-stable panel 2007;
a second structurally-stable panel 2021 having an outer surface and an inner surface, and at least one edge extending between its outer surface and the inner surface; wherein the inner surface of the first structurally-stable panel 2007 is planarly and contactably attached to the outer surface of the second structurally-stable panel 2021; and
a first WRB layer 2009 having an outer surface and an inner surface, wherein the inner surface of the WRB layer 2009 is secured to the outer surface of the second structurally-stable panel 2021.

In a variation to the above embodiment, the insulation layer can be adhered or secured to first structurally-stable panel using an adhesive, as described later in this disclosure. In a further variation to the above two embodiments, the first structurally-stable panel 2007 and the second structurally-stable panel 2021 are planarly and contactably attached to each other by an adhesive. In a further variation to the above embodiments, the second structurally-stable panel is planarly and contactably attached to a fastener-gasketing adhesive layer 2013, and the fastener-gasketing adhesive layer 2013 is planarly and contactably attached to the WRB layer 2009 through the second adhesive that is included on the inside of the WRB layer (not shown). In one embodiment, the fastener-gasketing adhesive is an optional component of the above-recited embodiment.

In an additional variation the above embodiments, the IWS panel described above comprises an insulation facer planarly and contactably attached to the outside surface of the insulation layer, as described infra.

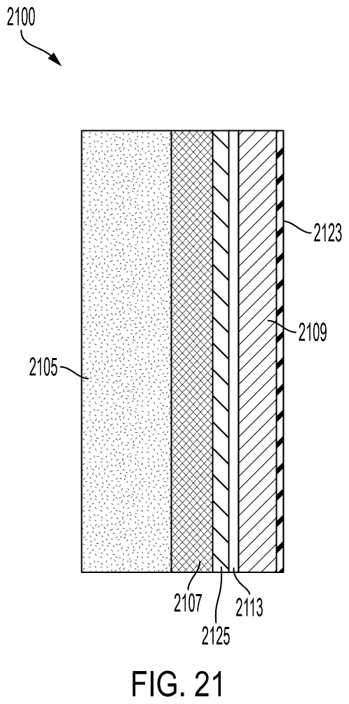

As shown in FIG. 21, in one embodiment, the present invention relates to a first insulation sheathing (IS) panel such as a first insulation wall sheathing (IWS) panel 2100 used for construction purposes, comprising the following layers:
a first insulation layer 2105 having an outer surface and an inner surface;
a first structurally-stable panel 2107 having an outer surface and an inner surface, and at least one edge extending between its outer surface and the inner surface; wherein the inner surface of the first insulation layer 2105 is planarly and contactably attached to the outer surface of the first structurally-stable panel 2107;
a first heat-sealant layer 2125 having an outer surface and an inner surface, and at least one edge extending between its outer surface and the inner surface; wherein the inner surface of the first structurally-stable panel 2107 is planarly and contactably attached to the outer surface of the first heat-sealant layer 2125; and
a first WRB layer 2109 having an outer surface and an inner surface, wherein the inner surface of the WRB layer 2109 is secured to the outer surface of the heat-sealant layer 2125.

In a variation to the above embodiment, the insulation layer 2107 can be adhered or secured to first structurally-stable panel 2107 using an adhesive, as described later in this disclosure. In a further variation to the above two embodiments, the first structurally-stable panel 2107 and the heat-sealant layer 2125 are planarly and contactably attached to each other by the use of an adhesive or other fastening means. In a further variation to the above embodiments, the heat-sealant layer 2125 is planarly and contactably attached to a fastener-gasketing adhesive layer 2113, and the fastener-gasketing adhesive layer 2113 is planarly and contactably attached to the WRB layer 2109 through a second adhesive that is included on the WRB layer (not shown in FIG. 21). In one embodiment, the fastener-gasketing adhesive is an optional component of the above-recited embodiment. In other words, the heat-sealant layer is directly attached, planarly and contactably, to the WRB layer through the adhesive on the WRB layer.

In an additional variation the above embodiments, the first insulation sheathing (IS) panel such as the first insulation wall sheathing (IWS) panel comprises an insulation facer planarly and contactably attached to the outside surface of the insulation layer through an adhesive, as described infra.

In another embodiment, and as shown in FIG. 21, an optional print layer 2123 is also attached or deposited on the WRB layer 2109.

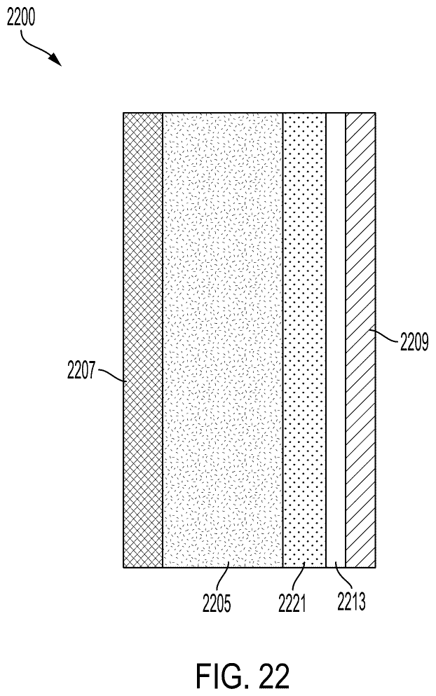

As shown in FIG. 22, in one embodiment, the present invention relates to a first IWS panel 2200 used for construction purposes, comprising the following layers:
a first structurally-stable panel 2207 having an outer surface and an inner surface, and at least one edge extending between its outer surface and the inner surface;
a first insulation layer 2205 having an outer surface and an inner surface; wherein the outer surface of the first insulation layer 2205 is planarly and contactably attached to the inner surface of the first structurally-stable panel 2207;
a second structurally-stable panel 2221 having an outer surface and an inner surface, and at least one edge extending between its outer surface and the inner surface; wherein the outer surface of the second structurally-stable panel 2221 is planarly and contactably attached to the inner surface of the first insulation panel 2205; and
a first WRB layer 2209 having an outer surface and an inner surface, wherein the inner surface of the WRB layer 2209 is secured to the outer surface of the second structurally-stable panel 2221.

In a variation to the above embodiment, the insulation layer 2205 can be adhered or secured to first structurally-stable panel 2207 using an adhesive, as described later in this disclosure. In a further variation to the above two embodiments, the insulation layer 2205 and the first structurally-stable panel 2207, and the insulation layer 2205 and the second structurally-stable panel 2221 are planarly and contactably attached to each other by use of an adhesive or other fastening means.

In a further variation to the above embodiments, the second-structurally stable panel 2221 is planarly and contactably attached to a fastener-gasketing adhesive layer 2213, and the fastener-gasketing adhesive layer 2213 is planarly and contactably attached to the WRB layer 2209 through a second adhesive that is included on the WRB layer 2209. In one embodiment, the fastener-gasketing adhesive layer 2213 is an optional component of the above-recited embodiment. In other words, the second structurally-stable panel 2221 is directly attached, planarly and contactably, to the WRB layer 2209 through the adhesive (not shown in FIG. 22) on the WRB layer 2209.

In an additional variation the above embodiments, the IWS panel comprises an insulation facer planarly and contactably attached to the outside surface of the insulation layer through an adhesive, as described infra.

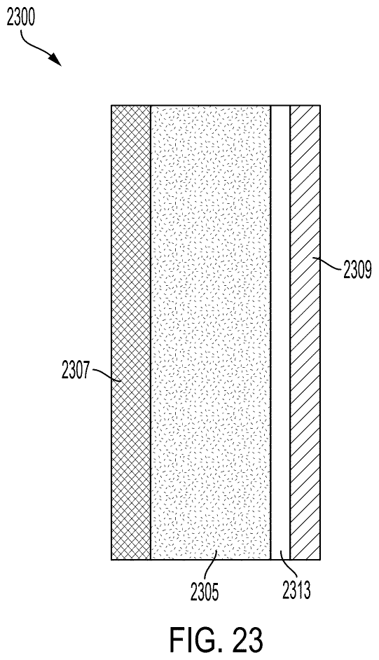

As shown in FIG. 23, in one embodiment, the present invention relates to a first insulation sheathing (IS) panel such as a first insulation wall sheathing (IWS) panel 2300 used for construction purposes, comprising the following layers:
a first structurally-stable panel 2307 having an outer surface and an inner surface, and at least one edge extending between its outer surface and the inner surface;
a first insulation layer 2305 having an outer surface and an inner surface; wherein the outer surface of the first insulation layer 2205 is planarly and contactably attached to the inner surface of the first structurally-stable panel 2307; and
a first WRB layer 2309 having an outer surface and an inner surface, wherein the inner surface of the WRB layer 2309 is secured to the outer surface of the first insulation panel 2305.

In a variation to the above embodiment, the insulation layer 2305 can be adhered or secured to first structurally-stable panel 2307 using an adhesive, as described later in this disclosure. In a further variation to the above two embodiments, the insulation layer 2305 and the first structurally-stable panel 2307, and the insulation layer 2305 and the WRB layer 2309 are planarly and contactably attached to each other by use of an adhesive or other fastening means.

In a further variation to the above embodiments, the insulation panel 2305 is planarly and contactably attached to a fastener-gasketing adhesive layer 2313, and the fastener-gasketing adhesive layer 2313 is planarly and contactably attached to the WRB layer 2309 through an optional second adhesive that is included on the WRB layer 2309. In one embodiment, the fastener-gasketing adhesive layer 2313 is an optional component of the above-recited embodiment. In other words, the insulation layer 2305 is directly attached, planarly and contactably, to the WRB layer 2309 through the adhesive (not shown in FIG. 23) on the WRB layer 2309.

In an additional variation the above embodiments, the IWS panel comprises an insulation facer planarly and contactably attached to the outside surface of the insulation layer through an adhesive, as described infra.

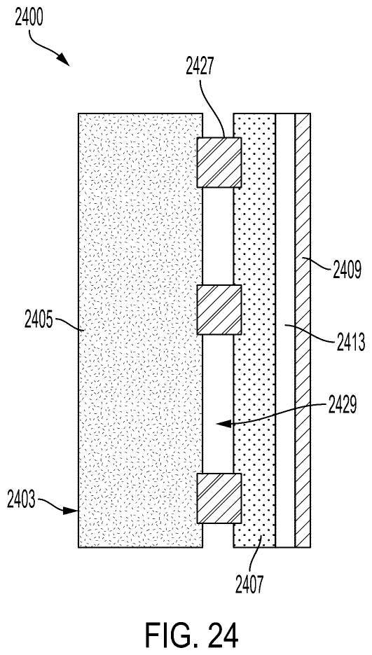

As shown in FIG. 24, in one embodiment, the present invention relates to a first insulation sheathing (IS) panel such as a first insulation wall sheathing (IWS) panel 2400 used for construction purposes, comprising the following layers:
a first insulation layer 2405 having an outer surface and an inner surface;
a first structurally-stable panel 2407 having an outer surface and an inner surface, and at least one edge extending between its outer surface and the inner surface;
a set of strips 2427 partially embedded in the first insulation layer 2405, wherein the set of strips 2427 contact the first structurally-stable layer 2407 at their non-embedded end; wherein said strips 2427 create air-pockets 2429 in conjunction with said first insulation layer 2405 and said first structurally-stable panel 2407; and
a first WRB layer 2409 having an outer surface and an inner surface, wherein the inner surface of the WRB layer 2409 is secured to the outer surface of the first structurally-stable panel 2407.

In a variation to the above embodiment, contact strips 2427 are variably embedded, depthwise, in the insulation layer 2405 to create either an even air-gap or an uneven air-gap between the insulation layer 2405 and the first-structurally stable panel 2407. In one embodiment, the strips 2427 are almost fully or partially embedded in the insulation layer 2405 and are planarly and contactably attached on their other end to the first-structurally stable panel 2407 by use of an adhesive or other fastening means. In another variation of the embodiments herein, the air-pocket strips 2427 form a geometric pattern or an irregular pattern. In another variation to this embodiment, the pattern, geometric or otherwise, is prepared such that it facilitates removal of water or moisture through drainage.

In a further variation to the above embodiments, the first structurally-stable panel is planarly and contactably attached to a fastener-gasketing adhesive layer 2413, and the fastener-gasketing adhesive layer 2413 is planarly and contactably attached to the WRB layer 2409 through a second adhesive (not shown in FIG. 24) that is included on the WRB layer 2409. In one embodiment, the fastener-gasketing adhesive layer (2413) is an optional component of the above-recited embodiment. In other words, the first structurally-stable panel 2407 is directly attached, planarly and contactably, to the WRB layer 2409 through the adhesive on the WRB layer 2409.

In a further variation to the above embodiments, a second structurally-stable panel is planarly and contactably attached to the other side on the insulation layer.

In an additional variation the above embodiments, the IWS panel 2400 comprises an insulation facer 2403 planarly and contactably attached to the outside surface of the insulation layer through an adhesive, as described infra.

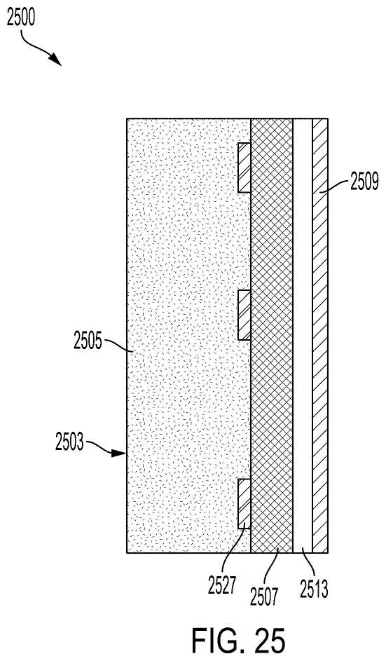

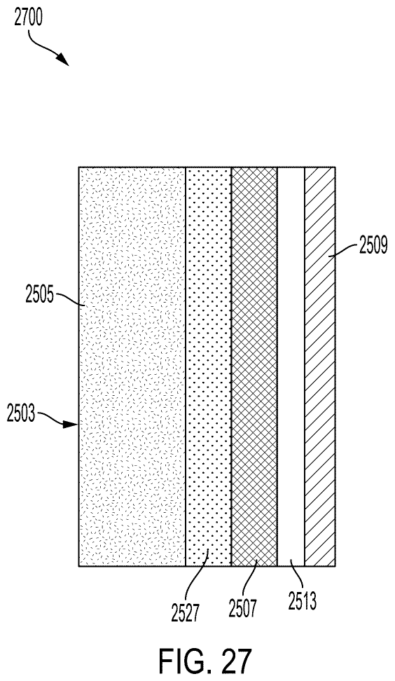

As shown in FIGS. 25 and 27 in one embodiment, the present invention relates to a first insulation sheathing (IS) panel such as a first insulation wall sheathing (IWS) panel 2500 used for construction purposes, comprising the following layers:
a first insulation layer 2505 having an outer surface and an inner surface;
a set of strips 2527 embedded in the first insulation layer 2505 with their non-embedded ends exposed but nominally flush with the inner surface of the insulation layer 2505;
a first structurally-stable panel 2507 having an outer surface and an inner surface, and at least one edge extending between its outer surface and the inner surface; wherein the inner surface of the first insulation layer 2505 is planarly and contactably attached to the outer surface of the first structurally-stable panel 2507, and wherein the non-embedded or exposed ends of the strips 2527 are in contact with the outer surface of the first structurally-stable panel 2507; and
a first WRB layer 2509 having an outer surface and an inner surface, wherein the inner surface of the WRB layer 2509 is secured to the outer surface of the first structurally-stable panel 2507.

In a variation to the above embodiment, contact strips 2527 are uniformly embedded or variably embedded, depthwise, in the insulation layer 2505 to create an even air-gap, an uneven air-gap, or virtually no air-gap between the insulation layer 2505 and the first-structurally stable panel 2507. In one embodiment, the strips 2527 are almost fully or partially embedded in the insulation layer 2505 and are planarly and contactably attached on their other end to the first-structurally stable panel 2507 by use of an adhesive or other fastening means. In another variation of the embodiments herein, the strips 2527 form a geometric pattern or an irregular pattern. In another variation to this embodiment, the pattern, geometric or otherwise, is prepared such that it facilitates removal of water or moisture through drainage.

In a further variation to the above embodiments, the first structurally-stable panel 2507 is planarly and contactably attached to a fastener-gasketing adhesive layer 2513, and the fastener-gasketing adhesive layer 2513 is planarly and contactably attached to the WRB layer 2509 through a second adhesive (not shown in FIG. 25) that is included on the WRB layer 2509. In one embodiment, the fastener-gasketing adhesive layer 2513 is an optional component of the above-recited embodiment. In other words, the first structurally-stable panel 2507 is directly attached, planarly and contactably, to the WRB layer 2509 through the adhesive on the WRB layer 2509.

In a further variation to the above embodiments, a second structurally-stable panel is planarly and contactably attached to the other side on the insulation layer.

In a further variation to the above embodiments of the invention, one or both structurally-stable panels comprise wood-composite, grass, rice hulls, MgO, compalite, and other plant-based materials.

In an additional variation the above embodiments, the IWS panel 2500 comprises an insulation facer 2503 planarly and contactably attached to the outside surface of the insulation layer 2505 through an adhesive, as described infra.

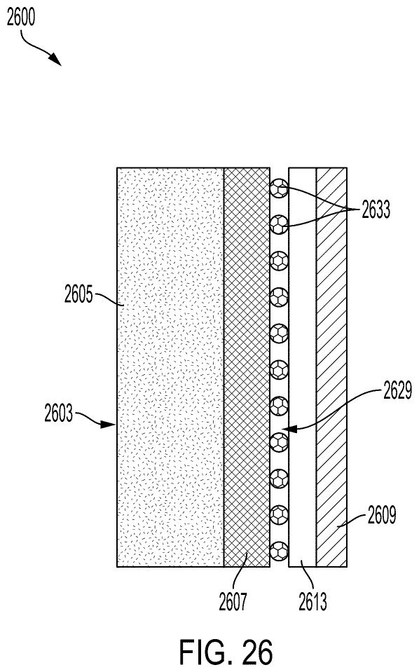

As shown in FIG. 26, in one embodiment, the present invention relates to a first insulation sheathing (IS) panel such as a first insulation wall sheathing (IWS) panel 2600 used for construction purposes, comprising the following layers:
a first insulation layer 2605 having an outer surface and an inner surface;
a first structurally-stable panel 2607 having an outer surface and an inner surface, and at least one edge extending between its outer surface and the inner surface;
a plurality of insulation beads 2633 in contact with the first structurally-stable layer 2607;
a first WRB layer 2609 having an outer surface and an inner surface, wherein the inner surface of the WRB layer 2609 is secured to the plurality of insulation beads 2633; wherein said insulation beads 2633 create air-pockets 2629 in conjunction with said first structurally-stable panel 2607 and said WRB layer 2609.

In a variation to the above embodiment, the insulation beads 2633 are of unform or variable size in their planar or perpendicular dimensions to the first structurally-stable panel 2607 to create either an even air-gap or an uneven air-gap between the WRB layer 2609 and the first-structurally stable panel 2607. In another variation of the embodiments herein, the beads 2633 form a geometric pattern or an irregular pattern in the plane in which they are located. In another variation to this embodiment, the pattern, geometric or otherwise, is prepared such that it facilitates removal of water or moisture through drainage.

In a further variation to the above embodiments, the first structurally-stable panel 2607 is planarly and contactably attached to a fastener-gasketing adhesive layer 2613, and the fastener-gasketing adhesive layer 2613 is planarly and contactably attached to the WRB layer 2609 through a second adhesive (not shown in FIG. 26) that is included on the WRB layer 2609. In one embodiment, the fastener-gasketing adhesive layer 2613 is an optional component of the above-recited embodiment. In other words, the first structurally-stable panel 2607 is directly attached, planarly and contactably, to the WRB layer 2609 through the adhesive on the WRB layer 2609.

In a further variation to the above embodiments, a second structurally-stable panel is planarly and contactably attached to the other side on the insulation layer.

In an additional variation the above embodiments, the IWS panel 2600 comprises an insulation facer 2603 planarly and contactably attached to the outside surface of the insulation layer 2605 through an adhesive, as described infra.

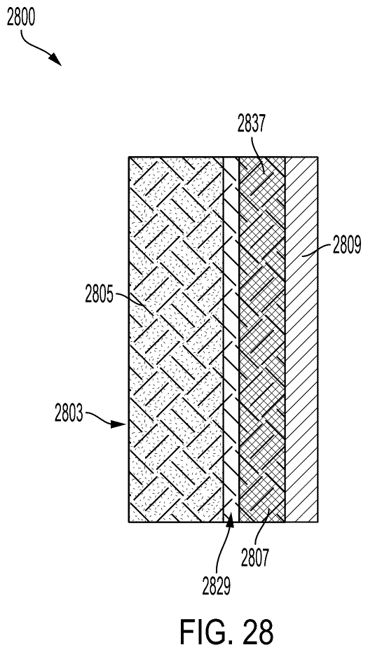

As shown in FIG. 28, in one embodiment, the present invention relates to a first IWS panel 2800 used for construction purposes, comprising the following layers:
a first insulation layer 2805 having an outer surface and an inner surface;
a first structurally-stable panel 2807 having an outer surface and an inner surface, and at least one edge extending between its outer surface and the inner surface; wherein the inner surface of the first insulation layer 2805 is planarly and contactably adjacent to the outer surface of the first structurally-stable panel 2807, and the insulation layer 2805 is optionally attached with an adhesive tape 2837, planarly and contactably, to the structurally-stable panel 2807;
wherein the insulation layer 2805 and the structurally-stable panel 2807 are attached to each other through an adhesive tape 2837 on at least one edge, and preferably on all four edges, wherein the tape covers of the combined insulation layer 2805 and the structurally-stable panel 2807 fully or partially; and
a first WRB layer 2809 having an outer surface and an inner surface, wherein the inner surface of the WRB layer 2809 is secured to the outer surface of the first structurally-stable panel 2807.

In one embodiment, the insulation layer has no adhesive that planarly and contactably assists in adhesion to the structurally-stable panel, but instead, the insulation layer such as a foam and the structurally-stable panel such as an OSB board are attached at their edges by a tape means, or other means such that there is a nominal or more than nominal airgap in between the insulation layer and the structurally stable panel. Stated differently, the absence of an adhesive that assists in planarly and contactably attaching the insulation layer and the structurally-stable panel can create air gaps by virtue of the roughness of the two surfaces or the width of the air-gap can be specifically engineered, as desired. The tape or edge-attachment means allow for the existence of such an air-gap, which can provide additional insulation. In another variation of the embodiment, the edge-attachment means such as a tape is used at one edge, two edges, three edges, or four edges (and multiple edges depending on the shape of the IWS panel). In another variation of the embodiment, the taping of the edges is performed in conjunction with a planarly and contactably attaching of an adhesive between the SS panel and the insulation layer. In a further variation to the above embodiments, the structurally-stable panel is planarly and contactably attached to a fastener-gasketing adhesive layer, and the fastener-gasketing adhesive layer is planarly and contactably attached to the WRB layer through the second adhesive that is included on the inside of the WRB layer. In one embodiment, the fastener-gasketing adhesive is an optional component of the above-recited embodiment.

In an additional variation the above embodiments, the IWS panel described above comprises an insulation facer planarly and contactably attached to the outside surface of the insulation layer, as described infra.

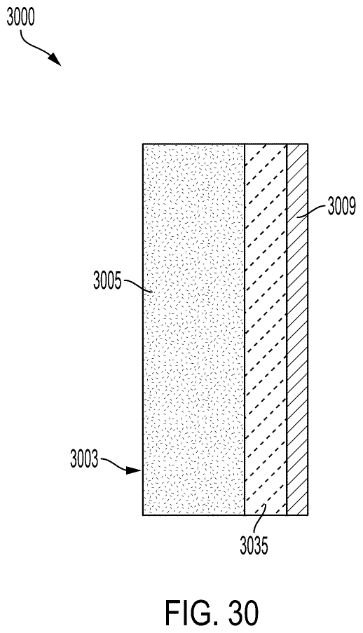

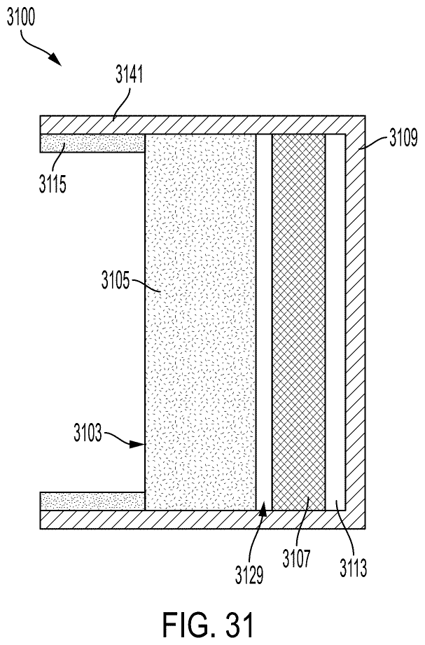

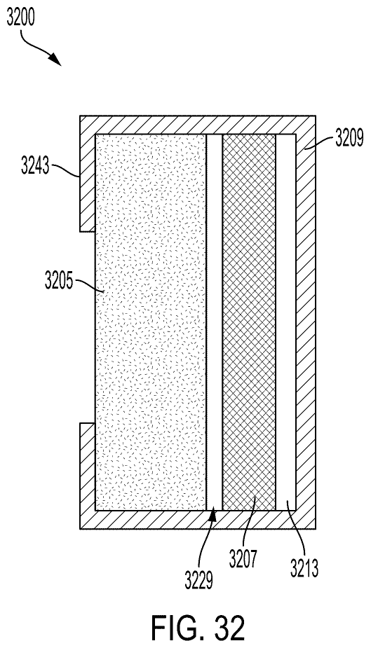

As shown in FIG. 30, in a further, the present invention relates to a first IWS panel 3000 used for construction purposes, comprising the following layers:
a first insulation layer 3005 having an outer surface and an inner surface; and
a first structurally-stable panel 3035 having an outer surface and an inner surface, and at least one edge extending between its outer surface and the inner surface;
a first WRB layer 3035 having an outer surface and an inner surface; and
wherein the structurally-stable panel 3035 is a non-OSB board, comprising, for example, wood-composite, grass, rice hulls, MgO, compalite, and other plant-based materials. For example, in one embodiment, the structurally-stable panel is a composite board such as the EcoStorm® coverboard obtained from Carlisle Corporation of Mechanicsburg, Pennsylvania. The EcoStorm® coverboard is an engineered composite building material made from a blend of plastic and cellulose fiber. In one embodiment of the invention, the composite board is sourced from post-industrial and post-consumer waste streams. In another embodiment, such composite board is a durable, moisture and mold resistant building material.

In a further variation to the above embodiments, the first structurally-stable panel is planarly and contactably attached to a fastener-gasketing adhesive layer 3013, and the fastener-gasketing adhesive layer 3013 is planarly and contactably attached to the WRB layer 3009 through a second adhesive (not shown in FIG. 30) that is included on the WRB layer 3009. In one embodiment, the fastener-gasketing adhesive layer 3013 is an optional component of the above-recited embodiment. In other words, the first structurally-stable panel 3035 is directly attached, planarly and contactably, to the WRB layer through the adhesive on the WRB layer.

In a further variation to the above embodiments, a second structurally-stable panel is planarly and contactably attached to the other side on the insulation layer, wherein the second structurally-stable panel is the same as the first structurally-stable panel as described above, or as described infra.

In an additional variation the above embodiments, the insulation sheathing (IS) panel such as the insulation wall sheathing (IWS) panel 3000 further comprises an insulation facer 1503 planarly and contactably attached to the outside surface of the insulation layer 3005 through an adhesive, as described infra.

As shown in FIG. 33, in one embodiment, the present invention relates to a first insulation sheathing (IS) panel such as a first insulation wall sheathing (IWS) panel 3300 used for construction purposes, comprising the following layers:
a first insulation layer 3305 having an outer surface and an inner surface;
a first structurally-stable panel 3335 having an outer surface and an inner surface, and at least one edge extending between its outer surface and the inner surface;
a first WRB layer 3309 having an outer surface and an inner surface; and
wherein the structurally-stable panel 3335 is a non-OSB board, comprising, for example, wood-composite, grass, rice hulls, MgO, compalite, and other plant-based materials. For example, in one embodiment, the structurally-stable panel is a composite board such as the EcoStorm® coverboard obtained from Carlisle Corporation of Mechanicsburg, Pennsylvania. The EcoStorm® coverboard is an engineered composite building material made from a blend of plastic and cellulose fiber. In one embodiment of the invention, the composite board is sourced from post-industrial and post-consumer waste streams. In another embodiment, such composite board is a durable, moisture and mold resistant building material.

In a further variation to the above embodiments, the first structurally-stable panel is planarly and contactably attached to a fastener-gasketing adhesive layer 3313, and the fastener-gasketing adhesive layer 3313 is planarly and contactably attached to the WRB layer 3309 through a second adhesive (not shown in FIG. 33) that is included on the WRB layer 3309. In one embodiment, the fastener-gasketing adhesive layer 3313 is an optional component of the above-recited embodiment. In other words, the first structurally-stable panel 3335 is directly attached, planarly and contactably, to the WRB layer through the adhesive on the WRB layer.

In a further variation to the above embodiments, a second structurally-stable panel is planarly and contactably attached to the other side on the insulation layer, wherein the second structurally-stable panel is the same as the first structurally-stable panel as described above, or as described infra.

In an additional variation the above embodiments, the first insulation sheathing (IS) panel such as the first insulation wall sheathing (IWS) panel 3300 further comprises an insulation facer 3303 planarly and contactably attached to the outside surface of the insulation layer 3305 through an adhesive, as described infra.

In yet another embodiment, this invention relates to a first insulation sheathing (IS) panel such as a first insulation wall sheathing (IWS) panel 3900 or panel assembly as recited above, without extension flaps and the release-liner, wherein in place of a WRB, a water proof intumescent coating fluid 3945 is applied that provides additional protection, and wherein said panel 3900 comprises a split liner tape 3949 at least on one side, wherein said split liner tape 3949 exceeds the dimension of the structurally-stable panel 3935 from at least one of its edges to create an extension flap 3915; and
wherein the extension flap 3915 of the split liner tape further comprises a removably attached release-liner 3917 attached to the layer immediately below it in a planarly and contactably attached construction.

In the embodiments described in the above section for insulation panels without extension flaps, the following variations of the embodiment are also part of the invention, as and where appropriate:

In one embodiment, the structurally-stable panel of the above embodiment is made from structural materials as defined herein. Specifically, the structurally-stable panel comprises material selected from MgX, gypsum, wood, cementitious material, composite material, wood composite material, plant-based material, reinforced materials, blends thereof, and mixtures of stated materials. In one variation of the above embodiment, the SS panel is made from material comprising magnesium oxide, magnesium oxychloride, magnesium sulfate, magnesium oxysulphate, magnesium oxyphosphate, or combinations thereof. In another variation of this embodiment, the structurally-stable panel is made from, for example, plant-based material such as grass and rice hulls In another variation of the above embodiment, the SS panel is made from lignocellulosic material, OSB, plywood, waferboard, particleboard, chipboard, medium-density fiberboard, and boards that are a composite of strands and ply veneers. In another variation of the above embodiment, the SS panel is made from engineered fiberboard laminate, and materials known as EcoStorm® and CompoLite® and materials with glass-fiber reinforcement.

In one embodiment, the insulation layer of the above embodiment comprises foams made from at least one of at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

In another variation of the above embodiment, the WRB layer is a house-wrap such as Blueskin® and Tyvek®.

In one embodiment, the insulation panel has a facer layer planarly and contactably attached to its first surface.

In one embodiment, this invention relates to a method for preparing a panel assembly, the method comprising: providing a plurality of IS panels, wherein at least one panel is as recited in the above embodiments; securing each of the plurality of the IS panels to a structural element of the wall; and sealing the seams between the individual IS panels of the plurality of panels using sealing means such as tapes, sealing compounds, and other know methods in the art.

In another embodiment, all panels are from the above set of embodiments.

In one embodiment, this invention relates to a method for preparing a panel assembly, the method comprising: providing a plurality of IS panels, wherein at least one panel is as recited in the above embodiments; securing each of the plurality of the IS panels to a structural element of the wall; and sealing the seams between the individual IS panels of the plurality of panels using sealing means such as tapes, sealing compounds, and other know methods in the art.

### I. Insulation Facer Layer

A problem encountered when using thin insulation sheathing is physical damage from bending, impact, or breaking. Such damage may occur by acts of vandalism, high velocity winds, rain, hail, construction practices, and the like. For example, in construction, it is common for ladders placed against vertical walls to bend, damage, or even break the insulation sheathing. It is also common for construction personnel to kneel upon insulation boards during construction.

Also, foam insulation boards are subjected to oxygen- and water-vapor-transmission and structural damage, both of which, over time, contribute to deteriorating the insulation properties and reducing the structural integrity of the board. A technique to address the problems of physical damage and loss of insulation properties is to apply or adhere a facing material (called a “facer”) to at least one side of the board. Examples of such facing materials include plastic film, thin metal foil, paper or thin cellulose, nonwoven polymeric fabrics, fiberglass scrims, and combinations of the foregoing.

Important properties of facers include serving as moisture vapor and oxygen transmission barriers, providing strength and structural integrity, ease of application, and the like. Thin metal foils, such as aluminum, are commonly utilized in facers to provide moisture-vapor- and oxygen-transmission-barrier properties.

Many laminates and/or facers for use in covering foam insulation boards and other products are described in the prior art. Such laminates are described in U.S. Pat. Nos. 6,872,673; 6,355,701; 6,093,481; 6,044,604; 5,695,870; 5,565,252; 5,345,738; 5,044,705; 4,985,106; 4,764,420; 4,572,865; 4,509,307; 4,284,674; 4,254,173; and 3,903,346. It is desirable to provide a laminate and/or facer for uses that require improved oxygen- and moisture-vapor barrier properties, structural integrity, strength, and weatherability.

It should be noted that all references cited above, and otherwise, in this specification are incorporated in this specification as if they were fully set forth herein.

Patterns are embossed as described later in this specification on the insulation facers. In one embodiment, one or more of the following patterns are embossed.

### Geometric Pattern

By geometric pattern is mean vertical lines, horizontal lines, transverse lines, crisscross lines, lattice, circles, triangles, squares, rectangles, trapezoid, rhombus, pentagons, and other such geometric designs. More than one type of geometric structure may be present on the surface of the insulation facer in an embossed or recessed fashion.

### Regular Pattern

By a regular pattern is meant that the same pattern is repeated in partial or full surface of the insulation facer. In other words, a geometric pattern would be repeated, or an irregular pattern would be repeated.

### Irregular Pattern

By irregular pattern is meant the insulation facer has a random design that is not regular.

### Embossing

By embossing herein is meant a relative difference in depth between the embossed pattern and the recessed pattern on the surface of the insulation facer. For example, if a pattern is embossed on the insulation facer surface, it covers the aspect where the same design is embossed or recessed. In one aspect, the textured surface is characterized by an embossed pattern of features or indentations. As used herein, “embossing” can mean embossing, debossing, scoring, or any other means to alter the texture of the facer.

Generally, separate steps are needed to create a system that is insulative, vapor semi-permeable, a weather resistive barrier, and acts as a drainage plane. The steps may include exterior insulation and a weather-resistive barrier that may or may not meet drainage needs through an outward facing attachment to the film and placing an additional medium to the wall system to promote drainage.

### II. Insulation Layer

### Insulation Foam

Thermal insulation sheathing offers thermal barrier properties desirable for enclosures having regulated temperatures, including houses, offices, refrigerated containers, and the like. Extruded polymer foam articles such as polystyrene foam boards are thermal insulation materials for use in such enclosures including building and construction applications as well as thermal insulation containers. See for example, WO2018098570A1.

The thermal insulation sheathing that can be cut up into boards that are commonly used to enhance insulation of building structures. Relatively thin (about % inch to about 3.0 inches), rectangular panels of foam board are commonly placed between the dry wall and building exteriors such as stone, brick, wood, stucco, and the like. Insulation boards employed in such applications may include, but are not limited to, those utilizing polyisocyanurate foam and extruded polystyrene, polyolefin, and polyurethane foams and beads.

It would be advantageous if such insulation sheathing also provided a weather-resistive barrier that aids in removal of moisture and waterproofing.

The thermal insulation sheathing comprises foams of thermoplastic resins such as, for example, polystyrene and polyethylene, and polyurethane. Foams can be open-celled, close-celled and/or a mixed-cell structure.

In one embodiment, the insulation foams are made of extruded polystyrene, expanded polystyrene, polyethylene, polypropylene, or polyurethane.

The insulation layer can be selected from a wide range of options. By way of example, the insulation layer can comprise expanded polystyrene, extruded expanded polystyrene, among other types of rigid, closed-cell foam materials. Other example types of foam insulation include polyisocyanurate materials, polyurethane materials, and phenolic materials. In some embodiments, the insulation layer can include a phase change material (PCM) insulation material.

The insulating layer may be between one inch and three inches thick or greater depending on the application. In some embodiments, the insulation layer is two inches thick. In some embodiments, the insulation layer comprises polyurethane or polyester. In some embodiments, the insulating layer may comprise polystyrene. Examples of polystyrene insulation include expanded polystyrene foam and extruded polystyrene foam. Additionally, or alternatively, the insulation layer may comprise a polyisocyanurate, polyurea, phenolic foam or an organic aerogel. In some embodiments, the insulating layer may comprise an inorganic insulating material, such as mineral wool, glass wool, compressed fumed silica, perlite, calcium silicate, foamed glass, or silica aerogel blanket. In some embodiments, the insulating layer can be a machined, pre-made foam containing slots of a suitable size for surrounding and affixing the reinforcement structures to the outer layer. In some embodiments, the insulating layer may comprise mineral wool. In some embodiments, the insulating layer may be a rigid pour foam or injected formed from a two-part Class I rated urethane.

They are useful industrial products because of their excellent heat-insulating, cushioning and other properties. These foams have found acceptance over the years in such applications as thermal insulation and cushioning as well as raw material for the fabrication of various shaped articles. The preparation of thermoplastic foams by extruding a heat-plastified mixture of a thermoplastic resin and a blowing agent is well known in the art and is described in U.S. Pat. Nos. 2,740,157; 3,067,147; 3,413,387; 3,413,388; 3,431,163; 3,431,164; 3,954,929 and 3,966,381 and Canadian Pat. No. 451,864. Similarly, various methods of preparing open or close-celled expanded polystyrene and other thermoplastic resins are described in art such as U.S. Pat. Nos. 3,243,485; 3,922,328; 4,399,086; 5,049,328; 5,271,886; and 7,358,280; U. S. Pat. App. Pub. Nos. US20020117769, US20130266766; and EPO patents EP0242191A2 and EP1995273A2. All art cited in this document is incorporated by reference as if fully set forth herein.

Current weather-resistive barriers that claim drainage capability are sheet films that have an external application of adhesive or coating that provides an offset for potential drainage.

In U.S. Pat. No. 6,355,333, granted to Waggoner et al., a Construction Membrane is taught. The membrane is described as resisting liquid and air penetration, being moisture vapor permeable, and being provided with integral drainage channels. The disclosed exterior wall construction which incorporates this membrane may be faced with stucco, siding, brick, or stone.

An Exterior Building Cladding Having Rigid Foam Layer With Drain Channels is shown in U.S. Pat. No. 6,886,301, granted to Schilger. Both the inside and the outside faces of the rigid foam insulation layer are provided with vertical channels 21 to remove moisture by way of thin channels 22. Exterior water penetration drains to the bottom of channels 22, and exits the wall construction by means of a drain wick 28 and flashing 25.

In Published Patent Application No. US 2011/0296781, owned by McCary, an Insulating Finishable Panel is illustrated. This construction employs a rigid-faced foam cored panel, which, in one embodiment includes foam air spacers adhered to the panel's radiant reflective surface. In another arrangement, attached foam air spacers create an air space between the insulation and the radiant reflective surface.

In Published Patent Application No. US 2008/0034690, to Gartz et al., an Underlayment With Improved Drainage is disclosed. The underlayment may include a plurality of vertical channels, and funnels at respective top and bottom edges. The funnels are provided to compensate for misalignment of vertically stacked underlayment panels.

Notwithstanding coats of paint and moisture sealant applied to the exterior layer of a stucco wall, moisture still manages to penetrate the stucco overtime and collect on layers of material within the wall. Known prior art construction methods provide moisture barriers and attempt to allow the drainage of accumulated moisture. However, these methods have proven inadequate, and stucco walls continue to fail from moisture intrusion and accumulation, allowing mold to form and causing wood to rot. The exterior stucco wall construction disclosed herein provides improved drainage of the moisture which has penetrated the wall and collects therein on materials and structures. Improved longevity and integrity of the stucco wall system is thereby provided.

The insulation layer can comprise any suitable insulation material conventionally known to one of ordinary skill in the art. For example, the insulation layer can comprise a foam polymer insulation, including for example and without limitation, polyisocyanurate foam, polystyrene foam, polyurethane foam, or any combination thereof. In further exemplary aspects, the foam insulation layer comprises polyisocyanurate foam. In still further aspects, the foam insulation layer can comprise a blend or combination of a polyisocyanurate and polyurethane foam.

The foam insulation layer can comprise extruded foam, expanded foam, or a combination thereof. As one of ordinary skill in the art will appreciate, extruded foams can be prepared by melting a suitable polymer material, incorporating a blowing agent to yield a foamed gel, and extruding the foamed gel through a die to form the desired foam layer. Expanded foams can be prepared by subsequent expansion of beads containing a blowing agent, wherein the expanded beads are molded at the time of expansion to form the desired foam layer.

The foam insulation can have any desired density. For example, the foam insulation can have a density of at least about 1, 2, 3, 4, 5, 6, 7, 8, 9, 10, 11, 12, 13, 14, 15, 16, 17, 18, 19, or even at least about 20 pounds per cubic feet (pcf) according to ASTM D1622. In further aspects, the foam insulation can have a density in the range of about 1 pcf to about 20 pcf. In still further aspects, the foam insulation density can be any desired value within any range derived from any of the above exemplified values, including, for example, a density in the range from about 2 to about 5 pcf, or from about 1 to about 10 pcf.

The foam insulation can be either closed cell or open cell. Open cell foam is more likely to let water vapor condense inside the cells, thereby reducing the insulation value. Thus, in further exemplary aspect, the foam insulation is closed cell. In a further aspect, the foam insulation is greater than about 50, 60, 70, 80, or even greater than about 90% closed-cell according to ASTM D2856.

Since water can negatively impact thermal performance, the foam insulation preferably exhibits limited or substantially no water absorption. For example, the foam insulation exhibits a water absorption of less than about 10, 9, 8, 7, 6, 5, 4, 3, 2, or even less than about 1% according to ASTM C209. In a further aspect, the foam insulation exhibits a water absorption of less than about 10, 9, 8, 7, 6, 5, 4, 3, 2, or even less than about 1% according to ASTM C2842. In a still further aspect, the foam insulation can exhibit a water absorption in the range of about 10 to about 0%. In a yet further aspect, the water absorption can be any desired value within any range derived from any of the above exemplified values, including, for example, a water absorption in the range from about 0 to about 5%, or from about 1 to about 3.5%.

Moreover, the foam insulation layer can have any desired water vapor permeance (or transmission) value. For example, the water vapor permeance can be about 20, 15, 10, 9, 8, 7, 6, 5, 4, 3, 2, 1, or even about 0 perms according to ASTM E96. In a further aspect, the water vapor permeance can be in the range of about 0 to about 20 perms. In a still further aspect, the water vapor permeance can be any desired value within any range derived from any of the above exemplified values, including, for example, a water vapor permeance in the range from about 0 to about 2 perms, or from about 1 to about 5 perms.

The insulation layer can have any desired thickness (t). This thickness (t) can be customized to fit any particular application and desired thermal resistance. For example, and without limitation, the thickness of the foam insulation layer can be in the range of from about 0.25 in. (¼″) to about 3 in. (3″). In further aspects, the thickness can be from about 0.5 in. to about 1 in. Depending on the intended application, the panel can have any desired thermal resistance value (R-value). For example, the panel can have a R-value of at least about 1, 2, 3, 4, 5, 6, 7, 8, 9, 10, 15, 20, 25 according to ASTM C1289-02. In a further aspect, the R-value can be in the range of about 1 to about 25. In still further aspects, the R-value can be any desired value within any range derived from any of the above exemplified values, including, for example, R-value in the range from about 1 to about 10, or from about 3 to about 7.

In various aspects, the insulation layer can optionally comprise a membrane layer. The insulation membrane layer can comprise radiant barrier material, such as metal foil, for example, aluminum foil, polymeric film or fabric, paper, or cellulosic material, reinforcing scrim, such as fiberglass scrim, or a combination thereof. In some aspects, the membrane layer comprises a single or multi-layered material which can be a laminate in which a backing material is laminated to a foam insulation layer. In other aspects, one or more optional additives can also be incorporated into or otherwise applied to the foam insulation layer. Exemplary and non-limiting additives can include flame retardants, colorants, ultraviolet absorbers, textured coatings, and the like as well as any combinations thereof.

The insulation layer can be secured to the inward facing surface of the panel, for example, by any conventionally used adhesive material known in the art to be compatible for use with foam insulation. For example, according to non-limiting aspects of the invention, the adhesive can be selected from a phenol-formaldehyde resin, hot-melt adhesive, polyvinyl acetate (PVA) resin, or any combination thereof. In still a further aspect, the adhesive can be isocyanate-based.

The insulated panels disclosed herein can exhibit improved physical strength and durability over traditional sheathing panels or foam panels. Thus, in one aspect, the inventive insulated panels can exhibit enhanced structural strength and dimensional stability when compared to a conventional or reference sheathing panel in the absence of the insulation layer when exposed to substantially the same environmental and/or physical forces under substantially similar conditions. To that end, the foam insulation layer can have a dimensional stability of about less than 5, 4, 3, 2, or even less than about 1% according to ASTM D2126. In a further aspect, the dimensional stability is preferably about less than 2%. The foam insulation layer can also have any desired compressive strength. For example, the foam insulation layer can have a desired compressive strength of at least about 1, 5, 10, 15, 20, 25, 30, 35, 40 pounds per square inch (psi) according to ASTM D1621. In a further aspect, the compressive strength can be in the range of about 1 to about 40 psi. In a still further aspect, the compressive strength can be any desired value within any range derived from any of the above exemplified values, including, for example, a compressive strength in the range from about 15 to about 30 psi, or from about 20 to about 25 psi. Likewise, the foam insulation layer can have any desired tensile strength. For example, the foam insulation layer can have a tensile strength of greater than about 300, 400, 500, 600, 700, 800, 900, 1000, 1500, 2000 pounds per cubic foot (pcf) according to ASTM D1623. In a further aspect, the tensile strength can be in the range of about 300 to about 2000 pcf. In a still further aspect, the tensile strength can be any desired value within any range derived from any of the above exemplified values, including, for example, a tensile strength in the range from about 500 to about 1000 pcf, or from about 600 to about 800 pcf.

In further aspects, the structural properties of the disclosed insulated panels make the insulated panels suitable for use in numerous structural applications, while still providing improved thermal performance. For example, in one aspect, the inventive insulated panels can be used as braced wall panels, when used in accordance with 2006 IBC Section 2308.3 and 2006 IRC Section R602.10.1. In another aspect, the inventive insulated panels are considered equivalent to Construction Method 3 described in Section 2308.9.3 of the 2006 IBC and Section R602.10.3 of the 2006 IRC. In another aspects, the inventive insulated panels are suitable for use an alternative to wood structural panels in the construction of wood shear walls, when installed in accordance with 2006 IBC Section 2305.3.

It should be noted that all references cited above, and otherwise, in this specification are incorporated in this specification as if they were fully set forth herein.

In one embodiment, the foam insulation is expanded Polystyrene (EPS), Extruded Polystyrene (XPS), Graphite Polystyrene (GPS), or polyisocyanurate foam insulation.

Expanded Polystyrene Insulation, more commonly referred to as EPS, is a closed cell insulation made commonly with of 98% trapped air and only 2% plastic. In one embodiment, this invention relates to a flat board, a contoured shape, or a combination of flat and contoured shaped EPS.

Extruded Polystyrene, referred to as XPS, is a closed cell insulation product commonly used in remodeling and new construction applications. In one embodiment, this invention relates to a flat board, a contoured shape, or a combination of flat and contoured shaped XPS.

Graphite polystyrene insulation, or GPS, is made from Neopor beads, patented and manufactured by BASF. Neopor gives GPS insulation a dark gray appearance and higher r-value than traditional EPS insulation products. In one embodiment, this invention relates to a flat board, a contoured shape, or a combination of flat and contoured shaped GPS.

Polyisocyanurate foam boards may include closed-cell polyisocyanurate (polyiso) foam insulation. This is described, for example, in U.S. Pat. No. 10,829,939B2, which is incorporated by reference herein.

In one embodiment, this invention relates to a system of panels described herein, wherein at least one panel comprises EPS, or at least one panel comprises XPS, or at least one panel comprises GPS, or at least one panel comprises polyisocyanurate foam, or at least a combination of two out of the four panels, three of the four panels, or all four panels. In another embodiment, the panels may be organized adjacent each other or separate from each other.

In one embodiment, this invention relates to a insulation sheathing system that comprises two insulation sheathing panels: a first insulation sheathing panel and a second insulation sheathing panel. The two panels are juxtaposed side by side in one plane. Each insulation sheathing panel comprises the insulation foam layer and the fire-proofing layer as described previously.

In one embodiment, this invention relates to a insulation sheathing system that comprises two insulation sheathing panels: a first insulation sheathing panel and a second insulation sheathing panel. The two panels are juxtaposed side by side in one plane. Each insulation sheathing panel comprises the insulation foam layer and the fire-proofing as described previously.

In one embodiment, the panel has more than 2 sides. Stated differently, the present invention envisions a panel comprising, the following sides: 3, 4, 5, 6, 7, 8, 9, 10, 11, 12, 13, 14, 15, 16, 17, 18, 19, 20.

In one embodiment of the invention, the panel has a curved shape, for example, it is circular, or oblong shaped or a semi-circle shaped. In one embodiment of the invention, the panel has at least one side that is not linear but has a curved shape.

In one embodiment, the multiple-sided panel has all sides that are equal or at least two sides that are equal or no sides that are equal in length.

This invention envisions an insulation sheathing panel system comprising at least two panels wherein a first panel is irregular shaped, but the adjacent juxtaposing second panel neatly fits with the irregular shape of the first panel.

In one embodiment, the insulation panel system comprises more than one square or a rectangular panel, wherein each side of the panel has a tongue or groove configuration.

In one embodiment, the insulation sheathing includes extruded polystyrene, polyisocyanurate, polyolefin, polyurethane, and phenolic foams and beads.

### III. Structurally-Stable Panel

The structurally-stable (SS) panels are an integral part of the IWS panel and is generally contactably and planarly adjacent the insulation layer.

As used herein, “structurally-stable panel” is intended to mean a panel product, commonly composed of structural materials described below, which, in its commodity end use, is essentially dependent upon certain mechanical and/or physical properties for successful end use performance, for example as plywood. A non-exclusive description may be found in the PS-2-92 Voluntary Product Standard.

By “structural materials” is meant MgX, gypsum, wood, cementitious material, composite material, plant-based material, and such and other materials when reinforced by fillers and/or fibers, and blends or mixtures of stated materials.

### MgX

By “MgX” or “magnesium-based material” as used herein is meant to include magnesium oxide, magnesium oxychloride, magnesium sulfate, magnesium oxysulphate, magnesium oxyphosphate, or combinations thereof, which can optionally include fillers (such as perlite) and other additives such as water resistance and processing additives.

### Cementitious Material

By “cementitious material” is meant to include materials containing magnesium oxide as defined herein, or other cement types, such as Portland cement; or any mixtures thereof of these materials.

### Wood

As used herein, “wood” is intended to mean a cellular structure, having cell walls composed of cellulose and hemicellulose fibers bonded together by lignin polymer, or a lignocellulosic material. It is understood to include, inter alia, and exemplarily, oriented strand board (OSB), wood composite, materials containing wood products, wood byproducts, plywood, and waferboards for example. As used herein, “wood composite” or “wood composite material” it is meant a composite material that comprises wood and one or more other additives, such as adhesives or waxes. Non-limiting examples of wood composite materials include oriented strand board (“OSB”), waferboard, particleboard, chipboard, medium-density fiberboard, plywood, and boards that are a composite of strands and ply veneers. As used herein, “flakes” and “strands” are considered equivalent to one another and are used interchangeably. Anon-exclusive description of wood composite materials may be found in the Supplement Volume to the Kirk-Othmer Encyclopedia of Chemical Technology, pp. 765-810, 6^{th} edition. “Wafer board” is intended to mean panels manufactured from reconstituted wood wafers bonded with resins under heat and pressure.

### Composite Material

In one embodiment, the structurally-stable panel is a composite board such as the EcoStorm® coverboard obtained from Carlisle Corporation of Mechanicsburg, Pennsylvania. The EcoStorm® coverboard is an engineered composite building material made from a blend of plastic and cellulose fiber. In one embodiment of the invention, the composite board is sourced from post-industrial and post-consumer waste streams. In another embodiment, such composite board is a durable, moisture and mold resistant building material.

In one embodiment, the SS panel can be, for example, an engineered fiberboard laminate which is a composite material formed from multiple layers of paperboard made from wood fibers or other cellulosic materials that are bonded together using various techniques and bonding agents to create a strong, stable, and durable panel. The bonding agents may include extruded polymer, adhesive, or a combination thereof. In some embodiments, the extruded polymer can be a thermoplastic or thermoset material that is applied to the paperboard layers through an extrusion coating process. The adhesive can be any suitable type of adhesive, such as a moisture-resistant or water-resistant adhesive, which is compatible with the paperboard layers and provides adequate bonding strength. In some embodiments, one or more of the paperboard layers within the engineered fiberboard laminate may be extrusion coated with a polymer material to enhance the moisture resistance, durability, or other properties of the SS panel.

Alternatively, or in addition, one or more of the paperboard layers of the SS panel may be laminated to a plastic film or foil to provide additional barrier properties, such as water resistance, vapor resistance, or gas impermeability. The plastic film can be made from various polymeric materials, such as polyethylene, polypropylene, polyester, or nylon, while the foil can be an aluminum foil or other metallic foil that provides a high level of barrier protection. In one embodiment, these plastic films or foils may be used in place of, or in addition to, the WRB layer described below.

### Gypsum

In some embodiments, the SS panel may further comprise gypsum. Additionally, or alternatively, SS panel may fully comprise gypsum.

### Reinforced Materials

In some embodiments, the SS panel may be made of a cementitious material with a glass fiber reinforcing material embedded therein. Additionally, or alternatively, the SS panel may be formed by pouring a slurry of cementitious material with glass fiber reinforcing material into a mold and allowing the cementitious product to cure, or dry. The glass fiber reinforcing material can be in the form of chopped glass fiber. Additionally, or alternatively, the glass fiber reinforcing material may be incorporated into the SS panel in the form of one or more glass fiber scrim(s). Once cured, the SS panel may be removed from the mold prior to adhering the reinforcement structures to the inner surface of the SS panel. Choice of reinforcement include glass, flax, basalt, cellulose, carbon, or aramid fiber such as Kevlar®. Other reinforced materials include Compolite® from Ascorium industries, Konigswinter Germany, wherein the reinforcement fiber mat is embedded with polyurethane.

### Plant-Based Material

The structurally-stable panel can also comprise at least one plant-based material, as described below:
grass, including perennial grass, switchgrass such as Panicum virgatum L, Miscanthus, Sorghum, sugarcane, millets, Napier grass, giant reed, and other forage and turf grasses, subalpine grasses, native grass, sedge, rush include Agrostis exarata (Spike Bentgrass), Ammophila arenaria (European sand dune or beach grass), Ammophila breviligulata (American beach grass), Ammophila champlainensis Seymour, Ammophila maritima, Beckmannia zyzigachne (American Sloughgrass), Bromus carinatus (California Brome), Bromus vulgaris (Columbia Brome), Carex densa (Dense-Headed Sedge), Carex feta (GreenSheathed Sedge), Carex leporina (Harefoot Sedge), Carex lenticularis (=C. kelloggii) (Shore Sedge), Carex lyngbyel (Lyngby Sedge), Carex macrocephala (Big Headed Sedge), Carex obnupta (Slough Sedge), Carex pansa (Foredune Sedge), Carex unilateralis (One-Sided Sedge), Deschampsia caespitosa (Tufted Hair Grass), Eleocharis palustis (Creeping Spike rush), Elymus glaucus (Blue Wild Rye), Festuca idahoensis var. roemeri (Roemer's Fescue), Festuca rubra var. littoralis (Shore Fescue), Festuca subulata (Bearded Fescue), Glyceria elata (Tall Mannagrass), Glyceria occidentalis (Western Mannagrass), Hordeum brachyantherum (Meadow Barley), Juncus effusus (Soft Rush), Juncus patens (Spreading Rush), Juncus tenuis (Slender Rush), Lozula campestris (Woodrush), Phalaris arundinacea (Reed Canary Grass), Phalaris aquatica, Phalaris tuberosa (Staggers Grass), Phalaris canariensis, Poa Macrantha (Dune Bluegrass), ReGreen (Sterile Hybrid Wheat), Scirpus acutus (Hardstem Bullrush), Scirpus americanus, Scirpus cyperinus, Scirpus maritimus (Seacoast Bullrush), Scirpus microcarpus, Scirpus validus, Sparaganuim eurycarpum (Giant Burreed), Triglochin maritinum (Seaside Arrowgrass), Typha latifolia (Cattail), Alopecuris geniculatus, Carex pachystachya, Carex stipata (grass like), Danthonia californica, Eleocharis ovata (grass like), Glycaria grandis, Juncus acuminatus, Juncus bolanderi and Juncus ensifolius (Daggar leaf rush). By way of example, other grasses include the Lily of the Nile (Agapanthus africanus), white fountain grass (Pennisetum ruppelihi), muhly grass (Muhlenbergia capillaris), African iris (Dietes vegeta), Podocarpus (Podocarpus macrophyllus), wax myrtle (Myrica cerifera), Aztec grass (Ophiopogon intermedius argenteomarginatus), mondo grass (Ophiopogon japonicus), evergreen giant (Liriope muscan), evergreen Paspalum (Paspalum quadrifarium) and sand cord grass (Spartina bakerii).

Further the structurally-stable panel comprises other plant-based materials, said other plant-based materials comprise flax straw, which is flax fibers and flax shives produced from processing waste flax straw. Waste flax straw is made during the harvesting of flaxseeds from flax plants. The flax straw includes a mixture of flax fibers and flax shives. In another embodiment, the lignocellulosic component includes bio-waste cotton (Gossypium hirsutum L.) stalks and underutilized Paulownia (Paulownia fortunie). In yet another embodiment, the wood composite includes waste stone pine (Pinus pinea L.) cones, needle litter of Scotch pine (Pinus sylvestris L.), corn stalks, vine pruning stalks, sycamore leaves, reed stem, or Hevea brasiliensis clones. In yet another embodiment, the lignocellulosic component comprises corn stover, rice straw, wheat straw, barley straw, oat straw, rape seed straw, siteria grass, yukka fibre, lemongrass, jute, sisal, bamboo, pine needles, lupins, kenaf, coir fiber, coconut husks, cotton stalks, coffee husks, ground nut husks, areca nut husks, casaurina leaves, banana leaves and banana stem.

In one embodiment, the SS panel is a wood composite panel comprising a binder material and other plant-based material, wherein said panel includes at least 70 percent other plant-based material by weight and at least 2.5 percent thermoplastic binder by weight. In one embodiment, the thermoplastic binder material comprises high density polyethylene or recycled HDPE, a formaldehyde-free binder, or zero volatile organic compounds or polymeric methylene diphenyl diisocyanate (PMDI).

In another embodiment, the panel comprises an SS panel that is a wood composite panel which is selected from the group of wood composite panel types consisting of oriented strand wood composite panel, fiber wood composite panel, particle wood composite panel and layer comprising plant-based material. In one embodiment, the panel has a density in the range of 42 to 54 lbs/ft³. The thickness of the SS layer or panel is in the range of from about 0.01 inch to about 3 inches. Stated differently, the thickness of the SS panel is selected from any number given below, in inches, or any number in inches that resides within a range defined by any two numbers below including the endpoints of such ranges:
0.01, 0.02, 0.04, 0.06, 0.08, 0.1, 0.12, 0.14, 0.16, 0.18, 0.20, . . . 0.30, 0.40, 0.50, 0.60, 0.7, 0.8, 0.9. 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9. and 3.0.

In one embodiment of the IWS panel of the present disclosure, one SS panel is used. In another embodiment, the number of panels used are 2, 3, 4, 5, 6, 7, 8, 9, 10, 11, 12, 13, 14, 15, 16, 17, 18, 19, 20. In a given IWS panel, these panels may be interspersed with other layers defined herein, or can be provided as stacks of two or more SS panels.

In one embodiment, where multiple SS panels are used, whether in a stack form or interspersed between other layers, the thickness of the SS panels can be the same, can be different from each other, or at least two are of the same thickness, or at least two are of different thickness.

The IWS panel in accordance with the present disclosure can optionally incorporate one or more additional layers that can be any of a fiberglass, polymer, or metal sheet, film, fiber, mat, fabric layer, or combinations thereof, either within or on the SS panel(s) or the or insulation layer(s), that is on the surface of the SS panel(s) or insulation layer(s), and/or between the insulation layer(s) and the SS panel(s).

### IV. Weather-Resistive Barrier Laver

Weather-resistive barrier layer (“WRB layer”) include the external house-wrap layer that provides barrier properties but may have water vapor permeability. House-wraps are described for example in U.S. Pat. Nos. 6,901,712. House-wraps include Blueskin® sold by Henry Co. of PA and Tyvek® by DuPont Co. of DE. Other house-wrap materials include Barricade® Wrap Plus, Typar® Building Wrap, CertainTeed CertaWrap™, and HydroGap® Housewrap.

In one embodiment, the WRB layer is a pre-formed sheet air barrier membrane, which is permeable to water vapor, and which can be adhered to a substrate, substantially over its entire area, by virtue of an adhesive deposited on one side of the sheet. In one embodiment of the present invention, the substrate is a structurally-stable panel such as a wood panel as described, supra.

In another embodiment, the WRB layer provides a pattern for depositing the adhesive on the membrane such that the lateral movement of air between the membrane and the substrate or through lap joints of membrane sections is restricted.

In yet another embodiment, the WRB layer is a water vapor permeable, air barrier sheet membrane which can be installed with or without the use of mechanical fasteners, nails, screws, rivets, mechanical or plastic clamps, or tapes to provide an air barrier system with a continuous plane of air tightness.

In another embodiment, the WRB layer has an adhesive backed water vapor permeable sheet membrane that can perform as a barrier to the infiltration of liquid or bulk water as from wind-driven rain, when used in wall and roof assemblies.

In one embodiment, the WRB layer is a membrane permeable to water vapor, on one side of which is deposited an adhesive in a non-continuous film leaving zones of uncoated membrane, thereby permitting the diffusion of water vapor through the membrane at the uncoated zones.

In another embodiment of the WRB layer, the adhesive is deposited in a pattern on the membrane such that the adhesive intersects or connects in a manner to avoid providing channels through which air can laterally migrate when the membrane is bonded to a substrate.

In another embodiment of the WRB layer, the membrane, although permeable to water vapor, is rendered impermeable to liquid or bulk water and can thus perform as an adhesive backed moisture barrier which is permeable to water vapor.

In another embodiment, the WRB layer is a self-adhering, water vapor permeable, air and moisture barrier sheet for structural surfaces of buildings, comprising (i) an air and moisture barrier membrane which is water vapor permeable, and (ii) has an adhesive applied to one side of the water vapor permeable membrane in a non-continuous film.

In accordance with a particular embodiment of the invention, there is provided a self-adhering sheet for structural surfaces, comprising, (a) an air and moisture barrier membrane having opposed first and second faces, said membrane being water vapor permeable, and (b) an adhesive applied to said second face in a non-continuous film to define a plurality of spaced-apart, non-adhesive-coated zones surrounded by an adhesive coated zone.

In yet another aspect of the invention, WRB layer is an article of manufacture comprising a self-adhering sheet of the invention having a strippable release sheet removably adhered to said second face with a non-continuous adhesive film.

In some embodiments, in addition to the WRB layer, a veneer layer, which is a brick, a ceramic tile, porcelain tile, natural stone, engineered stone, wood, ceramic, plastic, vinyl, or paint.

In another embodiment, for the all the examples and embodiments described above, an intumescent coating that can aid in fireproofing/retarding and ignition proofing/retarding can also be included in place of or in addition to the WRB layer. Intumescent coatings are obtained for example from the NoBurn Co., Wadsworth, OH. Intumescent coatings also include fire retardant coatings and ignition retardant coatings.

In one embodiment, a split liner tape is used that can allow for one or more extension flaps to include the concept of release-liner. Intumescent coatings can be procured from No-Burn.

### WRB Layer—Vapor Permeable Membrane

The vapor permeable membrane of the invention is a flexible sheet or film, which is permeable to the passage of water in vapor form. The sheet or film may be microporous, microperforated or some other type of vapor permeable sheet or film.

A microporous sheet or film is a non-perforated continuous microfiber web with microscopic pores large enough for moisture vapor to pass through, but small enough to resist air and liquid water. Microperforated membranes depend on mechanical pin-perforations and/or film laminations to build in properties.

While both of the abovementioned types of sheet or film are permeable to water vapor, a sheet or film of the microporous type is preferred as this type is less permeable to the passage of water or moisture in liquid or bulk form.

Suitable microporous sheets or films are spunbonded or fibrous bonded polyolefin as described in U.S. Pat. Nos. 3,532,589 and 5,972,147, preferred polyolefins are polyethylene and polypropylene, one such microporous sheet is available commercially under the trade-mark Tyvek®; other suitable microporous sheets include oriented polymeric films as described in U.S. Pat. No. 5,317,035, and which comprise ethylene-propylene block copolymers; one such film is commercially available as Aptra®. The sheets or films may be reinforced with several types of scrim materials or may be laminated to other vapor permeable sheets or films, such as non-woven polypropylene or non-woven polyester for the purpose of improving strength and other physical properties.

In general, the membrane will typically have a thickness of 0.001 to 0.04, preferably 0.001 to 0.025 inches.

The WRB layer can extend at one or more edges of the panel as the extension flap, wherein the extension flap comprises a removably attached release-liner on its back side.

In one embodiment, the extension flap, in the direction perpendicular to the edge of the panel, is 0.10% to 50% of the shortest and the longest dimension of the panel, respectively.

In one embodiment, the adhesive on the inner surface of the WRB that adheres to the SS panel, or an insulation layer is the same as the adhesive on the extension flap of the WRB having a removably attached release-liner.

In one embodiment comprising the extension flaps or pre-applied tapes, the overhang is anywhere from 0.1 inches to 12 inches on any one or more edges of the panel. This is advantageous in minimizing or to eliminating the need for labor to tape the seams in the field.

### V. Optional Fastener-Gasketing Adhesive

The fastener-gasketing adhesive can be a hot-melt adhesive, solvent based adhesive, water based adhesive or of other types such as UV cured polymer. The applied adhesive is preferably tacky, i.e.—sticky and pressure sensitive. Suitable hot melt adhesives may contain such ingredients as polymers such as butyl rubber, styrene-butadiene-styrene (SBS), styrene-isoprene-styrene (SIS), styrene butadiene (SB), styrene-ethylene-butadiene-styrene (SEBS) and ethylene vinyl acetate (EVA); resins such as those of the hydrocarbon and rosin types, natural and petroleum waxes, oils, bitumen and others. Solvent-based adhesives may contain ingredients such as those listed above, dissolved or dispersed in a solvent vehicle. Water based adhesives would normally be based on emulsions of polymeric materials. Suitable polymeric materials would include vinyl acetate and acrylic polymers and copolymers such as vinyl acetate acrylic, ethylene vinyl acetate as well as styrene acrylic, vinyl chloride acrylic, vinyl versatate and others.

From a production standpoint, the preferred adhesives are of the hot melt type which are simply melted for application and need not emit solvent which is an environmental pollutant and may require re-condensation. Water based adhesives have the disadvantage that they generally require the additional use of drying ovens or heat lamps to evaporate the water.

The adhesive may suitably be applied at a thickness of 0.001 inches to 0.1 inch but is preferably applied at a thickness of 0.003 inches to 0.025 inches and most preferably at a thickness of 0.005 inches to 0.02 inches.

The WRB layer is adhered to a wood-composite material layer or a panel, with an adhesive. The WRB layer extends beyond the panel dimensions in one or more directions away from the edges. For example, if the panel is rectangular, with the WRB layer attached to it. The WRB layer will extend at least 0.1 inch over the dimension of the rectangular panel on one or more sides. In these extension flaps of the WRB panel will be attached a release-liner that is attached with an adhesive material, such that when more than one panel is abutted to each other, upon removal of the release-liner the WRB layer adhered directly to the adjacent panel of the assembly, and will seal the gaps between the two panels in the assembly. Suitable release sheets are paper sheet, having a silicone release surface coating and some treated plastic films.

### Adhesive Pattern

To retain an essential level of water vapor permeance in the adhesive coated membrane, the adhesive is applied to the vapor permeable membrane in a non-continuous film in order to leave parts, or spots or zones of the sheet uncoated with adhesive.

In order to prevent the lateral movement of air between the membrane and the substrate to which it is bonded, and through lap joints of the membrane, the adhesive coated areas of the membrane can be made to intersect to isolate the uncoated areas, thereby eliminating channels through which air can laterally move. This can be achieved by any number of patterns, such as intersecting circles with adhesive free centers, intersecting squares or rectangles of adhesive, intersecting strips in a checkered pattern, and the like.

In general, the adhesive film forms an adhesive sea on the membrane surface, with a multitude of membrane islands, surrounded by but not covered by the adhesive sea.

The adhesive may suitably be applied so as to cover 5% to 99% of the area of one side of the membrane, but is preferably applied to cover between 25% and 90% of the area, and most preferably between 50% and 80% of the area, to obtain the optimum balance of adhesion and vapor permeance in the sheet.

### VI. Optional Adhesive Laver

The adhesive can be a hot-melt adhesive, solvent based adhesive, water based adhesive or of other types such as UV cured polymer. The applied adhesive is preferably tacky, i.e.—sticky and pressure sensitive. Suitable hot melt adhesives may contain such ingredients as polymers such as butyl rubber, styrene-butadiene-styrene (SBS), styrene-isoprene-styrene (SIS), styrene butadiene (SB), styrene-ethylenebutadiene-styrene (SEBS) and ethylene vinyl acetate (EVA); resins such as those of the hydrocarbon and rosin types, natural and petroleum waxes, oils, bitumen and others. Solvent-based adhesives may contain ingredients such as those listed above, dissolved or dispersed in a solvent vehicle. Water based adhesives would normally be based on emulsions of polymeric materials. Suitable polymeric materials would include vinyl acetate and acrylic polymers and copolymers such as vinyl acetate acrylic, ethylene vinyl acetate as well as styrene acrylic, vinyl chloride acrylic, vinyl versatate and others.

From a production standpoint, the preferred adhesives are of the hot melt type which are simply melted for application and need not emit solvent which is an environmental pollutant and may require re-condensation. Water based adhesives have the disadvantage that they generally require the additional use of drying ovens or heat lamps to evaporate the water.

The adhesive may suitably be applied at a thickness of 0.001 inches to 0.1 inch, but is preferably applied at a thickness of 0.003 inches to 0.025 inches and most preferably at a thickness of 0.005 inches to 0.02 inches.

The WRB layer is adhered to a wood-composite material layer or a panel, with an adhesive. The WRB layer extends beyond the panel dimensions in one or more directions away from the edges. For example, if the panel is rectangular, with the WRB layer attached to it. The WRB layer will extend at least 0.1 inch over the dimension of the rectangular panel on one or more sides. In these extension flaps of the WRB panel will be attached a release-liner that is attached with an adhesive material, such that when more than one panel is abutted to each other, upon removal of the release-liner the WRB layer adhered directly to the adjacent panel of the assembly, and will seal the gaps between the two panels in the assembly. Suitable release sheets are paper sheet, having a silicone release surface coating and some treated plastic films.

### Adhesive Pattern

To retain an essential level of water vapor permeance in the adhesive coated membrane, the adhesive is applied to the vapor permeable membrane in a non-continuous film in order to leave parts, or spots or zones of the sheet uncoated with adhesive.

In order to prevent the lateral movement of air between the membrane and the substrate to which it is bonded, and through lap joints of the membrane, the adhesive coated areas of the membrane can be made to intersect to isolate the uncoated areas, thereby eliminating channels through which air can laterally move. This can be achieved by any number of patterns, such as intersecting circles with adhesive free centers, intersecting squares or rectangles of adhesive, intersecting strips in a checkered pattern, and the like.

In general, the adhesive film forms an adhesive sea on the membrane surface, with a multitude of membrane islands, surrounded by but not covered by the adhesive sea.

The adhesive may suitably be applied so as to cover 5% to 99% of the area of one side of the membrane, but is preferably applied to cover between 25% and 90% of the area, and most preferably between 50% and 80% of the area, to obtain the optimum balance of adhesion and vapor permeance in the sheet.

### Primer

As is common with other types of self-adhering membranes, the use of a liquid primer coating may sometimes be recommended to improve adhesion of the membrane to some substrates such as wood panel. In the case of a vapor permeable membrane, the primer should be selected from certain materials or applied at a reduced rate or in a manner such that the breathability of the assembly is not compromised.

### Vapor Impermeable Barrier Sheet

In some embodiments, the vapor permeable membrane sheet of the invention is typically employed in a building structure, especially a wall structure, in conjunction with a vapor impermeable barrier sheet. A preferred sheet is a polyethylene sheet, as known in the art, having a water vapor permeance of not more than 15 ng/Pa s m² (ASTM E 96).

Such a sheet may be considered a vapor retarder since it is not completely impermeable to water vapor.

Typically, the barrier sheet has a thickness of 0.001 to 0.008 inches, more usually 0.002 to 0.006 inches.

### Insulation Sheathing and WRB Panels

In one embodiment, this invention relates to a insulation sheathing system that comprises two insulation wall-sheathing (IWS) panels: a first IWS panel and a second IWS panel. The two panels are juxtaposed side by side in one plane as described previously. In one embodiment, the insulation sheathing system comprises two IWS panels wherein at least one panel comprises at least one extension flap with a backing of a release-liner, on one side of the panel. In another embodiment, the two panels are fitted or attached to each other via the extension flap arrangement, with the release-liner now removed and the extension flap extending from one panel to the second panel and providing the joining of the two panels. Multiple panels can be similarly joined.

In one embodiment, the extension flap is continuous along the length of the side of the insulation panel from which it extends outward. In another embodiment, of the invention, the extension flap is discrete, with multiple protrusions which in totality make the extension flap. In one embodiment, there is a gap between the protrusions that form the extension flap. In another embodiment, the protrusions are of the same width or of different widths. See FIG. 6, generally.

In one embodiment, the invention relates to one or more of the extension flaps in their direction parallel to the edge of the panel, which are from 5% to 120% the length of the edge of the panel.

In one embodiment, the extension flaps of two adjacent panels fit in a tongue and groove arrangement.

### Tongue-and-Groove Arrangement

In an insulation wall-sheathing (IWS) panel, at least on one side of the panel either a tongue or a groove can be provided for its juxtaposition and attachment to an adjacent panel. By tongue is meant a protrusion along the length of the side of a panel that removably fits within the groove of an adjacent panel. By groove is meant a depression along the length of an insulation wall-sheathing panel which allows for a removable attachment of the side of an adjacent panel that has a tongue along its length.

In one embodiment, the tongue and the groove are a continuous feature along the length of a system comprising at least two insulation wall-sheathing panels. In another embodiment of the IWS panel systems, the tongue and the groove arrangement is discrete such each tongue is divided into multiple protrusions along the length of the side of a panel, and the corresponding side of the receiving panel comprises multiple grooves in form of depressed troughs to receive the multiple protrusions. In one system, the tongue is discrete on one sheathing panel, but the receiving groove is continuous.

In one embodiment, this invention relates to a insulation sheathing system that comprises two insulation wall-sheathing panels: a first insulation wall-sheathing panel and a second insulation wall-sheathing panel. The two panels are juxtaposed side by side in one plane. In one embodiment, the insulation sheathing system comprises of the two panels wherein each panel comprises either a groove or a tongue at least on one side of the panel. In another embodiment, the two panels are fitted or attached or joined to each other via the tongue-and-groove arrangement. Multiple panels can be similarly joined.

In one embodiment, the tongue and the groove are a continuous feature along the length of a system comprising at least two insulation wall-sheathing panels. In another embodiment of the insulation wall-sheathing panel systems, the tongue and the groove arrangement is discrete such each tongue is divided into multiple protrusions along the length of the side of a panel, and the corresponding side of the receiving panel comprises multiple grooves in form of depressed troughs to receive the multiple protrusions. In one system, the tongue is discrete on one sheathing panel, but the receiving groove is continuous.

In one aspect of the invention, the invention relates to an insulation wall-sheathing panel or an insulation sheathing system (i.e., multiple panels), that have panels comprising both the extension flaps and the tongue-and-groove arrangement.

In one embodiment, the insulation wall-sheathing panel has more than 2 sides. Stated differently, the present invention envisions a panel comprising the following sides:
3, 4, 5, 6, 7, 8, 9, 10, 11, 12, 13, 14, 15, 16, 17, 18, 19, 20.

In one embodiment of the invention, the panel has a curved shape, for example, it is circular, or oblong shaped or a semi-circle shaped. In one embodiment of the invention, the panel has at least one side that is not linear, but has a curved shape.

In one embodiment, the multiple-sided panel has all sides that are equal or at least two sides that are equal or no sides that are equal in length.

This invention envisions an insulation wall-sheathing panel system comprising at least two panels wherein a first panel is irregular shaped, but the adjacent juxtaposing second panel neatly fits with the irregular shape of the first panel.

In one embodiment, the insulation panel system comprises more than one square or a rectangular panel, wherein each side of the panel has a tongue or groove configuration, and each side has an extension flap with the releasable liner backing.

In one embodiment, the pattern on the insulation facer will also repeat in the machine direction of the insulation sheath being made. In one embodiment, the embossed design connects with each other for adequate drainage of the moisture. In one embodiment, the embossed design is vertical lines. In one embodiment, the embossed design is crisscross lines or a lattice design. In one embodiment, the design is rhombus or diamond shape. In one embodiment, the entire design is connected to each other. In one embodiment the design is a set of transverse lines. It is to be understood that the designs and/or patterns herein are in plurality and/or in repetition in the vertical or the horizontal (machine) direction.

This invention addresses the above issues of moisture drainage by providing a vapor semi permeable weather resistive drainage product in a single inline process through an embossment technique.

Particularly, in one of its embodiments, it includes a vapor semi-permeable insulation sheathing that provides insulation, a weather-resistive barrier, and an air barrier while simultaneously providing a drainage mechanism on the external surface, which has been engendered through an in-line application of pressure and heat. The patterned embossment on the sheathing provide an avenue for moisture that gets behind the exterior weather barrier a means to escape.

The comprehensive weather resistive barrier that includes an insulation component with an embossed drainage system allows the contractor minimal passes to create all functions while using a planar board that does not exceed the primary dimension of the sheathing. The design uses a polymeric film that is breathable and adhered to an insulative core material through heat lamination on one face that undergoes pressure and heat to create a mechanism to promote drainage when used as a wall system component. The patterned embossment in the sheathing will provide an avenue for moisture that gets behind the exterior weather barrier a means to escape.

In the present disclosure, insulation sheathing, insulation board, insulation panel, or insulation material is used interchangeably.

As discussed previously, insulation facing laminations are laminates which contain film/foil or metalized films that provide protection for a variety of insulation applications. Often the adhesive possesses fire-retardant properties. Typical applications include ceiling panels and wall insulation.

As shown in FIG. 1.1, of U.S. Prov. App. No. 63/505,711, which filing is incorporated in its entirety, by reference, herein, and in one embodiment, the insulation sheathing comprises an insulation foam and an insulation facer laminated on at least one surface of the insulation foam.

In one embodiment, such facing materials or insulation facers include plastic film, thin metal foil, paper or thin cellulose, non-woven polymeric fabrics, fiberglass scrims, and combinations of the foregoing.

In one embodiment, the insulation sheathing includes extruded polystyrene, polyisocyanurate, polyolefin, and polyurethane foams and beads.

The insulation facer comprises an embossed pattern on its surface. The pattern may be geometric, regular, or random. The embossed pattern is such that it aids in draining of the accumulating moisture on the surface of the insulation sheathing.

By geometric pattern is mean vertical lines, horizontal lines, transverse lines, circles, triangles, squares, rectangles, trapezoid, rhombus, pentagons, and other such geometric designs. More than one type of geometric structure may be present on the surface of the insulation facer in an embossed or recessed fashion.

By a regular pattern is meant that the same pattern is repeated in partial or full surface of the insulation facer. In other words, a geometric pattern would be repeated, or an irregular pattern would be repeated.

By irregular pattern is meant the insulation facer has a random design that is not regular.

By embossing herein is meant a relative difference in depth between the embossed pattern and the recessed pattern on the surface of the insulation facer. For example, if a pattern is embossed on the insulation facer surface, it covers the aspect where the same design is embossed or recessed.

The pattern will also repeat in the machine direction of the insulation sheath being made.

The embossed design on the insulation sheathing is such that insulation sheathing of the present invention has an advantageous moisture drainage or removal possibility. An embossed design is shown in FIG. 1.2 of U.S. Prov. App. No. 63/505,711.

In one embodiment, this invention relates to an exterior stucco wall construction comprising: a wall frame; sheathing attached to the outer side of the wall frame; a moisture collection channel or the embossed design mounted along the insulation sheathing facer, a second moisture impervious board comprising the insulation sheathing having an inner side insulation facer provided with drain means such as the embossed design described previously to facilitate the downward drainage of moisture.

Turning now to the drawings, and in particular FIG. 1.3 of U.S. Prov. App. No. 63/505,711, it shows the process of embossing the design on the insulation facer. At least one of the roller has a design template on its surface. The continuously moving insulation sheathing has an insulation facer on one or both surfaces. The insulation sheathing (with the foam and the facer) moves in the horizontal direction, in one example, and under temperature and/or pressure, the embossed design is imprinted. As shown in FIG. 1.4 of U.S. Prov. App. No. 63/505,711, a design for moisture removal is embossed on the facer of the foam insulation. This embossed design feature provides the maximum discharge of moisture and condensation. Experimentation includes creating a means to emboss the assembly while not deteriorating the weather resistive barrier or air barrier requirements. Further testing includes permeance, wind driven rain, R-Value, compatibility, drainage, and pressure testing of the assembly.

### EXPERIMENTAL

In one embodiment, a pattern roller is applied to a rotary press. The sheet of foam which is laminated in line previously enters the roller with ¼″ pinch which creates pressure at a temperature in excess of 220° F. The pressure roller is spinning at 60 feet per minute. The material exits the roll, and the pattern is embossed in the insulation sheathing on the facer side.

1. A first insulated sheathing (IS) panel used for construction purposes, comprising three or more layers of material, wherein the three or more layers comprise a first insulation layer; a first structurally-stable panel; and a first weather-resistive barrier (WRB) layer;
wherein either the first structurally-stable (SS) panel is planarly and contactably attached to the first WRB layer, or the first insulation layer is planarly and contactably attached to the first WRB layer; and
wherein the first WRB layer exceeds the dimension of the IS panel from at least one of its edges to create an extension flap along the edges, and wherein the extension flap of the WRB layer further comprises a removably attached release-liner attached to the first WRB layer's inner surface at the back of the extension flap.

2. A first IS panel as recited in claim 1, comprising the following layers:
a first insulation layer having an outer surface and an inner surface;
a first structurally-stable panel having an outer surface and an inner surface, and at least one edge extending between its outer surface and the inner surface; wherein the inner surface of the first insulation layer is planarly and contactably attached to the outer surface of the first structurally-stable panel; and
a first WRB layer having an outer surface and an inner surface, wherein the inner surface of the WRB layer is secured to the outer surface of the first structurally-stable panel;
wherein the WRB layer exceeds the dimension of the structurally-stable panel from at least one of its edges to create an extension flap; and
wherein the extension flap of the WRB layer further comprises a removably attached release-liner attached to the WRB layer's inner surface at the back of the extension flap.

3. A first IS panel as recited in claim 1, comprising the following layers:
a first insulation layer having an outer surface and an inner surface;
a first structurally-stable panel having an outer surface and an inner surface, and at least one edge extending between its outer surface and the inner surface; wherein the inner surface of the first insulation layer is planarly and contactably attached to the outer surface of the first structurally-stable panel;
a second structurally-stable panel having an outer surface and an inner surface, and at least one edge extending between its outer surface and the inner surface; wherein the inner surface of the first structurally-stable panel is planarly and contactably attached to the outer surface of the second structurally-stable panel; and
a first WRB layer having an outer surface and an inner surface, wherein the inner surface of the WRB layer is secured to the outer surface of the second structurally-stable panel;
wherein the WRB layer exceeds the dimension of the structurally-stable panels from at least one of its edges to create an extension flap; and
wherein the extension flap of the WRB layer further comprises a removably attached release-liner attached to the WRB layer's inner surface at the back of the extension flap.

4. A first IS panel as recited in claim 1, comprising the following layers:
a first insulation layer having an outer surface and an inner surface;
a first structurally-stable panel having an outer surface and an inner surface, and at least one edge extending between its outer surface and the inner surface; wherein the inner surface of the first insulation layer is planarly and contactably attached to the outer surface of the first structurally-stable panel;
a first heat-sealant layer having an outer surface and an inner surface, and at least one edge extending between its outer surface and the inner surface; wherein the inner surface of the first structurally-stable panel is planarly and contactably attached to the outer surface of the first heat-sealant layer; and
a first WRB layer having an outer surface and an inner surface, wherein the inner surface of the WRB layer is secured to the outer surface of the heat-sealant layer;
wherein the WRB layer exceeds the dimension of the heat-sealant layer from at least one of its edges to create an extension flap; and
wherein the extension flap of the WRB layer further comprises a removably attached release-liner attached to the WRB layer's inner surface at the back of the extension flap.

5. A first IS panel as recited in claim 1, comprising the following layers:
a first structurally-stable panel having an outer surface and an inner surface, and at least one edge extending between its outer surface and the inner surface;
a first insulation layer having an outer surface and an inner surface; wherein the outer surface of the first insulation layer is planarly and contactably attached to the inner surface of the first structurally-stable panel;
a second structurally-stable panel having an outer surface and an inner surface, and at least one edge extending between its outer surface and the inner surface; wherein the outer surface of the second structurally-stable panel is planarly and contactably attached to the inner surface of the first insulation panel; and
a first WRB layer having an outer surface and an inner surface, wherein the inner surface of the WRB layer is secured to the outer surface of the second structurally-stable panel;
wherein the WRB layer exceeds the dimension of the structurally-stable panels from at least one of its edges to create an extension flap; and
wherein the extension flap of the WRB layer further comprises a removably attached release-liner attached to the WRB layer's inner surface at the back of the extension flap.

6. A first IS panel as recited in claim 1, comprising the following layers:
a first insulation layer having an outer surface and an inner surface;
a first structurally-stable panel having an outer surface and an inner surface, and at least one edge extending between its outer surface and the inner surface; wherein the inner surface of the first insulation layer is planarly adjacent to the outer surface of the first structurally-stable panel;
a set of strips embedded in the first insulation layer, wherein the set of strips contact the first structurally-stable layer at the strips' non-embedded end and wherein said strips create air-pockets in conjunction with said first insulation layer and said structurally-stable panel;
or wherein the set of strips is embedded in the first insulation layer such that the strips' non-embedded ends are exposed but are nominally flush with the inner surface of the insulation layer; and
a first WRB layer having an outer surface and an inner surface, wherein the inner surface of the WRB layer is secured to the outer surface of the first structurally-stable panel;
wherein the WRB layer exceeds the dimension of the structurally-stable panel from at least one of its edges to create an extension flap; and
wherein the extension flap of the WRB layer further comprises a removably attached release-liner attached to the WRB layer's inner surface at the back of the extension flap.

7. The first IS panel as recited in claim 6, wherein the set of strips are organized in a geometric pattern to drain moisture.

8. A first IS panel as recited in claim 1, comprising the following layers:
a first insulation layer having an outer surface and an inner surface;
a first structurally-stable panel having an outer surface and an inner surface, and at least one edge extending between its outer surface and the inner surface;
a plurality of insulation beads in contact with the first structurally-stable layer;
a first WRB layer having an outer surface and an inner surface, wherein the inner surface of the WRB layer is secured to the plurality of insulation beads, and wherein said insulation beads create air-pockets in conjunction with said first structurally-stable panel and said WRB layer; and
wherein the WRB layer exceeds the dimension of the first structurally-stable panel from at least one of its edges to create an extension flap; and
wherein the extension flap of the WRB layer further comprises a removably attached release-liner attached to the WRB layer's inner surface at the back of the extension flap.

9. A first IS panel as recited in claim 2, comprising the following layers:
first insulation layer having an outer surface and an inner surface;
a first structurally-stable panel having an outer surface and an inner surface, and at least one edge extending between its outer surface and the inner surface; wherein the inner surface of the first insulation layer is planarly and contactably attached with optionally an adhesive to the outer surface of the first structurally-stable panel;
wherein the insulation layer and the structurally-stable panel is attached to each other through an adhesive tape on at least one edge of the combined insulation layer and the structurally-stable panel; and
a first WRB layer having an outer surface and an inner surface, wherein the inner surface of the WRB layer is secured to the outer surface of the first structurally-stable panel;
wherein the WRB layer exceeds the dimension of the structurally-stable panel from at least one of its edges to create an extension flap; and
wherein the extension flap of the WRB layer further comprises a removably attached release-liner attached to the WRB layer's inner surface at the back of the extension flap.

10. A first IS panel as recited in claim 1, comprising the following layers:
a first insulation layer having an outer surface and an inner surface;
a first structurally-stable panel having an outer surface and an inner surface, and at least one edge extending between its outer surface and the inner surface; wherein the inner surface of the first insulation layer is planarly and contactably adjacent to the outer surface of the first structurally-stable panel, and the insulation layer is optionally attached with an adhesive, planarly and contactably, to the structurally-stable panel; or wherein the inner surface of the first insulation layer is planarly and contactably adjacent to the outer surface of the first structurally-stable panel, and the insulation layer is only nominally in contact with structurally-stable panel, creating an air-gap therebetween;
wherein, optionally, the insulation layer and the structurally-stable panel is attached to each other through an adhesive tape on at least one edge of the combined insulation layer and the structurally-stable panel; and
a first WRB layer having an outer surface and an inner surface, wherein the inner surface of the WRB layer is secured to the outer surface of the first structurally-stable panel;
wherein the WRB layer exceeds the dimension of the structurally-stable panel from at least one of its edges to create an extension flap; and
wherein the extension flap of the WRB layer further comprises a removably attached release-liner attached to the WRB layer's inner surface, such that the WRB layer is extended beyond the face of the panel, and over at least one edge of the IS panel to at least partially encase the IS panel.

11. The panel as recited in claim 1, wherein if the structurally-stable panel is planarly and contactably attached to the WRB layer, a first facer layer is planarly and contactably attached to outer surface of the insulation layer and on the opposite side of the WRB layer, and wherein the insulation panel is planarly and contactably attached to the WRB layer, the facer layer is planarly and contactably attached to the outer surface of the structurally-stable panel and on the opposite side of the WRB layer.

12. The panel as recited in claim 1, further comprising a first fastener-gasketing layer having an outer surface and an inner surface; wherein the outer surface of the fastener-gasketing layer is in contact with the inner surface of said WRB layer.

13. The panel as recited in claim 1, wherein the one or more structurally-stable (SS) panels comprises material selected from MgX, gypsum, wood, cementitious material, composite material, wood composite material, plant-based material, reinforced materials, blends thereof, and mixtures of stated materials.

14. The panel as recited in claim 1, wherein the SS panel comprises lignocellulosic material, OSB, plywood, waferboard, particleboard, chipboard, medium-density fiberboard, and boards that are a composite of strands and ply veneers.

15. The panel as recited in claim 1, wherein the SS panel comprises magnesium oxide, magnesium oxychloride, magnesium sulfate, magnesium oxysulphate, magnesium oxyphosphate, or combinations thereof.

16. The panel as recited in claim 1:
wherein the SS panel is an engineered composite building material made from a blend of plastic and cellulose fiber;
wherein the SS panel is an engineered fiberboard laminate which is a composite material formed from multiple layers of paperboard made from wood fibers or other cellulosic materials; or
wherein the SS panel is laminated to a plastic film or foil, wherein the plastic film comprises polyethylene, polypropylene, polyester, or nylon, and wherein the foil is a metallic foil.

17. The panel as recited in claim 1:
wherein the SS panel comprises a cementitious material with a glass fiber reinforcing material embedded therein;
wherein the SS panel is formed by pouring a slurry of cementitious material with glass fiber reinforcing material into a mold and allowing the cementitious product to cure, or dry;
wherein the SS panel comprises glass fiber reinforcing material in the form of chopped glass fiber;
wherein the glass fiber reinforcing material may be incorporated into the SS panel in the form of one or more glass fiber scrims;
wherein the SS panel comprises a reinforcing material selected from glass, flax, basalt, cellulose, carbon, or aramid fiber; or
wherein the SS panel comprises a reinforcement fiber mat is embedded with polyurethane.

18. (canceled)

19. The panel as recited in claim 1, wherein the SS panel is a wood composite panel selected from the group consisting of oriented strand wood composite panel, fiber wood composite panel, particle wood composite panel and a layer comprising plant-based material.

20.-22. (canceled)

23. The panel as recited in claim 1, wherein the insulation layer comprises a foam, or wherein the insulation layer comprises a foam that is open-celled, close-celled, or a mixed-cell structure.

24. The panel as recited in claim 1, wherein the insulation layer comprises at least one of extruded polystyrene, expanded polystyrene (EPS), graphite polystyrene (GPS), polyethylene, polypropylene, polyurethane, polyester, polyisocyanurate, phenolic material, organic aerogel, and a phase change material (PCM).

25. The panel as recited in claim 1, wherein the insulation layer comprises at least one of an inorganic insulating material selected from the group consisting of mineral wool, glass wool, compressed fumed silica, perlite, calcium silicate, foamed glass, and silica aerogel blanket.

26. The panel as recited in claim 1, further comprising one or more additional layers that can be any of a fiberglass, polymer, or metal sheet, film, fiber, mat, fabric layer, or combinations thereof, either within or on one or more of the SS panel, or one or more of the insulation layers, that is on the surface of the one or more of the SS panels or the one or more of the insulation layers, and/or between the one or more of the insulation layers and the one or more of the SS panels.

27.-31. (canceled)

32. The panel as recited in claim 1, wherein the insulation membrane layer comprises radiant barrier material, polymeric film, polymeric fabric, paper, cellulosic material, reinforcing scrim, or a combination thereof.

33. The panel as recited in claim 1, wherein the insulation layer is secured to the panel using an adhesive selected from a phenol-formaldehyde resin, hot-melt adhesive, polyvinyl acetate (PVA) resin, or a combination thereof.

34.-44. (canceled)

45. The panel as recited in claim 1, comprising a fastener-gasketing adhesive between the WRB layer and the layer on the inside of the panel facing the WRB layer.

46. The panel as recited in claim 1, wherein the release-liner or release sheet is a paper sheet having a silicone release surface coating or a treated plastic film.

47.-50. (canceled)

51. A panel assembly comprising at least two panels juxtaposed and/or adhered to each other, wherein at least one panel is according to a panel as recited in claim 1.

52.-63. (canceled)

64. A method for preparing a first IS panel, the method comprising the following steps:
providing a first insulation layer having an outer surface and an inner surface;
providing a first structurally-stable panel having an outer surface and an inner surface, and at least one edge extending between its outer surface and the inner surface;
planarly and contactably attaching the inner surface of the first insulation layer to the outer surface of the first structurally-stable panel; and
providing a first WRB layer having an outer surface and an inner surface,
wherein the WRB layer exceeds the dimension of the structurally-stable panel from at least one of its edges to create an extension flap, and
wherein the extension flap of the WRB layer further comprises a removably attached release-liner attached to the WRB layer's inner surface at the back of the extension flap;
planarly and contactably securing or attaching the inner surface of the WRB layer to the outer surface of the first structurally-stable panel.

65.-67. (canceled)
